(19) United States
(12) Patent Application Publication
(10) Pub. No.: US 2019/0086154 A1
(43) Pub. Date: Mar. 21, 2019

(54) ADDITIVE MANUFACTURING CONSTRUCTS AND PROCESSES FOR THEIR MANUFACTURE

(71) Applicant: ADDITIVE ROCKET CORPORATION, La Jolla, CA (US)

(72) Inventors: Kyle ADRIANY, San Diego, CA (US); Reiley WEEKES, La Jolla, CA (US); Kylie SAGISI, San Diego, CA (US); Samantha LANDIS, Tustin, CA (US); Alec KOCHIS, San Diego, CA (US); Andy KIEATIWONG, San Diego, CA (US); Zachary ROGERS, Oceanside, CA (US)

(21) Appl. No.: 16/136,874

(22) Filed: Sep. 20, 2018

Related U.S. Application Data
(60) Provisional application No. 62/561,120, filed on Sep. 20, 2017.
(60) Provisional application No. 62/561,573, filed on Sep. 21, 2017.
(60) Provisional application No. 62/562,306, filed on Sep. 22, 2017.

(51) Int. Cl. F28D 1/04; B22F 3/105; B22F 5/10

(52) U.S. Cl. CPC F28D 1/0443; F28D 1/0417; B33Y 80/00; B22F 5/106; B22F 3/1055

(57) ABSTRACT

Calibrated additive manufacturing processes can be used to manufacture constructs which can include or exclude heat exchangers incorporating fractal branched conformal cooling passages for use as molds, rocket engine components, and test articles. Described herein are the manufacture and use of conformal cooling of heat exchangers made by an additive manufacturing process.

### RELATED APPLICATION DATA

This application claims priority to U.S. Provisional Patent Application Ser. No. 62/561,120, filed Sep. 20, 2017, U.S. Provisional Patent Application Ser. No. 62/562,306, filed Sep. 22, 2017, and U.S. Provisional Patent Application Ser. No. 62/561,573, filed Sep. 21, 2017, all of which are incorporated herein by reference in their entirety.

### FIELD OF THE INVENTION

The disclosure relates to the field of additive manufacturing. More particularly, the disclosure relates to the additive manufacture and use of conformal cooling of injection molds, engine deflector nozzles, and calibration test apparatuses.

### INCORPORATION BY REFERENCE

All U.S. patents, U.S. patent application publications, foreign patents, foreign and PCT published applications, articles and other documents, references and publications noted herein, and all those listed as References Cited in any patent or patents that issue herefrom, are hereby incorporated by reference in their entirety. The information incorporated is as much a part of this application as if all the text and other content was repeated in the application, and will be treated as part of the text and content of this application as filed.

### BACKGROUND

The following includes information that may be useful in understanding the present invention. It is not an admission that any of the information, publications or documents specifically or implicitly referenced herein is prior art, or essential, to the presently described or claimed inventions. All publications and patents mentioned herein are hereby incorporated herein by reference in their entirety.

Additive manufacturing can produce end-use components which generally exhibit high geometric customization and customized applications. The end-use components may find application in high performance racing vehicles, aerospace and medical industries.

Additive manufacturing (AM) is the direct fabrication of a part, typically in a printed layered format. However, AM has manufacturing limitations which leads to variations in print to print builds. Identifying, characterizing, predicting, and mitigating the occurrence of such print variations is useful to produce consistent high-fidelity parts.

At least some known component geometries can be designed according to the manufacturing method that can be used to machine the final component. At least some known standard computer-aided engineering and design (CAD) tools that are used to produce three-dimensional (3D) models can mimic standard machine shop methods when designing a 3D model to ensure that the components will be manufacturable using standard methods at a reasonable cost.

### SUMMARY OF THE INVENTION

The embodiments described herein have many attributes and aspects including, but not limited to, those set forth or described or referenced in this Brief Summary. It is not intended to be all-inclusive and the embodiments described herein are not limited to or by the features or embodiments identified in this Brief Summary, which is included for purposes of illustration only and not restriction.

In some aspects, this disclosure relates to a heat exchanger comprising a plurality of fractal branched cooling passages in fluidic communication with an inlet and one or a plurality of outlets. In some embodiments, the heat exchanger further comprises a central cavity comprising a surface, where the plurality of fractal branched cooling passages conforms to the contours of the central cavity surface which are disposed close to, but not in fluidic communication with, said central cavity. In some aspects, the sum of the cross sectional area of the plurality of fractal branched cooling passages is substantially the same throughout the length of said passages. The heat exchanger is additively-manufactured.

In some aspects, the heat exchanger further comprises one or a plurality of fractal branching points. In some aspects, the heat exchanger further comprises one or a plurality of convergent junctures. In some aspects, the heat exchanger further comprises comprising one or a plurality of first fluid feeder passages. In some aspects, the heat exchanger further comprises one or a plurality of second fluid feeder passages. In some aspects, the heat exchanger is in fluidic communication with the plurality of fractal branched cooling passages. In some aspects, the heat exchanger can further comprise a fluid. In some aspects, the first fluid feeder passage can comprise a first fluid, the second fluid feeder passage can comprise a second fluid, and the first fluid and the second fluid can be of the same type of fluid or different types of fluid. In some aspects, the first fluid and the second fluid are at different temperatures or at different temperatures when presented to the inlets. In some aspects, the fluid is selected from ethylene glycol, water, oil, a nanofluid, a cryogenic fluid, or mixtures thereof. In some aspects, the heat exchanger comprises a fluid at a lower temperature than the heat exchanger.

In some aspects, the heat exchanger is a mold. In some aspects, the mold is an open-pour mold, a metal injection mold, or a plastic injection mold (“injection mold”). In some aspects, the injection mold further comprises: an additively-manufactured mold insert comprising a plurality of fractal branched cooling passages.

In some aspects, this disclosure provides for a method of forming a plastic part substantially free of warping defects, the method comprising the steps of: (a) presenting a plastic material into the central cavity of any of an mold comprising fractal branched conformal cooling passages; (b) increasing the temperature of the plastic material to above the softening point of the plastic material to form a melted plastic material; (c) decreasing the temperature of the plastic material to below the softening point of the plastic material to form a solidified plastic material; and (d) removing the additively-manufactured mold from the solidified plastic material to form a formed plastic part. In some aspects, step (b) increasing the temperature of the plastic material is performed by presenting a fluid into the plurality of fractal branched cooling passages, then heating said fluid. In some aspects, step (b) increasing the temperature of the plastic material is performed by presenting a pre-heated fluid into the plurality of fractal branched cooling passages. In some aspects, step (b) increasing the temperature of the plastic material is performed by placing the additively-manufactured mold comprising the plastic material into an external heating apparatus. In some aspects, the external heating apparatus is a heating oven. In some aspects, step (c) decreasing the temperature of the plastic material is performed by presenting a pre-cooled fluid into the plurality of fractal branched cooling passages. In some aspects, the mold comprises two or more additively-manufactured mold segments, each of which comprises a surface. In some aspects, each of the surfaces of the two or more additively-manufactured mold segments define substantially the entire surface of a formed plastic part. In some aspects, the temperature difference delta across the surface of the central cavity of a mold comprising conformal cooling passages is less than that of a central cavity of a mold without conformal cooling passages.

In some aspects, this disclosure relates to the improvement of conformal cooling technology through the implementation of non-machinable, additively manufacturable, coolant passage geometries. The embodiments described in this document enable the production of high performance molds and mold inserts through additive manufacturing processes. These additively manufactured molds and mold inserts implement conformal cooling at a cost significantly lower than that of traditionally machined, conformally cooled, molds while delivering a number of additional benefits.

The embodiments described herein also include a testing apparatus with a standardizable three-dimensional (3D) geometry that enables the measurement of numerous parameters in a high throughput fashion, and methods of assembling the same. The testing apparatus described herein can be rapidly manufactured utilizing a minimal amount of material. In some aspects of this disclosure, the testing apparatus can be imaged using simple inspection optics, from which accurate measurements of each testing apparatus parameter can be obtained.

The inventors have recognized that metal additive manufacturing can be used in the fractal branched conformal cooling of mold tooling. This is specifically due to the degree of difficulty inherent in the machining of conformally cooled molds and mold inserts as well as the cost. The shape of cooling passages are dictated by the feasibility of constructing these passages through machining methods, and not for the optimization of cooling. This issue can be solved through metal additive manufacturing, wherein both the mold and cooling passages can be fabricated simultaneously, layer by layer. The shape of cooling passages are not dictated by manufacturing restrictions. Complex geometries for conformally cooled fractal branched passages in molds can be produced for the optimization of cooling. Fractal branched conformal cooled molds and mold inserts offer a number of benefits to molders.

Cooled molds enable molders to operate at lower per-unit production cycle time, thereby reducing part cost while increasing production throughput. Cycle times are typically constrained by the rate at which the plastic material, injected as a liquid or semi-solid, or presented into a cavity in an open-pour mold, can cool. Standard implementations of cooling speed cooling, but result in a higher rate of part defects if pushed to cool at a higher throughput rate. To overcome this challenge, mold makers typically spread parts out in a mold where applicable. A multi-cavity mold for a small component, may have 2-4 inches of inter-cavity spacing. This serves to increase the mass of metal around each cavity to reduce thermal variations within each cavity, and across multiple cavities. This method inevitably increases mold size dramatically, thus directly increasing the costs associated with materials, machining, and large format injector machine time.

Conformally cooled molds rely on cooling passages which closely wrap around the contours of each mold cavity in order to deliver precision cooling and increase part throughput. Multi-cavity molds use conformal cooling to reduce overall mold footprint, delivering cooling to each cavity thereby enabling close packing of cavities.

Despite superior performance, high tooling costs associated with conformally cooled molds have hindered their widespread adoption. Conformally cooled molds are capable of yielding reduced cycle times and greater cooling uniformity, which is necessary for thin wall molding. Nevertheless, conformally cooled molds exhibit issues, similar to those seen in traditionally cooled molds when pushed to the upper limits of their production rate.

A typical failure mode indicative of improper cooling is the thermal stress defect. This occurs when thermal energy is not removed evenly across a cavity, resulting in the over/undercooling of a component's particular region. Thermal stress typically presents as warping or cracking within the plastic components being produced. This result is generally visible externally to the naked eye.

Cooling cycle time in molding is typically constrained by the rate at which the plastic material, injected as a liquid or semi-solid, can cool. Standard cooling methods for molds result in higher rates of part defects when pushed to perform at high throughput rates. To overcome this challenge, part cavities can be spread out within the mold. A multi-cavity mold for a small component may have 2-4 inches of inter-cavity spacing. This serves to increase the mass of metal around each cavity to reduce thermal variations within each cavity, and across multiple cavities. Unfortunately, this inevitably increases costs associated with materials, machining, and large format plastic material presenter machine time.

Conformally cooled molds and mold inserts combat these problems by utilizing cooling passages that contour the mold cavities to deliver even and precise cooling. This allows injection molders to operate at lower production cycle time per-unit, which reduces part cost and increases production throughput. Despite superior performance, difficulties in machining and high tooling costs associated with conformally cooled molds have hindered their widespread adoption. Furthermore, conformally cooled molds exhibit similar issues to those seen in traditionally cooled molds when pushed to the upper limits of their production rate.

As a result, metal additive manufacturing has become increasingly popular in the creation of passages for use in the conformal cooling of injection mold tooling. In some embodiments, this disclosure relates to the improvement of conformal cooling technology through the implementation of non-machinable, additively manufacturable, coolant passage geometries. In some embodiments, this disclosure relates to the production of high performance molds and mold inserts through even and precise cooling possible only with additive manufacturing. These additively manufactured molds and mold inserts implement conformal cooling at a cost significantly lower than possible with traditionally machined, conformally cooled molds.

In some aspects, this disclosure relates to solutions to the problems of nonoptimal throttling and combustion based instabilities in liquid propellant rocket engines. In some aspects, this disclosure describes an additively manufactured deflector nozzle component of a rocket engine.

While not hindered by the limitations of traditional manufacturing, designing for additive manufacturing-manufactured components can require data regarding 3D printing nuances to design a critical component. During the AM process, extraneous variables and pitfalls in the methodology produce geometries which deviate from the desired 3D model. In order for manufacturers to produce the desired component, the design must be adjusted to offset certain geometric aspects of the 3D models in order to account for the 3D printing nuances and variations. Testing apparatii are components which can be made to test for the performance of any given manufacturing process and material.

In some aspects, this disclosure relates to a multi-sided testing apparatus which includes the features of a barcode pattern that is positioned on at least one of the plurality of side surfaces; a plurality of rings positioned adjacent to the barcode pattern, wherein each of the plurality of rings are coupled to each other such that each ring of the plurality of rings is concentrically aligned with at least one other ring of the plurality of rings, each of the plurality of rings have the same first predefined diameter; at least one first set of a plurality of openings positioned on the same side surfaces that the barcode pattern and the plurality of rings are positioned on, wherein each of the at least one first set of the plurality of openings have a second predefined diameter that is different than the first predefined diameter, the at least one first set of the plurality of openings have a predefined first shape; at least one second set of a plurality of openings positioned on at least one of the plurality of side surfaces that is different than the at least one surface that the barcode pattern and the plurality of rings are positioned on, wherein each of the at least one second set of the plurality of openings have a second predefined diameter that is different than the first predefined diameter, the at least one second set of the plurality of openings have a predefined second shape; and at least one third set of a plurality of openings positioned adjacent to the at least second set of the plurality openings, wherein the at least one third set of the plurality of openings have a predefined third shape that is different than the predefined second shape. In some aspects, the testing apparatus further comprises at least one series of tapered edge ramps at one or more angles tapering inward to the center of the testing apparatus to partially bisect two of the side surfaces. In some aspects, the at least one series of tapered edge ramps comprises six ramps. In some aspects, the angles of the at least one series of tapered edge ramps are selected from: 1, 15, 30, 45, 60, and 75 degrees. In some aspects, the testing apparatus further comprises a planar tapered edge ramp configured at the lateral outer edge of and spanning across the length of the testing apparatus. The angle of the planar tapered edge ramp can be 1.0 (+/−0.1) degrees.

In some aspects, the testing apparatus further comprises one or a plurality of stepped troughs penetrating into one or more side surfaces opening up from a single point to an open area. In some aspects, the testing apparatus comprises one or more stepped ridge configured on one or more of the side surfaces, where the walls of the trapezoid are step-tapered.

In some aspects, the testing apparatus is a polyhedron. In some aspects, the testing apparatus comprises 4, 5, or 6 sides. In some aspects, the 4-sided testing apparatus is a triangular pyramid. In some aspects, the 5-sided testing apparatus is a rectangular pyramid. In some aspects, the 6-sided testing apparatus is a rectangular cuboid. In some aspects, the rectangular cuboid is a cube (also known as a hexahedron). In some aspects, the testing apparatus consists essentially of six side surfaces and twelve edges. The twelve edges of the testing apparatus can be of the same length. In some aspects, the length of the twelve edges can vary by 1%, 2%, 3%, 4%, 5%, 6%, 7%, 8%, 9%, or 10% from edge to edge. In some aspects, the length of each edge is less than 5, 4, 3, 2, or 1 centimeters. In some aspects, the length of each edge is less than 3.5 centimeters.

In some aspects, orientation text may be positioned on at least one of the testing apparatus side surfaces. In some aspects, the testing apparatus comprises standoffs on at least one side surface. In some aspects, the testing apparatus comprises one or a plurality of angled openings which bisect at least two sides of the testing apparatus. In some aspects, the angles of the angled openings can be from 1 degree to 90 degrees. In some aspects, the angle of the angled openings is selected from: 1 degree, 30 degrees, 45 degrees, or 60 degrees. The angles of each of the angled openings can be the same or different. In some aspects, the testing apparatus comprises one or a plurality of troughs positioned on at least one side surface. The troughs can be straight or curved. The troughs can be square-bottomed or curved-bottomed. In some aspects, the testing apparatus comprises one or a plurality of ridges positioned on at least one side surface. The ridges can be straight or curved. The ridges can be rounded or squared on top. In some aspects, the testing apparatus comprises one or a plurality of dimples positioned on at least one side surface. The shape of the dimples can be hemispherical. In some aspects, the testing apparatus comprises one or a plurality of bumps positioned on at least one side surface. In some aspects, the testing apparatus comprises one or a plurality of beveled edges along at least one edge. In some aspects, the testing apparatus comprises one or a plurality of angled ramps on at least one side, bisecting two sides of the testing apparatus along at least one edge.

In some aspects, the testing apparatus surface is smooth. In some aspects, the testing apparatus surface is rough. In some aspects, the testing apparatus surface is porous.

In some aspects, the testing apparatus consists essentially of six side surfaces. In some aspects, the testing apparatus consists essentially of twelve edges. In some aspects, the testing apparatus is cubic shape. In some aspects, each side surface of the testing apparatus has substantially about the same surface area. In some aspects, the length of each testing apparatus edge is substantially about the same. In some aspects, the testing apparatus is a cube where the length of the edges is less than 3.5 centimeters. In some aspects, the testing apparatus consists of 12 edges where the length of the edge is selected from: 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, or 3.5 cm. The small testing apparatus size allows for the testing apparatus to be manufactured in parallel with the manufacture of another object to be used as quality control mechanism of the additive manufacturing process. In some aspects, multiple testing apparatii can be created at selected positions in the manufacture bed during the manufacturing of another object.

In some aspects, this disclosure relates to an imaging system comprising a testing apparatus as described herein and a camera configured to be orthogonal to any of the testing apparatus six side surfaces. The camera can be a digital camera. The digital camera can be selected from a CCD (charge-coupled device) or CMOS (complementary metal-oxide semiconductor) camera. The camera can be focused on the entirety of a testing apparatus side surface or one or a plurality of features positioned on a testing apparatus side surface. The camera can take one or a plurality of images of each side surface. The testing apparatus can be positioned on a table, laser table, or harness. In some aspects, the camera can be configured to move around the testing apparatus after imaging each side surface so as to image two or more side surfaces of the testing apparatus. In some aspects, the testing apparatus can be configured in a harness so as to rotate and present a different side surface to the camera after imaging one of the side surfaces.

In some aspects, this disclosure relates to a method of fabricating a testing apparatus for additive manufacturing processes, and using said testing apparatus to detect the presence of defects of a selected additive-manufacturing process. An illustrative embodiment of the method includes creating an input design file for a testing apparatus where the design file comprises size requirements of the testing apparatus features, performing an additive manufacturing process to the testing apparatus designed from the input design file, scanning a first side surface of the additively manufactured testing apparatus, measuring the dimensions of one or a plurality of the features positioned on the first side surface of the additively manufactured testing apparatus, and comparing the dimensions of one or a plurality of the features positioned on the first side surface of the additively manufactured testing apparatus with the first input design file size features. A difference greater than a set threshold in the dimensions of the additively manufactured testing apparatus and of the first input design file indicates a defect in the additive manufacturing process.

In some aspects, the method of detecting the presence of any defects of an additive-manufacturing process further comprises the steps of scanning a second side surface of the additively manufactured testing apparatus and measuring the dimensions of one or a plurality of the features on the second side surface of the additively manufactured testing apparatus.

In some aspects, the method of detecting the presence of any defects of an additive-manufacturing process using a testing apparatus using the input design file is done in parallel with the manufacture of a separate object. One or a plurality of testing apparatus can be manufactured at separate locations within the build volume of the manufactured separate object, all during the same manufacturing process. The use of multiple test apparatii at separate locations enables detection of manufacturing process defects at any point (or layer) during the manufacturing process. A defect identified in the additive manufacturing process indicates a defect in the manufactured separate object.

In some aspects, this disclosure relates to a method of optimizing an additive manufacturing process to reduce the number and intensity of defects when additively manufacturing an object. The method comprises creating a first input design file for a testing apparatus where the first design file comprises size requirements of the features, performing an additive manufacturing process to the testing apparatus designed from the first input design file, scanning a first side surface of the additively manufactured first testing apparatus, measuring the dimensions of one or a plurality of the features positioned on the first side surface of the additively manufactured first testing apparatus, comparing the dimensions of one or a plurality of the features of the additively manufactured first testing apparatus with the first input design file size features; optionally scanning a second side surface of the measuring the difference in dimensions of the additively manufactured first testing apparatus, measuring the dimensions of one or a plurality of the features on the second side surface of the additively manufactured first testing apparatus, comparing the dimensions of one or a plurality of the features of the additively manufactured second side surface of the first testing apparatus with the first input design file size features; comparing the dimensions of one or a plurality of the features of the additively manufactured first testing apparatus with the first input design file size features of the testing apparatus, creating a second input design file of the testing apparatus, performing an additive manufacturing process to the testing apparatus designed from the second input design file, scanning a first side surface of the additively manufactured second testing apparatus, measuring the dimensions of one or a plurality of the features on the first side surface of the additively manufactured second testing apparatus, and comparing the dimensions of one or a plurality of the features of the additively manufactured second testing apparatus with the first input design file size features. In some aspects, the second input design file of the testing apparatus can correct for differences between the dimensions of the additively manufactured first testing apparatus and the first input design file such that the expected dimensions of the additively manufactured testing apparatus are obtained. In some aspects, the difference between the dimensions of the additively manufactured testing apparatus designed by the second input file and of the first input design file are reduced.

In some aspects, this disclosure relates to a statistical allowables database created from the measurement differences between the first input design file, and the dimensions of the additively manufactured first testing apparatus, and optionally the second input design file and optionally the dimensions of the additively manufactured second testing apparatus.

### BRIEF DESCRIPTION OF DRAWINGS

FIG. 1 is a top view of one embodiment of the invention which shows a fractal pattern of conformal cooling passages.

FIG. 2 is a top view of one embodiment of the invention which shows a simulation of the backpressure on fluid flow through a fractal pattern of conformal cooling passages. Minimal backpressure difference is observed for the fractal branched points. Distance is relative arbitrary length units. Backpressure is in relative pressure units. The simulation was calculated using Ansys™ modeling software.

FIG. 3 is a top view of which shows a simulation of the backpressure on fluid flow through a series of parallel pattern of non-conforming cooling passages. The results of the simulation demonstrate that extreme differences in backpressure are observed in the feeder passage 901 and at the first non-fractal branching point 902, when the passage geometry is not optimized for fluid flow. Distance is relative arbitrary length units. Backpressure is in relative pressure units. The simulation was calculated using Ansys™ modeling software.

FIG. 4 is a perspective view of one embodiment of the invention which shows a series of conformal cooling passages around a spherical part to be cast using the mold (center sphere). The passages are optimized to minimize fluid backpressure while maintaining maximum thermal contact with the mold. The mold is not shown for clarity.

FIG. 5 is a side-cut view on the XZ plane of one embodiment of the invention which shows the fractal branched conformal cooling passages around a spherical part to be cast using the mold (center circle). Heat flow 199 from the central cavity 105 to the fractal branched conformal cooling passages 104a, 104b, 104c, 104d, 104e, 110a, 110b, 110c, 110d, and 110e is represented by the solid arrow. Heat flow 198 from the fractal branched conformal cooling passages to the central cavity 105 is represented by the outline arrow, and occurs when the conformal passages are pre-heated to increase the rate at which the central cavity 105 is heated.

FIG. 6 is a side-cut view on the XY plane of one embodiment of the invention which shows the fractal branched conformal cooling passages around a spherical part to be cast using the mold (center sphere).

FIG. 7 is a perspective view of one embodiment of the invention which shows the top and bottom molds with the negative shape of the part to be cast (concave impressions) 105 and holes indicating the fractal branched conformal cooling passage ports.

FIG. 8 is a perspective view of one embodiment of the invention which shows the fractal branched conformal cooling passages in the molds for the part to be cast.

FIG. 9 is a perspective view of one embodiment of the invention which shows the fractal branched conformal cooling passages configured in the top and bottom molds of a part to be cast (rectangular block).

FIG. 10 is a perspective view of one embodiment of the invention which shows the fractal branched conformal cooling passages positioned relative to the part to be cast (rectangular block). The fractal branched conformal cooling passages are designed to have minimal backpressure and maximum thermal contact with the part to be cast.

FIG. 11 is a cut-side YZ view of one embodiment of the invention which shows the fractal branched conformal cooling passages positioned relative to the part to be cast (polyhedron).

FIG. 12 is a cut-side YX view of one embodiment of the invention which shows the fractal branched conformal cooling passages positioned relative to the part to be cast (polyhedron).

FIG. 13 is a perspective view of a reference non-conformal cooling passage geometry relative to central cavity (sphere).

FIG. 14 is a perspective view of a reference non-conformal cooling passage geometry relative to central cavity (polyhedron).

FIG. 15 shows a slice view of a heatmap of fractal branched conformal cooling passages 104 of the configuration depicted in FIG. 4, around a central cavity 105 (sphere). The results show the temperature profile is substantially homogeneous at the regions of the mold closest to the surface of the central cavity. Distance is in relative length units. Temperature is in relative temperature units (° C.).

FIG. 16 shows a slice view of a heatmap of reference non-conformal cooling passages 320 of the configuration depicted in FIG. 13 around a central cavity 321 (sphere). The results show the temperature profile is very heterogeneous at the regions of the mold closest to the surface of the central cavity around the cavity, with the regions of the mold farthest from the non-conformal cooling passages higher in temperature relative to the regions of the mold closest to the non-conformal cooling passages. Distance is in relative length units. Temperature is in relative temperature units (° C.).

FIG. 17 shows a perspective view of a heatmap of fractal branched conformal cooling passages (not shown for clarity) of the configuration depicted in FIG. 9, around a central cavity 105 (polyhedron). The results show the temperature profile is substantially homogeneous throughout all the regions of the central cavity. Distance is in relative length units. Temperature is in relative temperature units (° C.).

FIG. 18 shows a perspective view of a heatmap of reference non-conformal cooling passages (not shown for clarity) of the configuration depicted in FIG. 14, around a central cavity 321 (polyhedron). The results show the temperature profile varies at the outer peripheral regions of the central cavity relative to the interior region of the central cavity. Distance is in relative length units. Temperature is in relative temperature units (° C.).

FIG. 19 shows a slice view heatmap of fractal branched conformal cooling passages 104 of the configuration depicted in FIG. 9, around a central cavity 105 (polyhedron). The results show the temperature profile is substantially homogeneous throughout all the regions of the central cavity. Distance is in relative length units. Temperature is in relative temperature units (° C.).

FIG. 20 shows a slice view heatmap of reference non-conformal cooling passages 320 of the configuration depicted in FIG. 14 surrounding part of a central cavity 321 (polyhedron). The results show the temperature profile is different throughout the surface of the mold near the central cavity with the temperature the highest at the regions farthest from the non-conformal cooling passages relative to the temperature of the regions closest to the non-conformal cooling passages. Distance is in relative length units. Temperature is in relative temperature units (° C.).

FIG. 21 shows a top view heatmap of fractal branched conformal cooling passages 104 of the configuration depicted in FIG. 4, around a central cavity 105 (sphere). The results show the temperature profile is substantially homogeneous within the interior of the sphere with some minimal temperature escalation at the outer side surfaces of the sphere. Distance is in relative length units. Temperature is in relative temperature units (° C.).

FIG. 22 shows a slice view of a heatmap of reference non-conformal cooling passages of the configuration depicted in FIG. 13 around a central cavity 321 (sphere). The results show the temperature profile is heterogeneous between the peripheral regions of the sphere hotter than the interior regions of the sphere. Distance is in relative length units. Temperature is in relative temperature units (° C.).

FIG. 23 is a perspective view of one embodiment of the testing apparatus, in accordance with some embodiments of the present disclosure.

FIG. 24 is a perspective view of one embodiment of the testing apparatus, in accordance with some embodiments of the present disclosure.

FIG. 25 is a top view of one embodiment of the testing apparatus, in accordance with some embodiments of the present disclosure.

FIG. 26 is a bottom view of one embodiment of the testing apparatus, in accordance with some embodiments of the present disclosure.

FIG. 27 is a side view of one embodiment of the testing apparatus, in accordance with some embodiments of the present disclosure.

FIG. 28 is a side view of one embodiment of the testing apparatus, in accordance with some embodiments of the present disclosure.

FIG. 29 is a front view of one embodiment of the testing apparatus, in accordance with some embodiments of the present disclosure.

FIG. 30 is a rear view of one embodiment of the testing apparatus, in accordance with some embodiments of the present disclosure.

FIG. 31 is a perspective view of an embodiment where the testing apparatus (e.g., small box) can be placed relative to another object (e.g., a chess piece as depicted in the diagram) to measure the performance of a manufacturing process to create the other object.

FIG. 32 is a perspective view of an embodiment where a plurality of testing apparatii (e.g., small boxes) can be placed relative to another object (e.g., a chess piece as depicted in the diagram) to measure the performance of a manufacturing process to create the other object.

FIG. 33 is a series of drooping profiles fit to a closed contour of the drooped circular cross section in the ZX and ZY planes, in accordance with some embodiments of the present disclosure.

FIG. 34 is a photograph showing the top view of a manufactured embodiment of the testing apparatus, in accordance with some embodiments of the present disclosure. Shown alongside the manufactured embodiment of the testing apparatus is a ruler (in mm and inches).

FIG. 35 is a photograph showing the top view of a manufactured embodiment of the testing apparatus, in accordance with some embodiments of the present disclosure. Shown alongside the manufactured embodiment of the testing apparatus is a ruler (in mm). As can be observed from the photograph, passages with a diameter of less than 1 mm can be manufactured using the methods described herein.

FIG. 36 is a graph of the opening radius data from one embodiment of the testing apparatus of the present invention. Three series (“iterations”) of round openings in the testing apparatus were measured and compared to the CAD dimensions. The graph also shows the average measurement of each opening and the deviation from the model. The larger the opening number, the smaller the opening radius. The data shows that when the CAD opening radius is small (opening number is large), the manufactured opening radius is smaller than modeled. This is because at some threshold of opening radius, the particular additive manufacturing process is unable to manufacture an opening, resulting in a measured radius of “0” mm.

FIG. 37 is a graph of the opening diameter data from one embodiment of the testing apparatus of the present invention. Three series (“iterations”) of openings with teardrop shapes in the testing apparatus were measured and compared to the CAD dimensions. The graph shows the measured horizontal diameter and vertical diameters of the teardrop-shaped openings. The graph also shows the drooping offset measured from the difference in the observed and CAD diameters as a function of opening diameter (larger opening numbers correspond to smaller opening diameters).

FIG. 38 is diagram of an expansion deflection nozzle construct of one embodiment of the present invention.

FIG. 39 is an expanded view of a diagram of the small area nozzle throat produced by the pintle of one embodiment of the present invention.

FIG. 40 is an expanded view of the larger area nozzle throat produced by the pintle of one embodiment of the present invention.

FIG. 41 is a diagram depicting the convergent flow when using a high incident angle injector element as described herein.

### DETAILED DESCRIPTION

### Definitions

As used herein, the term “fractal”, refers to a geometry with substantially self-similar structure. In some embodiments, all of or part of the fractal geometry can be symmetric.

As used herein, the term “fractal branching point”, or “fluid diverter” refers to a structural feature in the additively-manufactured heat exchanger which divides fluid flow into from one to two or more fluid streams where the fluid division occurs in a fractal geometric manner.

As used herein, the term “convergent juncture”, refers to a structural feature in the additively-manufactured heat exchanger which combines two or more fluid streams into one fluid stream. In some embodiments, the convergent juncture can include or exclude a fractal geometric structure along the fluid flow paths.

As used herein, the term “convergent passage” refers to a structural feature in the additively-manufactured heat exchanger where the one fluid formed from a convergent juncture traverses.

As used herein, the terms “fluid feeder passage”, or “feeder passage”, refer to structural features in the additively-manufactured heat exchanger where the one fluid stream traverses from a fluid inlet to a fractal branching point.

As used herein, the term “fractal branched cooling passage”, refers to a structural feature where fluid traverses after contacting a fractal branching point.

As used herein, the term “fractal branched conformal cooling passage”, refers to a fractal branched cooling passage that traverses a geometry substantially close to at least one surface of a central cavity within an additively-manufactured mold.

As used herein, the term, the term “mold” is a structure comprising two elements when joined together form an internal cavity. The mold can be an injection mold, an open-pour mold, or a metal injection mold where metal is presented into a cavity then melted during processing.

As used herein, the term “mold insert” (“mold”) is a portion or subset of a mold.

As used herein, the term “barcode”, is a broad term and is used in its ordinary sense, including, without limitation to an identifier element encoding the design build and/or processing parameters. In some embodiments, the barcode is a nine-square pattern composed of a three square by three square matrix where any of the squares may be raised relative to (extruded) or at (non extruded) the surface level. In some embodiments, extruded squares represent binary 1's and non extruded squares represent binary 0's. One some embodiments, extruded squares represent binary 0's, and non extruded squares represent binary 1's. In some embodiments, the barcode includes a decimal corresponding to the binary array, using standard binary decimal conversion, which can represent the testing apparatus model iteration, testing apparatus print iteration, the 3D printer identifier, the material used, and/or the print method used. In some embodiments, the barcode can be selected from a 1-dimensional barcode or a 2-dimensional barcode. In some embodiments, the 1-dimensional barcode can be a 2-width barcode or a many-width barcode. In some embodiments, the 1-dimensional barcode can be of a format selected from: UPC (Universal Product code), ITF (interleaved 2 of 5), Code 93, Codabar, GS1 Databar, Plessey, and MSI Plessey (Modified Plessey). In some embodiments, the 2-dimensional barcode can comprise one or a plurality of shapes representing various aspects of the design build. In some aspects, the 2-dimensional barcode can be of the format selected from: SPARQcode, QR code, Datamatrix Code (including Semacode), Aztec, EZcode, Maxicode, NexCode, Qode, and ShotCode.

As used herein, the term “Series of Concentric Rings” or “concentric rings”, is a broad term and is used in its ordinary sense, including, without limitation to more than one round ring features positioned on at least one testing apparatus side surface. In some embodiments, the series of concentric rings comprises a circle with a radius that varies by no more than five percent. The cross-section profile of the ring can be square or rectangular. The ring feature can be negative or positive, that is, penetrating into or abutting from the testing apparatus side surface. In some embodiments, the series of concentric rings includes a middle ring which is an open or a closed cylinder. The thickness of the rings, as viewed orthogonally from the side surface of the testing apparatus on which the rings are configured, can be the same or different. The series of concentric rings can be used to measure manufacturing properties of small feature tolerances, perimeter resolution, minimum wall thickness, and XY directional variances.

As used herein, the term “perimeter resolution”, is a broad term and is used in its ordinary sense, including, without limitation to the ability to maintain the continuous line forming the boundary of a closed feature in the manufactured part relative to the input design file. Laser power is increased along with scan speed along the components' perimeters of each cross section in order to enhance perimeter definition and resolution while reducing surface roughness. If significantly more heat is transferred to the metal by the laser on the perimeters, then annealing of previous layers will occur. This causes a buildup of residual stresses leading to lips or edges along the perimeters. The height of these edges grow as a function of the number of perimeter layers below. This is highly dependent on material, perimeter laser power, and print methodology. If the height of the edges becomes greater than the material deposition layer height a significant drop in resolution will occur. This may lead to mid-print failure.

As used herein, the term “plurality of openings” or “openings”, is a broad term and is used in its ordinary sense, including, without limitation to one or more features penetrating into the surface of at least one side of the testing apparatus. The openings can be round, oval, or teardrop-shaped. The round openings are circular openings where the openings may not form a perfect circle, but instead may have one or more flat sides to the circle where the tangential angle is not 90 degrees to the center of the openings. In some embodiments, the round openings have a radius which varies no more than fifty percent around the edge of the openings. In some embodiments, the oval openings comprise two pairs of arcs, with two different radii for each arc wherein the arcs are joined at a point in which lines tangential to both joining arcs lie on the same line, thus making the arc juncture continuous. Openings with passages parallel to the build axis are termed “openings with z-radii” or “z-openings.” Openings with passages parallel to the xy-plane (and orthogonal to the build axis) are termed “openings with xy-radii” Or “zy-openings.” Z-opening features demonstrate small feature tolerances and concentricity in the build direction. Consistent variation from the CAD model can be used to offset models to achieve the desired as-build part. Measurement of the smallest “open” z-opening provides information about the minimum feature sizes achievable by the additive manufacturing process. XY-openings can be used to measure small feature tolerances and concentricity orthogonal to the build direction. Consistent variation front the CAD model can be used to offset models to achieve the desired as-build part. Measurement of the smallest “open” xy-opening provides information about the minimum feature sizes achievable by the additive manufacturing process. Openings can also be used to measure manufacturing properties selected from small feature tolerances, concentricity, and drooping. The bottom half of the teardrop-shaped openings can be round. The round bottom half of the teardrop openings are circular where the openings may not form a perfect half circle, but instead may have one or more flat sides to the half circle where the tangential angle is not 90 degrees to the center of the opening. The top half of the teardrop opening is shaped to where two aspects of the opening profile connect at a single point. Teardrop shaped openings are used to measure passage drooping. In some embodiments an over or under-exaggerated teardrop shaped opening can further reduce resolution of a passage. The extent to which a teardrop offset should be employed depends highly on the additive manufacturing process, including the printer method, material type, and opening radius. Data from the teardrop shaped openings can be used with drooping information from in-plane round openings to determine the ideal degree of teardrop offset to apply to a given opening model in order to achieve the desired circular shape of an opening. In some aspects, the opening can traverse the entirety of the testing apparatus to form a passage. In some aspects, the opening only penetrates a portion of the testing apparatus.

As used herein, the term “concentricity”, is a broad term and is used in its ordinary sense, including, without limitation to the common center of circles. In additive manufacturing, the tooling path of many mobile sintering, melting, or deposition heads can be highly variant. Standard geometric test features for concentricity are necessary for measuring quality parameters across numerous printing methodologies and materials. Curvature resolution can be limited by a stepper motor responsible for the positioning of a deposition head or laser. Controlling moving components in additive manufacturing is commonly constructed in Cartesian XY fashion, such that for smooth arcs actuation of both (X- and Y-) steppers is required. Minor stepper motor errors or deviations from their expected timing or step size can cause significantly decreased resolution.

As used herein, the term “Drooping”, is a broad term and is used in its ordinary sense, including, without limitation to the unintended sintering of loose metal powder along a z-axis within a cavity by the sintering laser as it applies heat to the solid region above the cavity. During additive manufacturing, unsupported internal cavities can be made within a component. This can be accomplished by filling the cavities with either metal powder or removable support material comprised of the same alloy used for the solid geometry of the object to be manufactured. For an internal cavity which extends in the xy-plane, the cavity is filled with powder which is not sintered. The cavity is constructed of layers of metal powder about 20 to about 100 microns in thickness spread over the previously sintered xy plane layer, increasing the component height in the z direction with each layer. While the bottom half of the cavity can be printed with little variation outside the expected tolerances and surface roughness characteristics, the top half of the cavity can exhibit drooping. In some embodiments, drooping is characterized by a decreased passage diameter when measured from bottom to top. In some embodiments, drooping is characterized by a function fit to the closed contour of the drooped circular cross section of the zx and zy planes, as shown in FIG. 20. In some embodiments, the z-axis is the axis parallel to gravity when the testing apparatus is additively manufactured. The xy-plane is orthogonal to the z-axis.

As used herein, the term “Angled openings”, is a broad term and is used in its ordinary sense, including, without limitation to one or a plurality of openings which penetrates into the surface of at least one side surface of the testing apparatus at an angle of incidence which is not 90 degrees to said side surface. The angle of incidences can be from 1 to 89 degrees. In some embodiments, the angle of incidence is 30 degrees. In some embodiments, the angle of incidence is 45 degrees. In some embodiments, the angle of incidence is 60 degrees. In some embodiments, the angle of incidence is 75 degrees. The angled openings can penetrate one or more side surfaces of the testing apparatus. Angled openings can be used to measure small feature tolerances, concentricity, drooping, and angular accuracy. In some embodiments, combining the data gathered from the xy-plane openings with angled openings allows for accurate modeling of the drooping of more complex openings systems. Apparent resolution of the openings at the various angles yields information about the effect of angle on feature generation. The steeper the angle, the greater the impact of the print layer height. Data from angled openings and tapered ramps can be used to measure roughness and resolution profiles of internal curved passages.

As used herein, the term “tapered edge ramp”, or “tapered ramp” is a broad term and is used in its ordinary sense, including, without limitation to one or a plurality of planes which may be angled to partially bisect two of the testing apparatus side surfaces. The angle can be from 1 to 89 degrees, preferably selected from 1, 15, 30, 45, 60, and 75 degrees. The plane can extend across the entire edge of a testing apparatus side surface or be limited to a sub-section of the edge of a testing apparatus side surface. Surface roughness varies with angle and face normal direction relative to the build plate. The inventors have discovered that downward facing tapered ramps exhibit more surface roughness and a higher degree of variation than upward facing tapered ramps. The inventors have discovered that downward facing tapered ramps at angles greater than 45 degrees can exhibit variation due to drooping. Data from tapered ramps and be used to create a roughness profile of an internal curved passage. Tapered Ramps can also be used to measure layer resolution, angular accuracy, angular surface roughness, and drooping.

As used herein, the term “planar tapered edge ramp”, or “small-angle ramp” is a broad term and is used in its ordinary sense, including, without limitation to ramps which exhibits a small angle (including 1.0 (+1-0.5) degrees) of vertical displacement in the build orientation. Planar tapered edge ramps enable optical resolution of the surfaces of individual layers. In some embodiments, additive manufacturing processes, including powder bed manufacturing, have layer heights which can range from 10 to 250 microns. In some embodiments, planar tapered edge ramps enable elucidation of the laser in fill pattern. The material direction interior to the testing apparatus exhibits perimeter edge variations due to the ramp's vertical offset. The inventors have discovered that downward facing planar tapered edge ramps demonstrate maximum drooping variation due to their lack of support material. In some embodiments, support material generation resolution information is obtained when support material is generated for the ramp. In some embodiments, when the ramp is downward facing, the ramp exhibits on-support surface resolution variation, tolerances, and surface roughness.

As used herein, the term “surface roughness”, is a broad term and is used in its ordinary sense, including, without limitation to the degree of variation from planarity of a surface. The surface roughness of power bed components can be non-uniform. Surface roughness is a function of the angle of the surface normal vector with respect to the build direction. In some embodiments, the maximum roughness is seen in the case of overhangs, where the surface normal vector is in the −Z direction (−90 degrees), where +Z is the build direction. In some embodiments, the minimum surface roughness occurs where the normal vector is in the +Z direction (+90 degrees). Surface roughness can be measured a percent of variance in surface height from the planarity of the surface.

As used herein, the term “Stepped Trough”, is a broad term and is used in its ordinary sense, including, without limitation to one or a plurality of sheet structures, each formed by two successive ridges and an interposed passage, the entirety of which penetrates into a testing apparatus side surface. Stepped Troughs can be used to measure the minimum negative feature resolution due to perimeter tolerances, and also manufacturing small feature tolerances, perimeter resolution, minimal wall thickness, and xy directional variances.

As used herein, the term “Stepped ridge”, is a broad term and is used in its ordinary sense, including, without limitation to one or a plurality of abutments from at least one side surface of the testing apparatus, which are semi-trapezoidal in shape, optionally with a series of tapered edges along one or more side abutments. The Stepped ridge can be used to measure manufacturing small feature tolerances, perimeter resolution, minimal wall thickness, and xy directional variances.

As used herein, the term “Orientation Text”, is a broad term and is used in its ordinary sense, including, without limitation to a character which indicates one or more of the z-direction, top side surface, left side surface, right side surface, front side surface, back side surface, bottom side surface, x-direction, and y-direction. The character can abut from and/or penetrate into the surface of at least one side surface of the testing apparatus. In some embodiments, the Orientation text comprises an arrow, part of an arrow, or chevron pattern. In some embodiments, the Orientation text comprises a word or letters.

As used herein, the term “Standoffs”, is a broad term and is used in its ordinary sense, including, without limitation to one or a plurality of rectangular or circular abutments from the bottom side surface of the testing apparatus. The standoffs can provide support for the testing apparatus enabling the testing apparatus to lie flat on a separate surface. In some embodiments, the rectangular abutment can be square-shaped. Standoffs can be used to measure the manufacturing support material generation method, lower surface overhang, and surface roughness.

As used herein, the term “Dimple”, is a broad term and is used in its ordinary sense, including, without limitation to one or a plurality of concave rounded features configured on and abutting from at least one side surface of the testing apparatus. In some embodiments, dimples are hemispheric indentations on the surface of at least one side surface of the testing apparatus. Dimples can be used to measure manufacturing small feature tolerances, perimeter resolution, concentricity, in-fill method, overhang, and drooping.

As used herein, the term “overhang”, is a broad term and is used in its ordinary sense, including, without limitation to the build material which unintentionally penetrates into a recess in a feature. Laser infill patterns vary by layer but are consistent within each layer. The unsupported lips or edges are affected by the unintentional sintering of powder layers below the target layer, resulting in loss of features when designed into an object for additive-manufacturing.

As used herein, the term “Bump”, is a broad term and is used in its ordinary sense, including, without limitation to one or a plurality of convex rounded features configured on and penetrating into at least one side surface of the testing apparatus. In some embodiments, the dimple is a hemispheric protrusion from the side surface of the testing apparatus. Bumps can be used to measure manufacturing small feature tolerances, perimeter resolution, and concentricity.

As used herein, the term “Beveled Edge”, is a broad term and is used in its ordinary sense, including, without limitation to one or a plurality of planes with bisect two orthogonal side surfaces of the testing apparatus. The Beveled Edge can extend for the entirety of any of the testing apparatus edges. Beveled Edges can be used to measure the manufacturing properties of layer resolution, angular accuracy, and angular surface roughness.

### Conformal Cooling Passages in Additive Manufacturing Processes

It was discovered that additive manufacturing allows for the creation of fractal based cooling passages in heat exchangers. Fractal branched cooling passages use a branching technique to allow the flow of fluid from an inlet to an arbitrary number of outlets while maintaining the requisite mass flow rate. When the heat exchanger is a mold comprising a central cavity, the branched passages conform to the contour of the central cavity defining the surface of a plastic part to be created to provide even heat transfer near said surface. By maintaining the overall cross sectional area throughout the flow geometry (passage length), significant pressure changes and therefore turbulence is eliminated yielding zero head loss. In some embodiments, the total cross sectional area of the plurality of fractal branched cooling passages is substantially the same throughout the entirety of the length of the passage. In some embodiments, the fractal branched cooling passage can be used for temperature modulation.

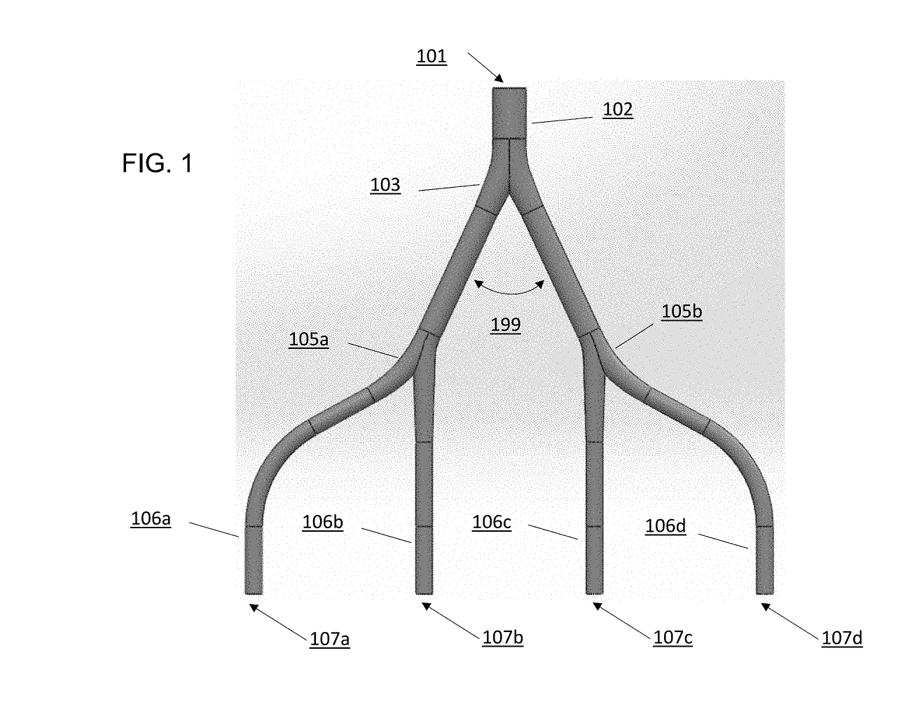

Referring to FIG. 1, the geometry of a fractal branched cooling passage includes an inlet to the first fluid feeder passage 101 which directs fluid flow through and is in fluidic communication with, the first feeder passage 102 in a continuously smooth manner. The fluid branches at the first generation fractal branching point 103 (also referred to herein as “a fluid diverter”), which is in fluidic communication with the first feeder passage 102. In some embodiments, there are a plurality of generations of fractal branching points. Each generation of fractal branching points is in fluidic communication with the preceding generation of fractal branching point. In some embodiments, the fluid flow is divided at the first generation fractal branching point 103 into two or more first generation fractal branched passages 104 which are in fluidic communication with the fractal branching point. In some embodiments, the fluid flow is divided at two or more second generation fractal branching points 105a and 105b, each of which individually are in fluidic communication with the fractal branching point. In some embodiments, the fluid flow is directed along two or more second generation fractal branched passages 106a 106b 106c and 106d, each of which are in fluidic communication with the fractal branching point. In some embodiments, any of the generations of fractal branched passages can direct fluid flow to an outlet 107 which is in fluidic communication with said fractal branched passages, where the fluid is optionally collected, re-cooled and recirculated to be in fluidic communication with the inlet to the first fluid feeder passage 101, or discarded. In some embodiments, any of the generations of fractal branched passages can converge into one or a plurality of convergent passages which is in fluidic communication with said fractal branched passages. In some embodiments, there can be a first feeder passage, a second feeder passage, a third feeder passage, and/or a fourth feeder passage, each of which can present the same, or different, fluid type and/or fluid at different temperature. In some embodiments, there can be from one or a plurality of, inclusive, of fractal branched passages, with each generation comprising two or a plurality of passages. In some embodiments, there can be one or a plurality of convergent passages.

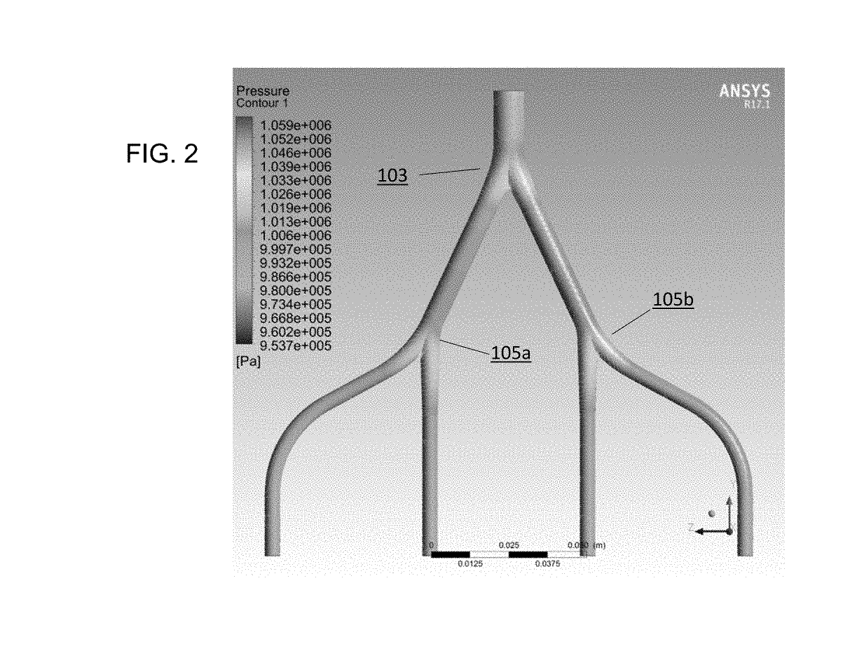

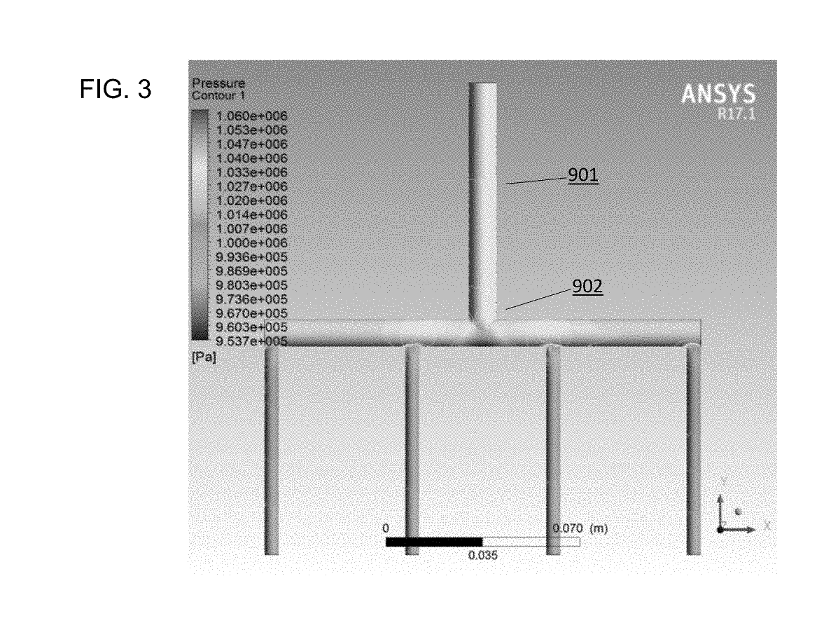

The backpressure simulation of the passage pattern geometry of FIG. 2 compared to that of FIG. 3 demonstrates that optimal fluid passage patterning designed by the methods described herein can significantly reduce backpressure throughout the passages. The simulation was calculated using Ansys™ modeling software with the appropriate modalities. The pressure is given in relative pressure units (Pascals). As can be observed from the simulation in FIG. 2, the pressure difference at the first branched juncture point 103 relative to the first fractal branched passage is less than 42,000 Pa (42 kPa, or about 6 PSI in imperial units). In some embodiments, the pressure difference throughout the fractal branched passages is less than 30 kPa, 35 kPa, 40 kPa, 45 kPa, 50 kPa, 55 kPa, 60 kPa, 65 kPa, 70 kPa, 75 kPa, 80 kPa, 85 kPa, 90 kPa, 95 kPa, 100 kPa, or higher. As seen in FIG. 2, the backpressure is elevated in minimal areas of the fluid passages of the fractal branched passages relative to the surface area of the fluid passages of non-fractal branched passages of FIG. 3.

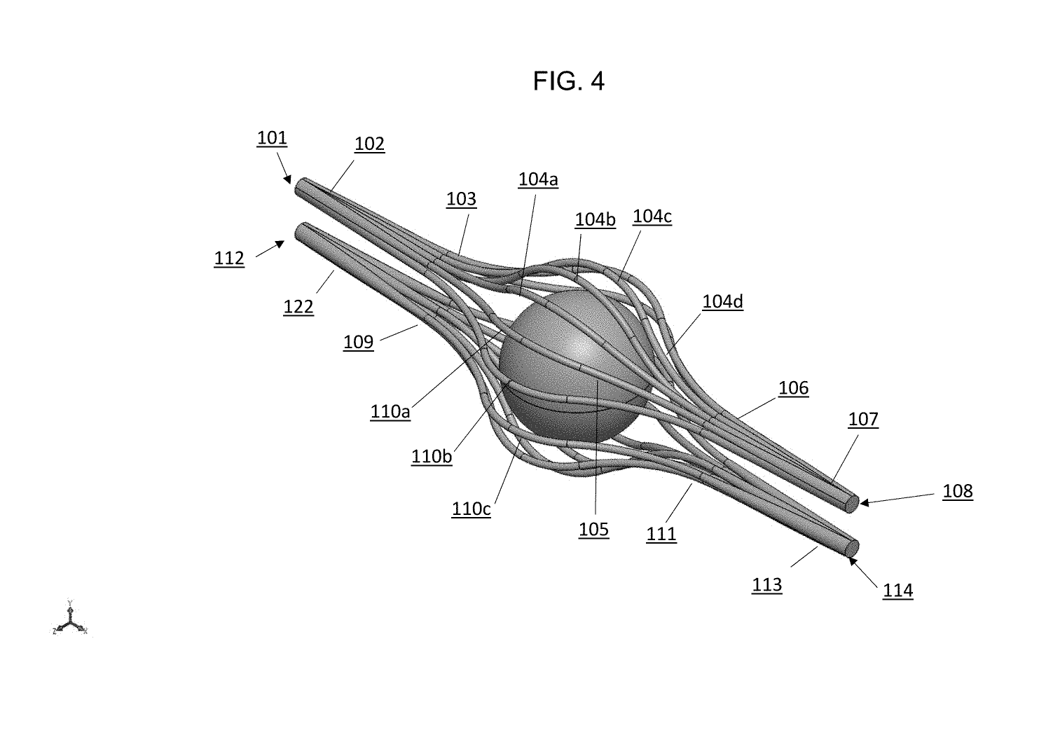

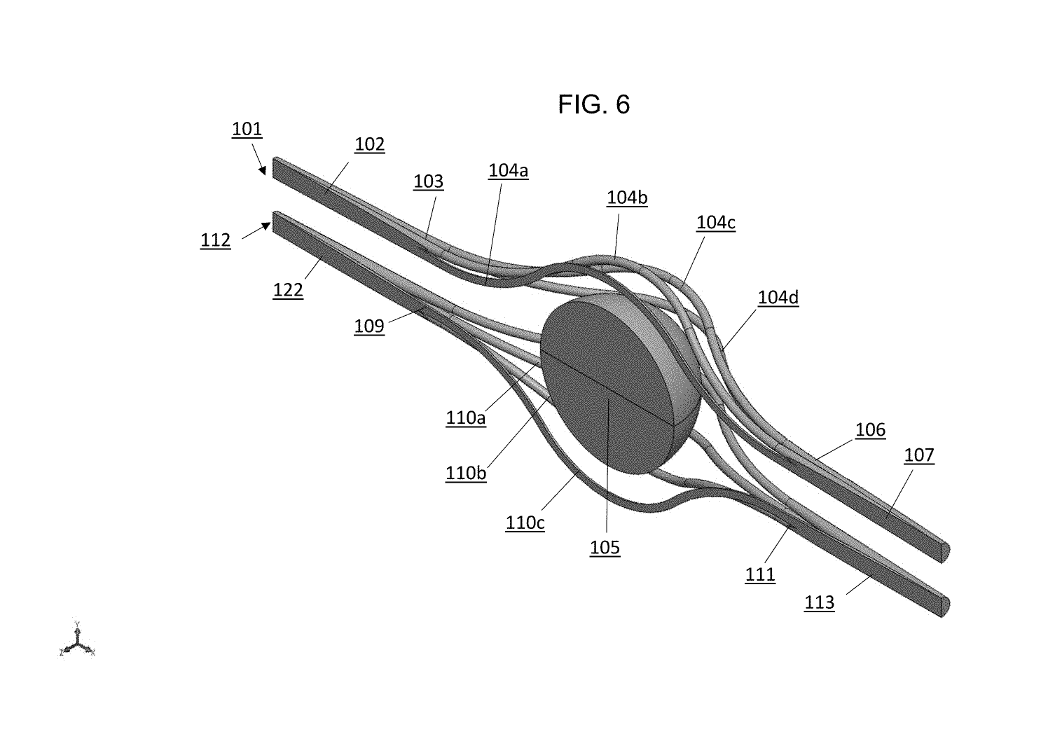

Referring to FIG. 4 and FIG. 6, the geometry of a set of continuously smooth conformal fractal branched cooling passages around the surfaces of a central cavity is presented. The additively-manufactured mold inserts are not shown for purposes of clarity. In some embodiments, a first fluid is presented in a first fluid feeder passage 101. A second fluid is presented in a second fluid feeder passage 102, which is not in fluidic communication with the first fluid feeder passage 101. In some embodiments, the first feeder fluid and the second feeder fluid are the same type, or are different. In some embodiments, the first feeder fluid and the second feeder fluid are at the same temperature, or at different temperatures. The first fluid feeder passage is in fluidic communication with a first fluid first generation fractal branching point 103. The first fluid first generation fractal branching point 103 is in fluidic communication with two or more first generation first fluid fractal branched passages 104a, 104b, and 104c. A portion of the two or more first generation first fluid fractal branched passages 104 are positioned near one or a plurality of central cavities defining the surface of an object of a part to be created 105. In some embodiments, heat can be transferred from the one or a plurality of central cavities 105 to the first fluid in the first fluid fractal branched passages 104. The first fluid first generation fractal branched passages 104 can converge at a first fluid convergent juncture 106 to direct fluid into a first fluid convergent passage 107. In some embodiments, the fluid in the first fluid convergent passage 107 can exit from the first passage outlet 108 and can be collected, re-cooled, or discarded. In some embodiments, the second fluid flow in the second fluid feeder passage 112 is directed to a second fluid first generation fractal branching point 109 to direct fluid into one or a plurality of second fluid first generation fractal branched passages 110a, 110b, and 110c. In some embodiments, the second fluid first generation fractal branched passages can be positioned near one or a plurality of central cavities defining the surface of an object of a part to be created 105. In some embodiments, heat can be transferred from the one or a plurality of central cavities 105 to the first fluid in the fractal branched passages 110. The second fluid first generation fractal branched passages 110 can converge at a second fluid convergent juncture 111 to direct fluid into a second fluid convergent passage 113. In some embodiments, the fluid in the second fluid convergent passage 112 can exit from the second passage outlet 114 and can be collected, re-cooled, or discarded.

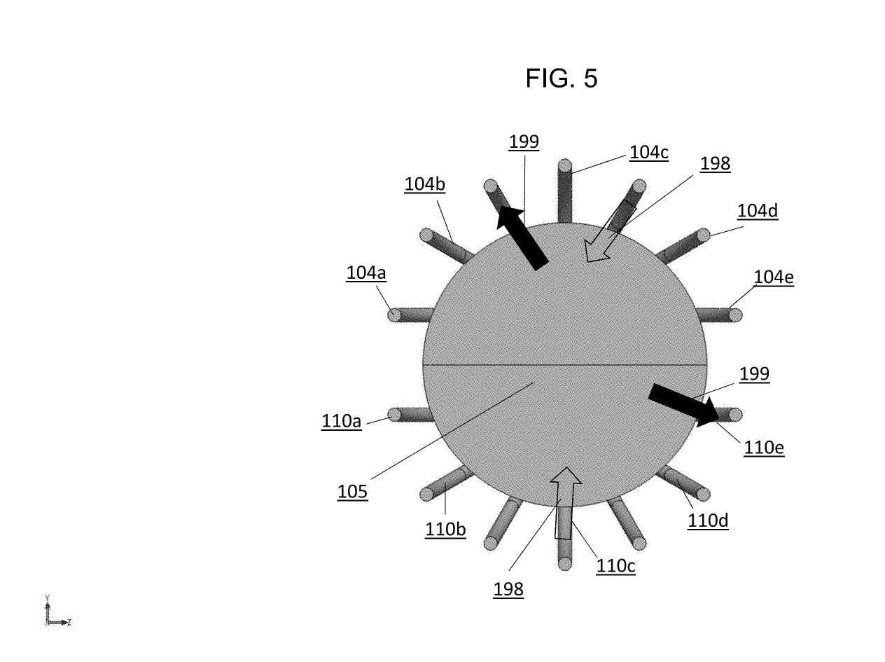

Referring to FIG. 5, a first fluid fractal branched passages 104 is positioned near, but not in fluidic communication with, one or more central cavities defining one or more surfaces of a part to be made 105. In some embodiments, a second fluid first generation fractal branched passages 110 is located near, but not in fluidic communication with, one or more central cavities defining one or more surfaces of a part to be made 105. In some embodiments, heat flow 199 transfers from the one or more cavities defining one or more surfaces of a part to be made 105 to the first fractal branched passages 104 and second fractal branched passages 110 when liquid at a temperature less than that of the central cavity is presented into said passages. In some embodiments, heat flow 198 transfers from the first fractal branched passages 104 and second fractal branched passages 110 to the one or more cavities defining one or more surfaces of a part to be made 105 when the temperature of the liquid is higher than the temperature of the central cavity 105.

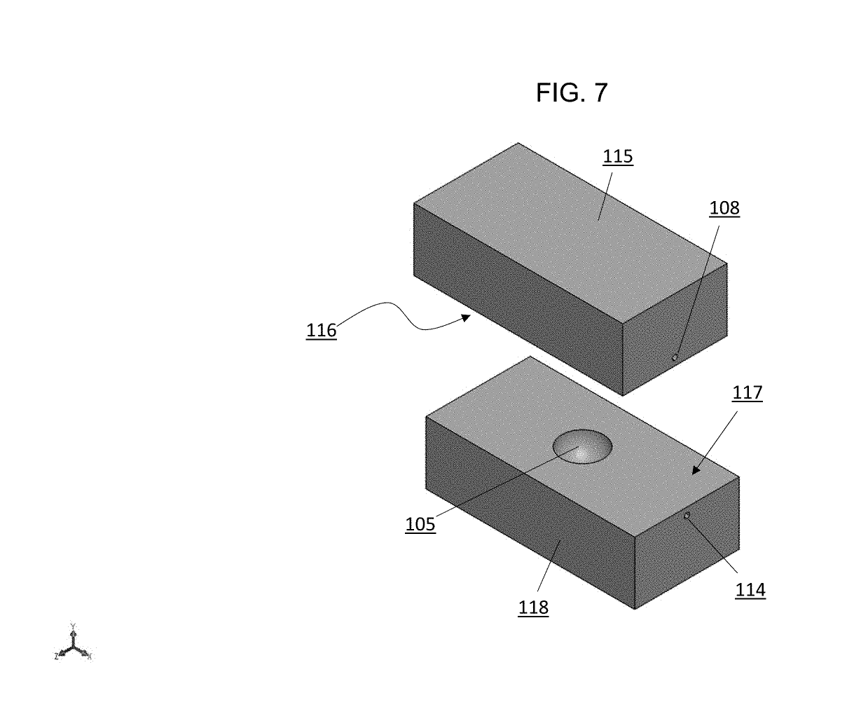

Referring to FIG. 7, a first additively manufactured mold 115 comprising a first fluid conformal fractal branching passages and a first fluid convergent passage outlet 108 and a mold-mold contacting surface of a first additively-manufactured mold is disposed with a second additively manufactured mold 118 comprising a second fluid conformal fractal branching passages and a second fluid convergent passage outlet 114 and a mold-mold contacting surface of a second additively-manufactured mold 117 such that the contacting surfaces 116 and 117 are in contact with each other. In some embodiments, plastic material is presented to the cavity defined by the first central cavity surface and the second central cavity surface 105. The mold is heated above the softening temperature of the plastic material for a selected time sufficient to allow the melted plastic material to conform to the central cavity. The one or more liquids are then presented into the conformal fractal branching passages (not shown for clarity) which are at a temperature less than the temperature of the central cavity. The first additively manufactured mold 115 is then separated from the second additively manufactured mold 116 and a formed plastic part is removed from the central cavity 105.

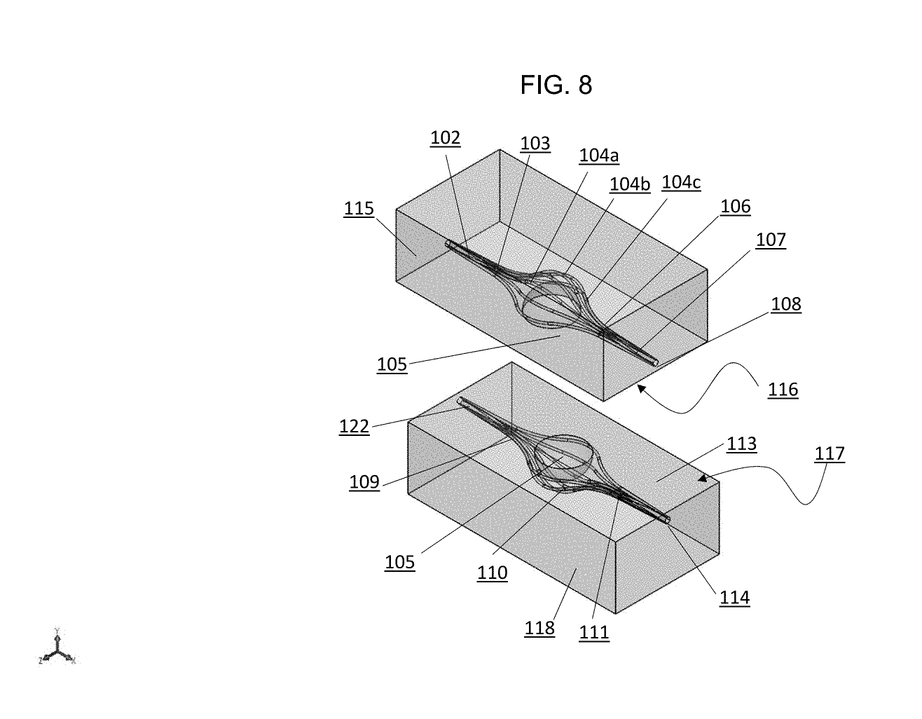

Referring to FIG. 8, a first additively manufactured mold 115 comprises a first fluid feeder passage 101 in fluidic communication with a first fluid feeder fractal branching point 103 which is in fluidic communication with a first fluid fractal branched passages 104, which is in fluidic communication with a first fluid convergent juncture 106, which is in fluidic communication with a first fluid convergent passage 107, which is in fluidic communication with a first fluid convergent outlet 108, a first central cavity surface defining part of a central cavity 105, and a mold-mold contacting surface of a first additively manufactured mold 116. The contacting surface 116 is contacted with a second additively manufactured mold 118 comprising a second fluid feeder passage 102, which is in fluidic communication with a second fluid fractal branching point 109, which is in fluidic communication with a second fluid fractal branched passages 110, which is in fluidic communication with a second fluid convergent junction 111, which is in fluidic communication with a second fluid convergent outlet 114, a second central cavity surface defining part of a central cavity 105, and mold-mold contacting surface of a second additively manufactured mold 117 such that the contacting surfaces are brought into contact with each other. In some embodiments, plastic material is presented to the cavity defined by the first central cavity surface and the second central cavity surface 105. The mold is heated above the softening temperature of the plastic material, then one or more liquids are presented to into the conformal fractal branching passages which are at a temperature less than the temperature of the central cavity. The first additively manufactured mold 115 is then separated from the second additively manufactured mold 116 and a formed plastic part is removed from the central cavity 105.

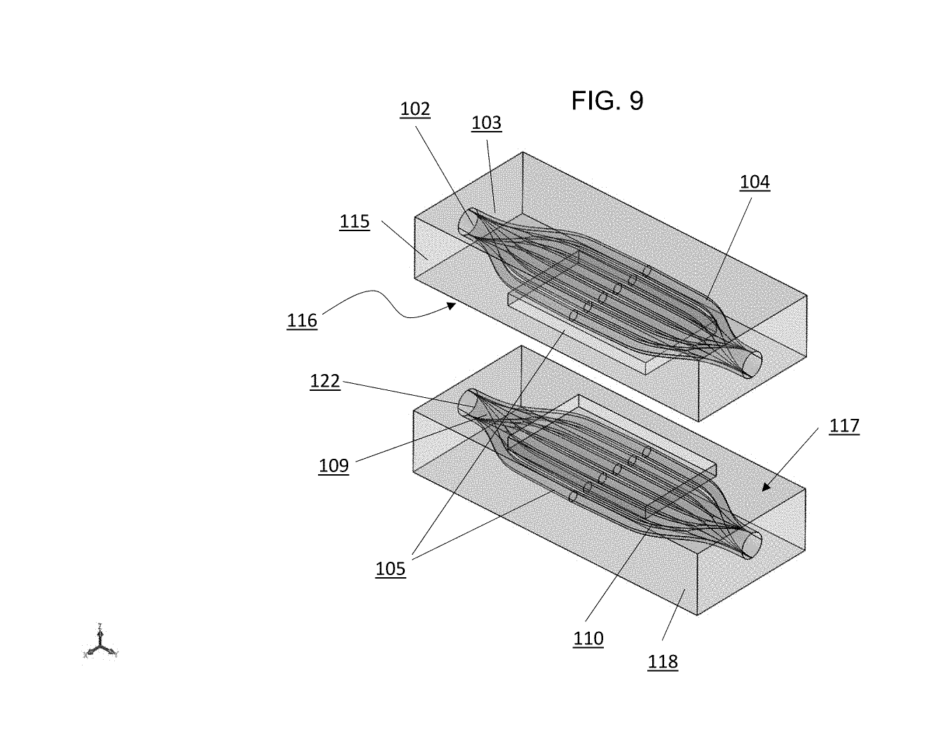

Referring to FIG. 9, this disclosure includes an embodiment where a first additively manufactured mold 115 and a second additively manufactured mold 116 together comprise a surface defining a central cavity 105 where the central cavity is in the shape of a polyhedron. In some embodiments, the central cavity is in the shape of a sphere. In some embodiments, the central cavity defines an ellipsoid. In some embodiments, the central cavity defines an irregular shape.

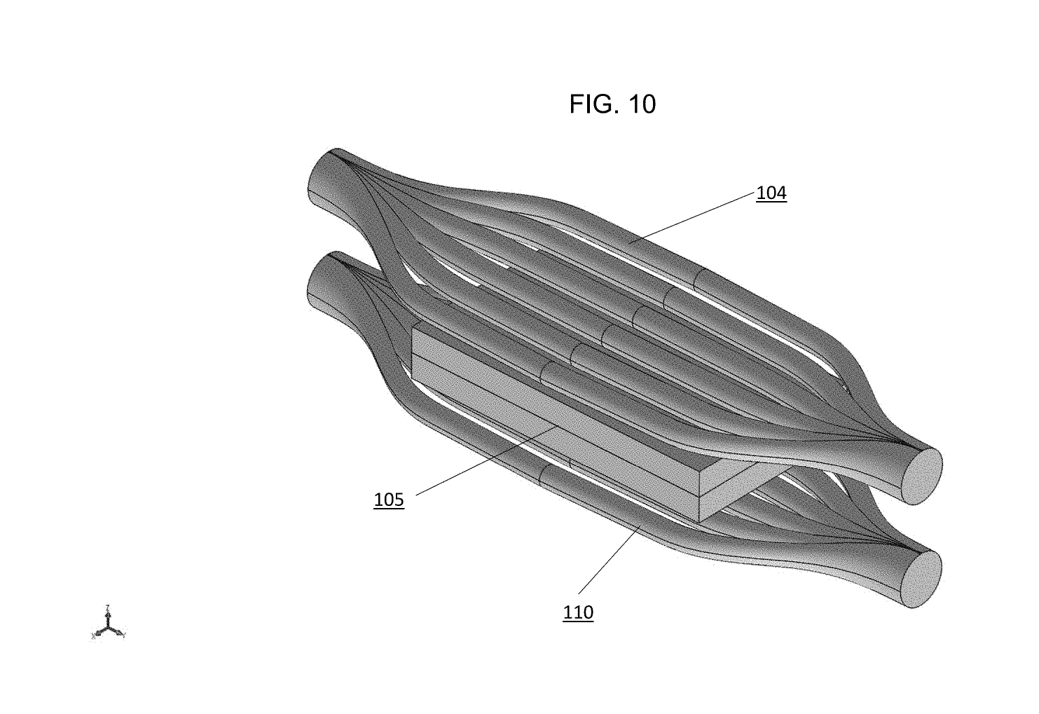

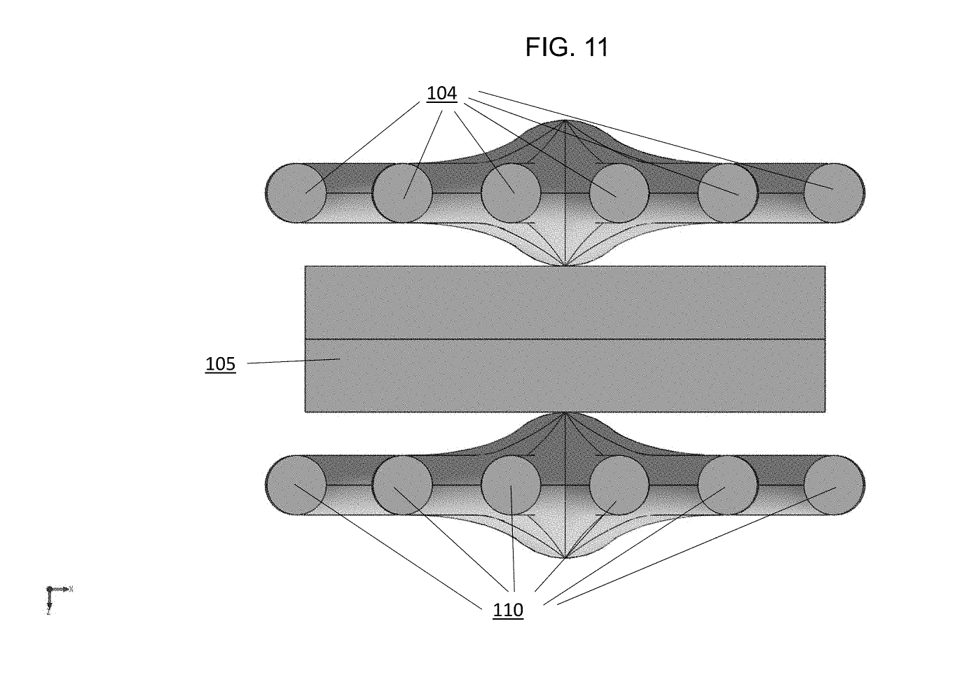

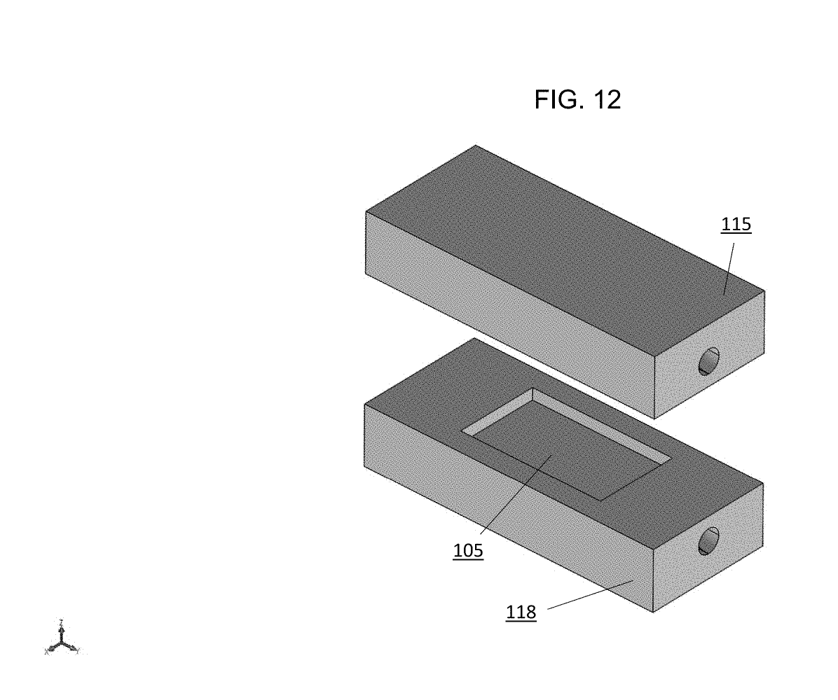

Referring to FIG. 10, FIG. 11, and FIG. 12, this disclosure includes an embodiment where first fluid fractal branching passages 104 and second fluid fractal branched passages 110 conform to a central cavity defining a polyhedron shape 105. In some embodiments, the first fluid fractal branching passages 104 are not in fluidic communication with the second fluid fractal branched passages 110. In some embodiments, the first fluid fractal branching passages 104 are in fluidic communication with the second fluid fractal branched passages 110, where the fluid in the first fluid fractal branching passages 104 is recirculated into the second fluid fractal branching passages 110.

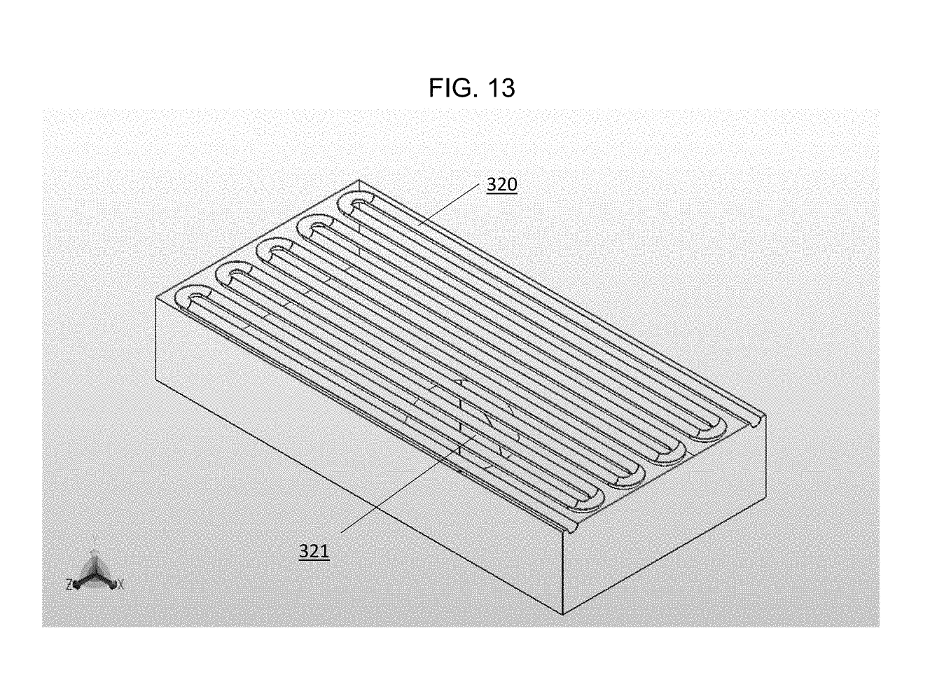

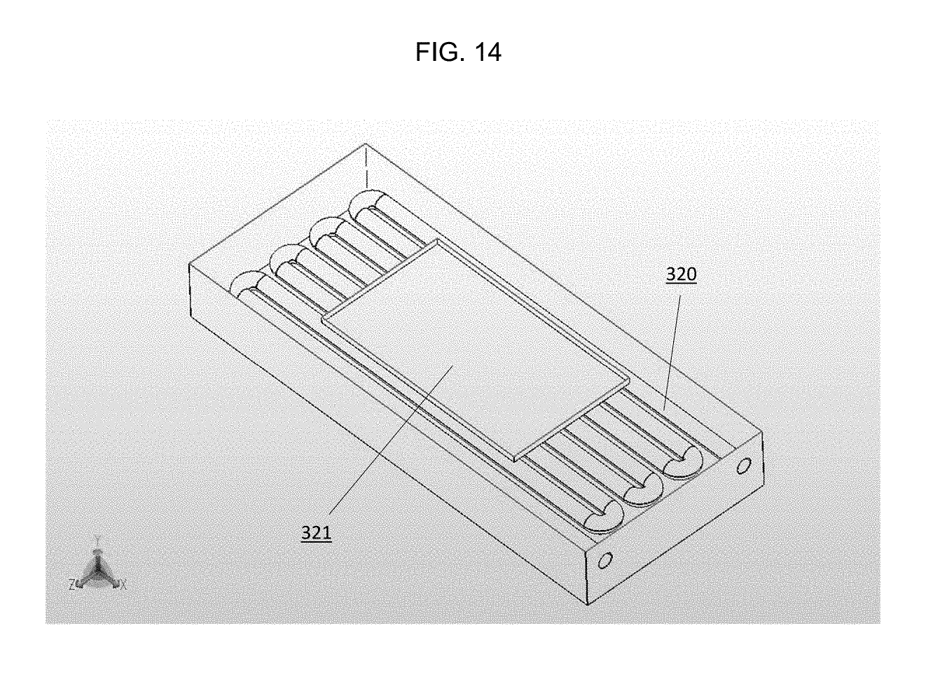

FIG. 13 and FIG. 14 describe a non-conforming cooling passage which is a reference comparison to the described fractal branched conformal cooling passages of the present disclosure. A mold comprises a non-conformal cooling passage 320 which is located near a central cavity having a spherical or polyhedral shape 321. The cooling passage is created on a single horizontal plane, by which some portions of the non-conformal cooling passage 320 are positioned away from the central cavity 321 and therefore provide minimal heat transfer to said central cavity.

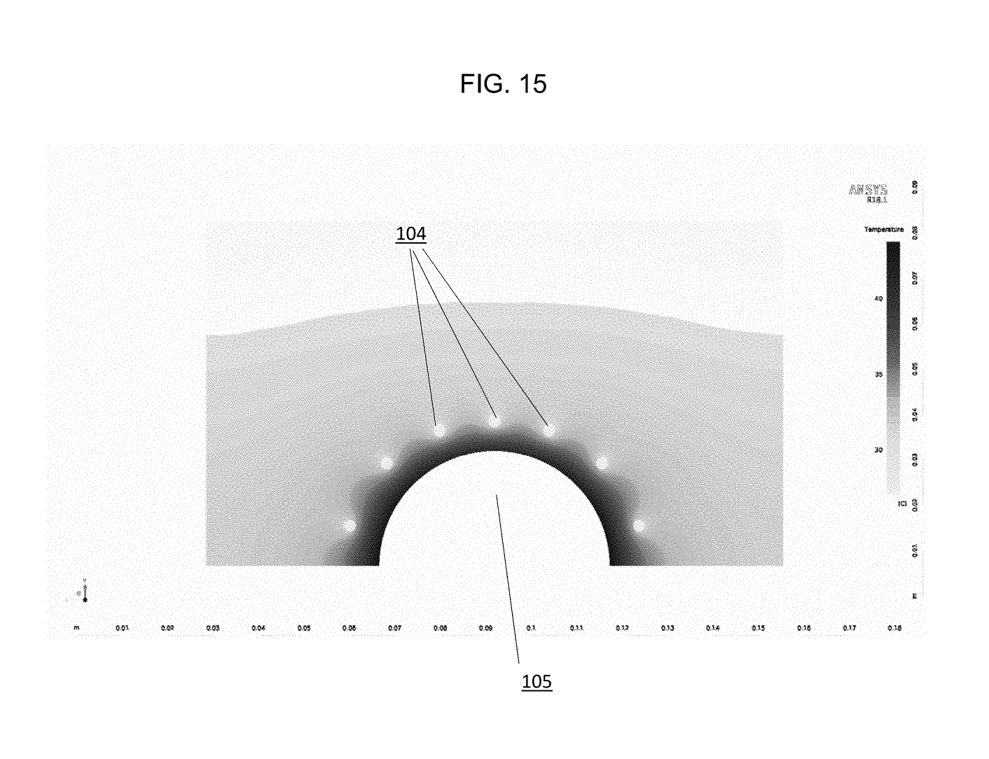

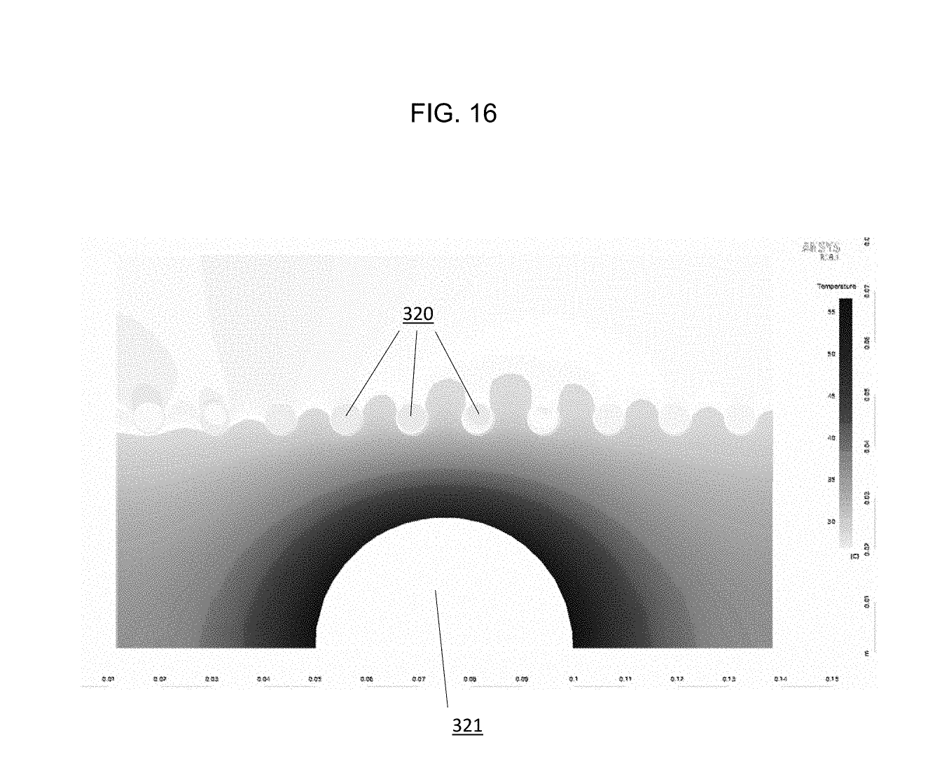

Referring to FIG. 15, the temperature profile is at the regions of the mold closest to the surface of the central cavity when the cooling passages are configured to be fractal branched conformal cooling passages 104 of the configuration depicted in FIG. 4, around a central cavity 105 (sphere). This demonstrates the ability to control the thermal profile using conformal passage geometry. In contrast, as shown in FIG. 16, temperature profile is non—at the regions of the mold closest to the surface of the central cavity when the cooling passages are configured as non-conformal cooling passages.

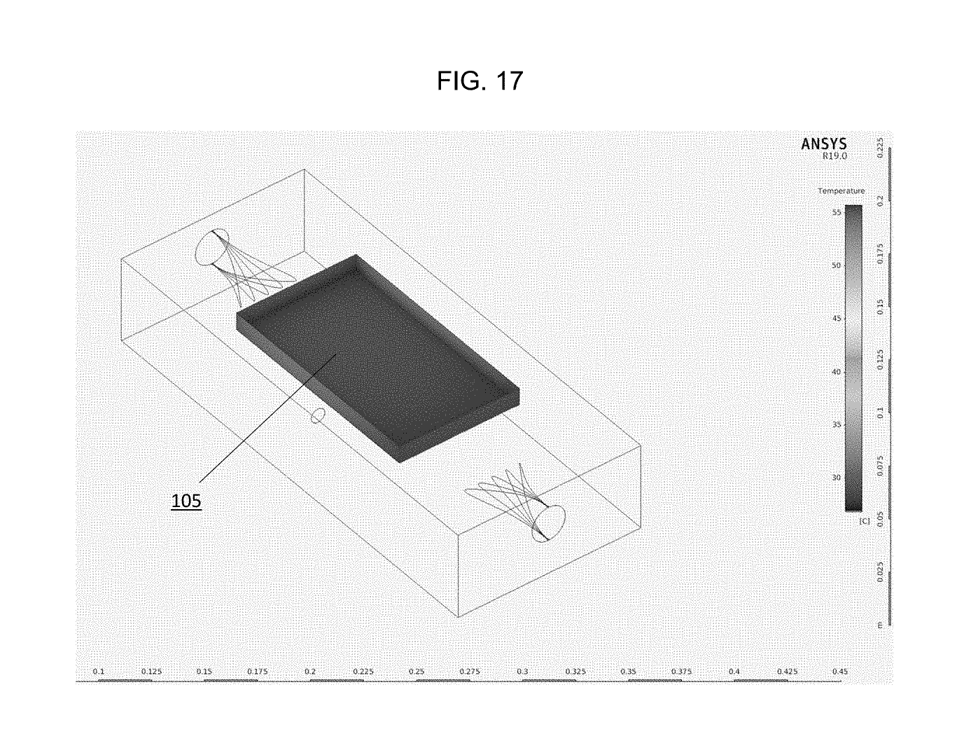

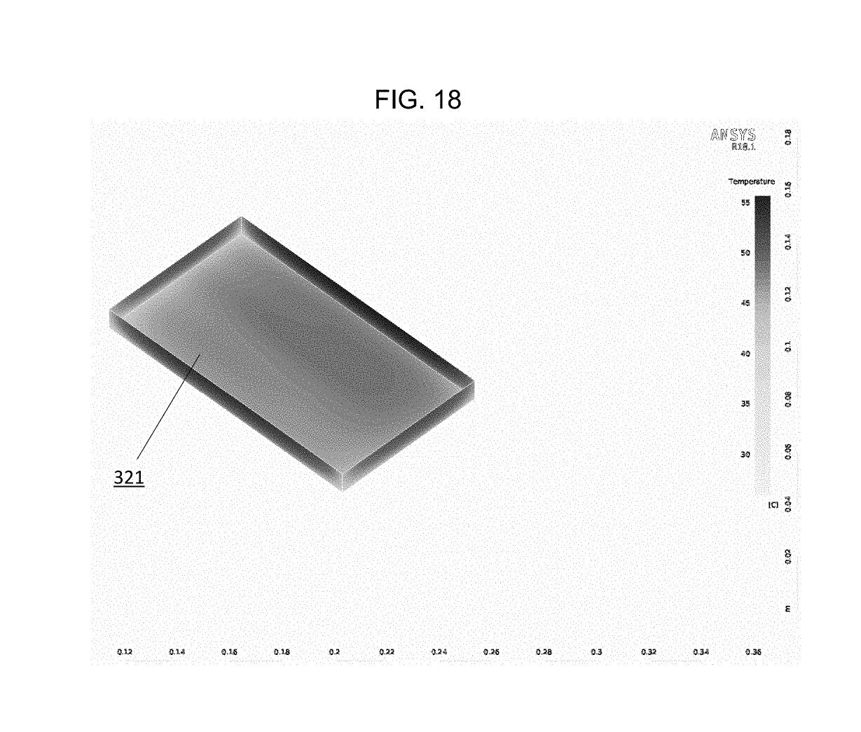

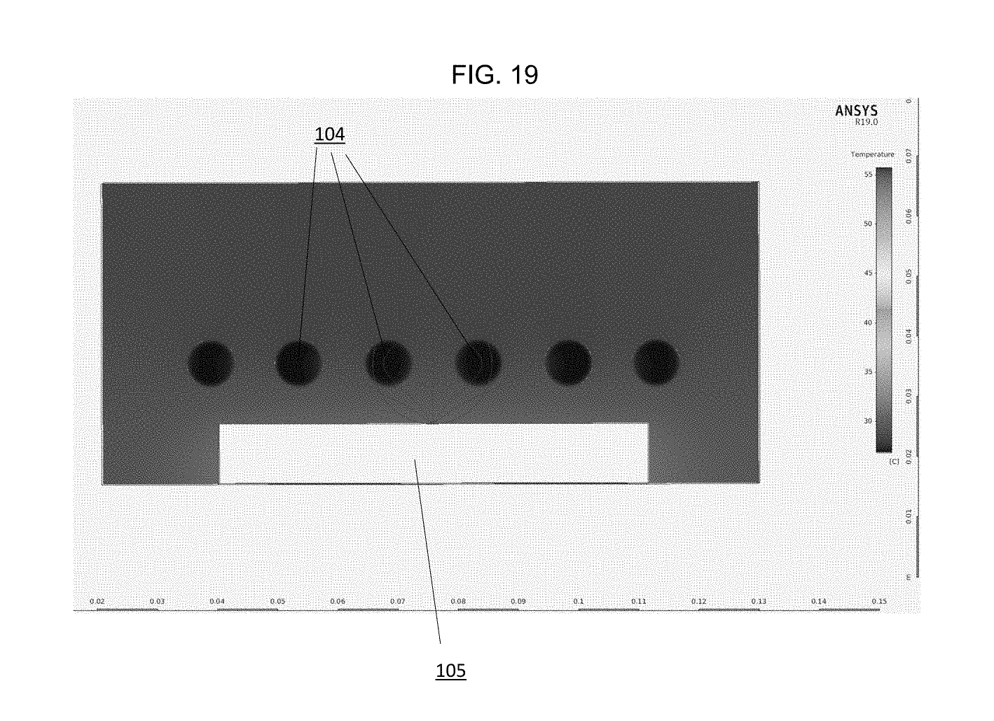

Referring to FIG. 17, the temperature profile is substantially homogeneous throughout the central cavity comprising a polyhedron when fractal branched conforming cooling passages are used. In contrast, as seen in FIG. 18, the polyhedron temperature profile is heterogenous throughout the polyhedron central cavity when non-fractal branched cooling passages are used. The results show the temperature profile is heterogeneous at the regions of the mold closest to the surface of the central cavity around the cavity, with the regions of the mold farthest from the non-conformal cooling passages higher in temperature relative to the regions of the mold closest to the non-conformal cooling passages. The side-profile heatmap shown in FIG. 19 shows the substantially homogeneous temperature profile of the mold surrounding a part of a central cavity comprising a polyhedron when fractal branched conforming cooling passages are used. In some embodiments, the multiple fractal branched cooling passages, each with a fluid which has not yet been in thermal contact with the central cavity, has a higher heat capacity to receive heat transfer from the warmed central cavity than a single-channel non-fractal branched cooling passage. As shown in FIG. 20, the side-profile heatmap of the non-fractal branched cooling passages surrounding a part of a mold comprising a central cavity comprising a polyhedron shows significant temperature differences in the portion of the outer sides of the mold compared to the portion of the mold between the cooling passages and the central cavity.

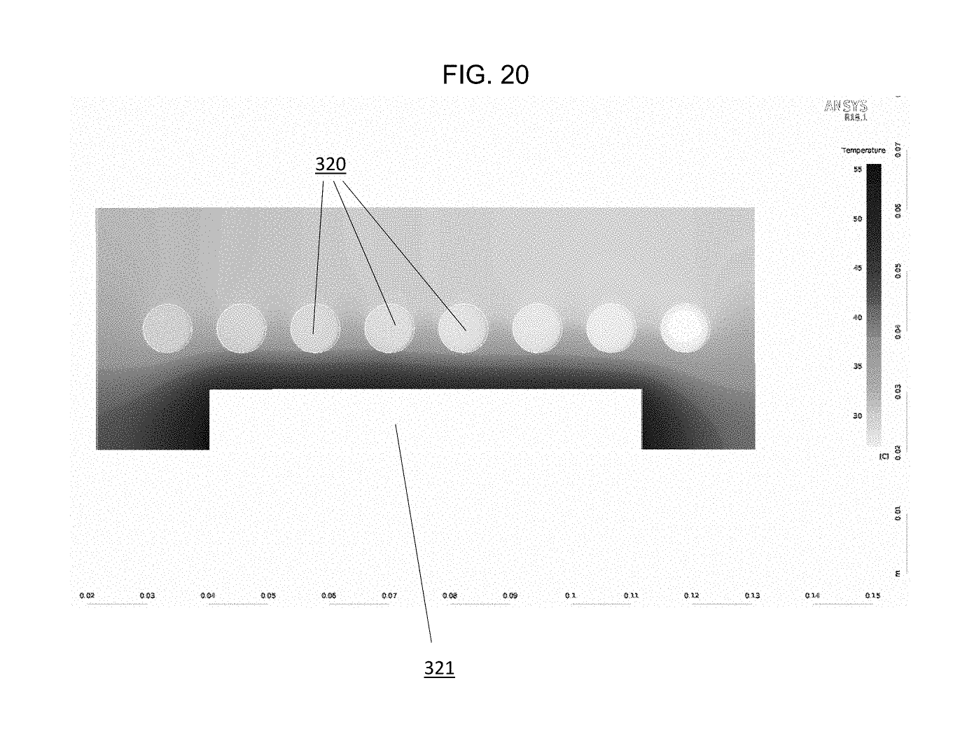

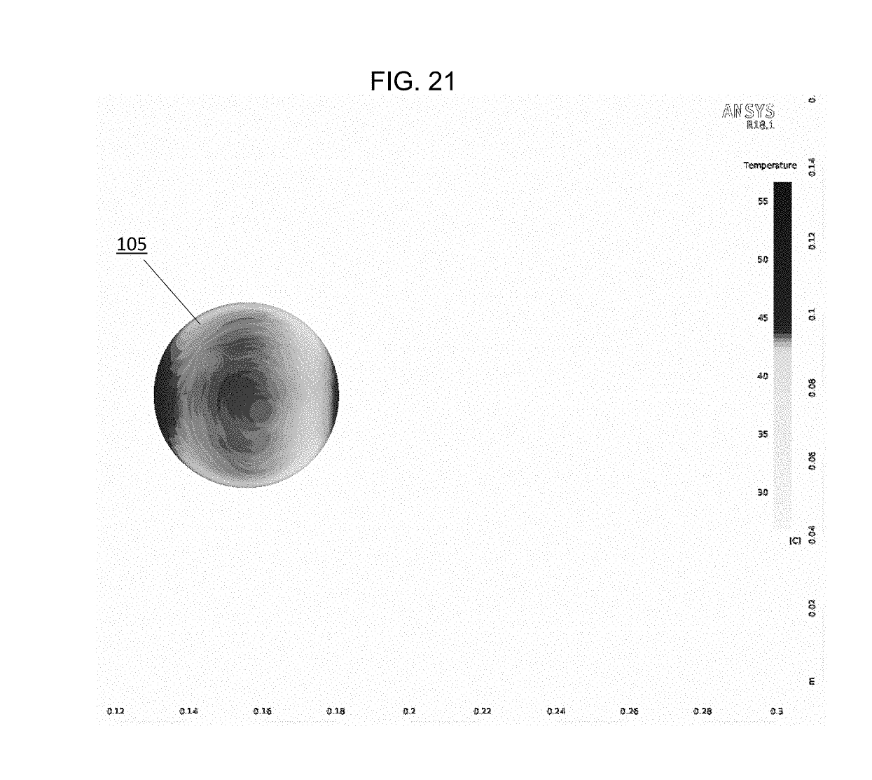

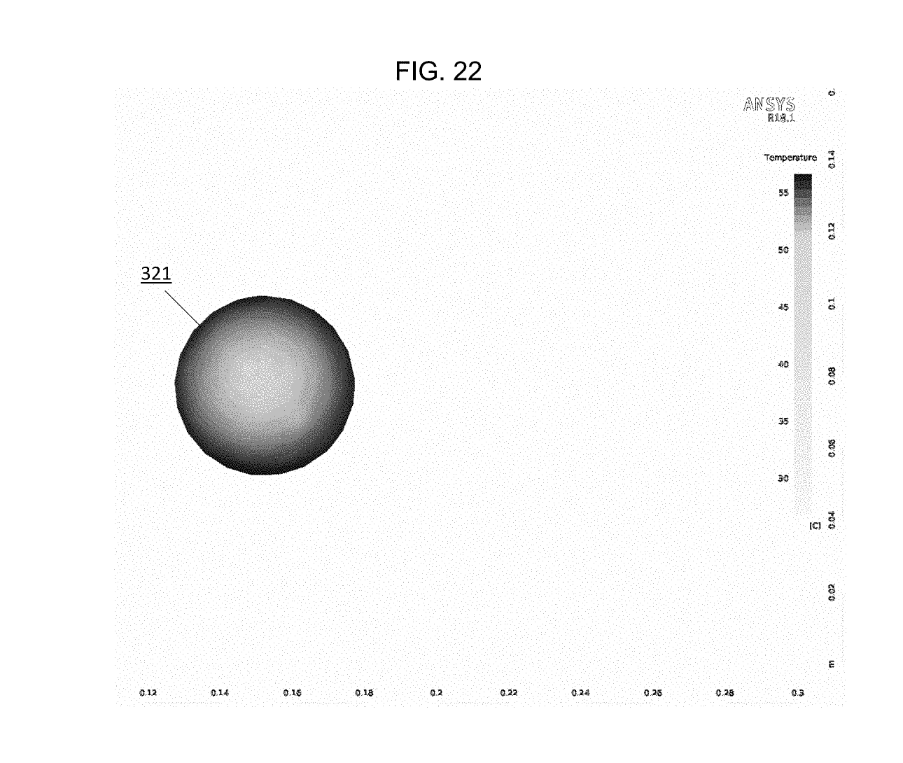

As shown in FIG. 21, a top view heatmap of a spherical central cavity cooled by fractal branched conformal cooling passages 104 of the configuration depicted in FIG. 4, demonstrates that the temperature profile is substantially homogeneous within the interior of the sphere with some minimal temperature escalation at the outer side surfaces of the sphere. In contrast, as shown in FIG. 22, a top view heatmap of a spherical central cavity reference non-fractal branched cooling passages of the configuration depicted in FIG. 13 shows a heterogeneous temperature profile. The heterogeneous temperature profile in the reference is significant between the peripheral regions of the sphere hotter than the interior regions of the sphere.

In some embodiments, the cross section of the cooling passages (also referred to herein as “fractal branched conformal cooling passages” or “conformal cooling passages”) can be selected from circular, rectangular, oval, or a combination thereof. The inventors recognized that turbulence in cooling passages should be modulated because in some embodiments it would result in non-uniform cooling on the cavity wall when the cooling passages are disposed sufficiently close to the cavity wall. Turbulence (as measured by Reynold's number) can be minimized by reducing the passage diameter and increasing the number of passages, but these methods of turbulence minimization ultimately fail at low plastic part creation cycle times if substantially homogeneous temperatures are not maintained throughout each plastic part creation cycle. The inventors recognized that conforming cooling passages provide additional benefits by adhering in part to the contours of the cavity, not only in the fluid flow direction, but perpendicular to the flow such that the cross sectional shape of each passage can change as the passage passes behind the cavity. In some embodiments, the cross sectional shape of each passage can be shaped to yield a substantially homogeneous thermal profile along the cavity surface. These passages described above can also be referred to as “thermally conforming cooling passages” or “conforming passages.”

Conformal cooling systems known in the art rely on one or two cooling passages which intricately wrap along the cavity contour to deliver cooling without regards to the total cross sectional area of the cooling passages.

In some embodiments, the present disclosure provides for an additively-manufactured mold for plastic injection molding, and method of using said mold, comprising fractal branched conforming cooling passages. In some embodiments, the fractal branched conforming cooling passages further comprise a plurality of passages with conforming flow paths. In some embodiments, the fractal branched conformal cooling passages comprise passages with a thermally conforming cross section to achieve the desired cooling efficiency for a prescribed cycle time and coolant properties. In some embodiments, there are one or a plurality of fractal branched cooling passages.

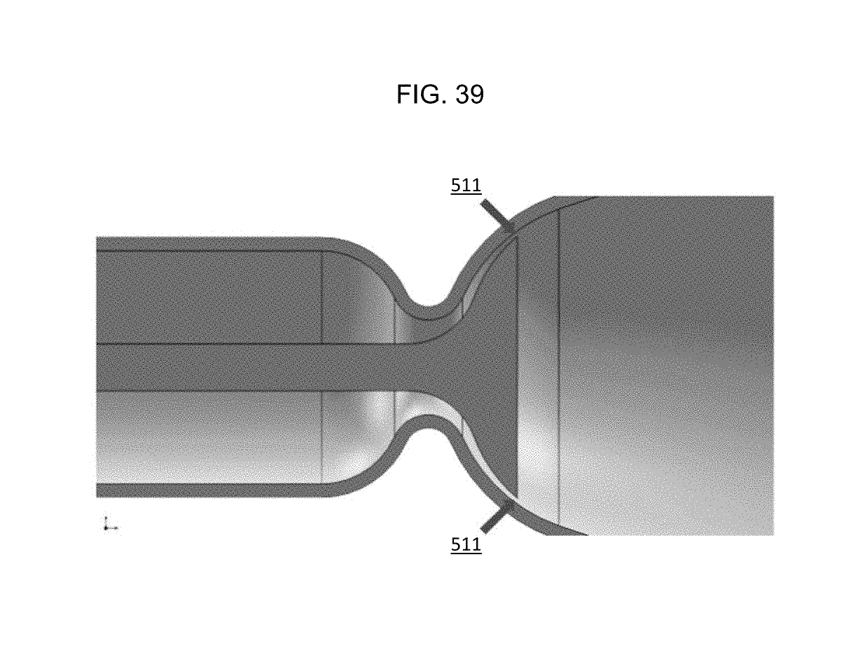

In some embodiments, the diameter of the cross section of the cooling passages is selected from a diameter from 10 microns to 3 centimeters. In some embodiments, the cross section of the cooling passages is selected from a diameter of 25, 30 35, 40, 45, 50, 55, 60, 65, 70, 75, 80, 85, 90, 95, 100, or more microns, or any diameter between any of the aforementioned diameter values. In some embodiments, the diameter of the cross section of the cooling passages is selected from a diameter of 0.1, 0.2, 0.3, 0.4, 0.5, 0.6, 0.7, 0.8, 0.9, 1.0, 2.0, 3.0, 4.0, 5.0, 6.0, 7.0, 8.0, 9.0, 10.0, 11.0, 12.0, 13.0, 14.0, 15.0, 16.0, 17.0, 18.0, 19.0, 20.0, 21.0, 22.0, 23.0, 24.0, 25.0, 26.0, 27.0, 28.0, 29.0, 30.0, 31.0, 32.0, 33.0, 34.0, 35.0, 36.0, 37.0, 38.0, 39.0, 40.0, 41.0, 42.0, 43.0, 44.0, 45.0, 46.0, 47.0, 48.0, 49.0, 50.0, 51.0, 52.0, 53.0, 54.0, 55.0, 56.0, 57.0, 58.0, 59.0, 60.0, 61.0, 62.0, 63.0, 64.0, 65.0, 66.0, 67.0, 68.0, 69.0, 70.0, 71.0, 72.0, 73.0, 74.0, 75.0, 76.0, 77.0, 78.0, 79.0, 80.0, 81.0, 82.0, 83.0, 84.0, 85.0, 86.0, 87.0, 88.0, 89.0, 90.0, 91.0, 92.0, 93.0, 94.0, 95.0, 96.0, 97.0, 98.0, 99.0, 100.0, or more millimeters, or any diameter between any of the aforementioned diameter values. In some embodiments, the diameter of the cross section of the cooling passages is selected from a diameter of 0.1, 0.2, 0.3, 0.4, 0.5, 0.6, 0.7, 0.8, 0.9, 1.0, 2.0, or 3.0 centimeters, or any diameter between any of the aforementioned diameter values. As shown in FIG. 39, the diameter of a round passage made by the processes described herein can be less than 1 mm. In some embodiments, the first fractal branching point comprises a first cross sectional area. In some embodiments, the first generation fractal branched cooling passages comprise a second cross sectional area. In some embodiments, the convergent juncture comprises a third cross sectional area. In some embodiments, the convergent juncture passages comprise a fourth cross sectional area. In some embodiments, the inlet comprises a fifth cross sectional area. In some embodiments, the outlet comprises a sixth cross sectional area. In some embodiments, the first, second, third, fourth, fifth, and sixth cross sectional areas are substantially about the same. In some embodiments, the sum of the first cross sectional areas, the sum of the second cross sectional areas, the sum of the third cross sectional areas, the sum of the fourth cross sectional areas, the sum of the fifth cross sectional areas, and the sum of the sixth cross sectional areas are each substantially about the same.

In some embodiments, the interior surface of the fractal branched cooling passage, the fractal branching point, and/or the feeder passage is textured so as to introduce turbulent flow into the fluid. The textures can be surface roughness or included features on said interior surface of the passages and/or branching point. In some embodiments, the interior diameter of the fractal branched cooling passage, the fractal branching point, and/or the feeder passage is reduced such that the total cross-section surface area is not constant throughout the fluidic passages to introduce turbulent flow into the fluid. Without being bound by theory, turbulence in the passage path reduces the viscous boundary layer and enhances heat transfer into the fluid.

The number, shape, flow path, and changing cross section of the fractal branched cooling passages described herein is dictated by a number of specific factors: ambient temperature, coolant temperature, injected plastic temperature, plastic heat capacity, specific heat, thermal conductivity, solidification temperature at pressures, cure time, thermal stress tolerance, shrink rate, injection speed, injection volume, injection pressure, clamp pressures, and cavity geometry.

In some embodiments, the plurality of passages are fed with a fluid. In some embodiments, the fluid is a complex coolant. Feeding a series of complex coolant passages is not trivial. While each passage may traverse a unique path with an undetermined path length or number of turns and cross section shape changes, a specific mass flow rate must be fed to each passage in order for the system to operate effectively. Improper distribution of coolant can result in detrimental hot/cool spots within the cavity. The inventors have recognized that using fractal branched passages enables delivery of the appropriate coolant mass flow.

Fractal branched cooling passages maintain a relatively low fluid velocity and fluid turbulence while distributing fluid. Without being bound by theory, this ensures that the prescribed mass flow, driven by differential pressure drops, is maintained. Fluid velocity is kept relatively low at the point of branching and is only increased when additional flow velocity or turbulent mixing is required. In some embodiments, fractal branched cooling passages can maintain low fluid velocity stability over a far greater range of initial and boundary conditions when compared to traditional fluid feed systems. In some embodiments, the fractal branched cooling passages passes produce minimal turbulent pressure drop. Turbulence decreases the viscous boundary layer, increasing the average flow velocity of the moderating fluid near the wall. Fractal passages can be optimized for a variety of coolant (or moderating fluid) transmission schemes. They can be used to feed a selected design of cooling passages comprising one or a plurality of curves, linear paths, arcs, junctures, branching points, entrances (inlets), and exits (outlets). In some embodiments, the fluid flow rate of the coolant through the cooling passage can be from 0.001 mL/second to 10 L/second, depending on the pressure applied, the diameter of the passage, backpressure from the passage geometry, and the viscosity of the fluid.

Variations in passage cross section shape, size, and pitch can be used to specifically tune the turbulence and therefore the heat transfer. This can be used to control the heat transfer as well as the temperature and pressure of the moderating fluid. This is particularly important for ensuring that the temperature and pressure of a cryogenic, or supercritical moderating, fluid is such that unwanted phase transformations are avoided, such as gasification or liquidation, as these are potentially damaging to the mold. Increasing and decreasing the cross sectional area of the passage enables the axial optimization of heat transfer into the fluid.

The fractal conformal cooling passages are not in fluidic communication with the central cavity of the additively-manufactured mold. In some embodiments, the fractal branched conformal cooling passages are disposed near to the central cavity in the additively-manufactured mold. In some embodiments, the fractal branched conformal cooling passages are within about 10 to 0.1 cm from the surface of the central cavity. In some embodiments, the fractal branched conformal cooling passages are within 3.0, 2.0, 1.0, 0.9, 0.8, 0.7, 0.6, 0.5, 0.4, 0.3, 0.2, 0.1 cm, or less from the surface of the central cavity. In some embodiments, the fractal branched conformal cooling passages are within 100, 90, 80, 70, 60, 50, 40, 30, or 20 microns from the central cavity. The cooling passages are not in fluidic communication with the central cavity because that would lead to a mixture of the fluid and plastic composition which would destroy the purpose of the mold. In some embodiments, the cooling passages are contoured to the pattern of the central cavity. In some embodiments, the proximity of the fractal branched conformal cooling passages to the central cavity can provide an additional means for carrying out an additional cooling or heating step on the formed plastic part that can take place any time during the molding process. In some embodiments, an additional cooling step can be implemented concurrently while injecting an additional quantity of gas (as in gas assist injection molding) into the formed plastic part within the central cavity. In some embodiments, an additional heating step can be implemented prior to injecting the molded material into the mold cavity. The additional heating and cooling steps can ensure manufacturing a plastic formed part with reduced or eliminated defects as described herein. In some embodiments, the temperature of the additively-manufactured mold comprising fractal branched cooling passages can be modulated before, during, and after the formation of the formed plastic part to increase material flow lengths and/or to mold thinner sections of the formed plastic part.

In some embodiments, the additively-manufactured molds comprising fractal branched cooling passages can comprise a heterogeneous build metal composition when constructing the additively-manufactured mold. When the mold comprises a heterogeneous metal composition, the localized thermal heat capacity of certain regions of the mold can be tailored using different localized build metal compositions. The localized thermal heat capacities afford matching the passage geometry to the localized thermal heat capacity to further fine-tune the thermal heat transfer throughout the additively-manufactured mold. This is not possible with die-cast manufactured molds, which can only be made from a homogeneous metal composition. The heterogeneous build metal composition of the additively-manufactured mold can be selected to minimize thermal expansion of the mold. In some embodiments, the heterogeneity of the build metal composition of the additively-manufactured mold can be a gradient between two or more build metal compositions. The build metal composition can be tailored to match localized thermal expansion rates to prevent fracture during repeated heating and cooling cycles.

In some embodiments, the additively-manufactured molds described herein comprise a first or a plurality of generation of one or a plurality of feeder passages, one or a plurality of generation of fractal branching points (also referred to herein as a “fluid diverter”), one or a plurality of fractal branched passages, a first or a plurality of generation of one or a plurality of convergent junctures (also referred to herein as a “fluid converger”), one or a plurality of convergent passages, and one or a plurality of exits (also referred to herein as “outlets”) and or entrances (also referred to herein as “inlets”). In some embodiments, the angle of a fractal branching point between two fractal branched passages (see FIG. 1, 199) is less than 180 degrees. In some embodiments, the angle of the fractal branching point is less than 90 degrees. In some embodiments, angle of the fractal branching point is less than or equal to 60 degrees. In some embodiments, the distance between any generation of fractal branching point and a subsequent generation fractal branching point is between 50 microns to 100 cm. In some embodiments, the length of a fractal branched passage is between 50 microns and 1 meter. In some embodiments, the distance between any generation of convergent juncture and a subsequent generation convergent juncture is between 50 microns to 100 cm.

### Mold Inserts

In some embodiments, the additively-manufactured molds described herein can be used as mold inserts. In some embodiments, the additively-manufactured mold inserts can be used in the same assembly as the additively-manufactured molds. In some embodiments, the mold inserts can include or exclude fractal branched cooling passages, fractal branching points, feeder passages, convergent junctures, convergent juncture passages, inlets, and outlets. Mold inserts are structures comprising one or more cavities embedded within a larger mold plate. In some embodiments, mold inserts are embedded into the central cavity within two or a plurality of mold segments. The mold inserts can be used in conjunction with conventional injection molding systems to present an interior surface to the plastic part which is advantaged by the methods described herein for forming a plastic part using fractal branched cooling passages. In larger molds, mold inserts are used to selectively cool particular regions of the central cavity due to the smaller size of said mold inserts.

### Multi-Cavity Cooling

Multi-cavity molds, including those comprised of multiple mold cavity inserts, require special treatment in order to reap similar substantially homogeneous temperature modulation benefits. Multi-cavity molds may be plumbed for discrete or continuous cooling. Discretely cooled cavities have dedicated cooling plumbing to deliver coolant to each insert independently. In some embodiments, each cooled insert is independent and utilizes identical cooling geometries. Continuous multi-cavity molds, where a single coolant inlet feeds the entirety of the molds insert cavities, requires the increase in coolant temperature, resulting from the removal of heat from upstream mold cavities, to be taken into account when determining the coolant inlet conditions for downstream cavities. In some embodiments, fluid velocity may need to be increased in conjunction with increased turbulent mixing, caused by passage nozzling or internal features, in order to achieve the desired amount of cooling for all cavities regardless of locations (upstream or downstream of the heat exchanging site).

### Hot Running

When first injecting the plastic into a mold, the mold generally sits at room temperature. The first contact between the hot plastic and the comparatively cool mold can cause thermal stress issues due to the rapid initial cooling of while the mold reaches thermal equilibrium with the plastic. After thermal equilibrium is reached, the rest of plastic is allowed to evenly cool at the same rate as the metal. The first layer of rapidly cooled plastic can cause cracking and other structural issues with the plastic parts due to the differing cooling conditions.

Preheating the molds using the fluid cooling passages to evenly heat the mold can be used to mitigate issues arising from the period of time before thermal equilibrium is reached. With the mold already at a temperature close to that of the melting temperature of the plastic material, thermal equilibrium is easier to reach and has far fewer negative effects on the plastic material.

After injection of the plastic material, the heated fluid in the cooling passages can be rapidly replaced with a second fluid at a different temperature than the heated fluid to quickly and efficiently decrease the temperature of the additively-manufactured mold. The plurality of conformal cooling passages maintains constant heat transfer rates to ensure even temperatures and minimal thermal stresses within the plastic part.

In some embodiments, this disclosure includes a method for manufacturing a plastic part, the method comprising the use of an additively-manufactured mold having fractal conformal cooling passages, wherein the additively-manufactured mold comprises a central cavity comprising a surface having a profile defined by the formed plastic part. A pattern of fractal branched cooling passages is disposed beneath the surface defined by the profile in the additively-manufactured mold. The additively-manufactured mold can be aligned with a second additively-manufactured mold to form a substantially complete enclosure about which the formed plastic part is to be made. The surfaces each of the additively-manufactured molds are joined together to form the mold component.

In some embodiments, this disclosure includes a mold component comprising additively-manufactured molds comprising fractal branched cooling passages which comprises a first mold segment and a second mold segment disposed in operable communication with each other, wherein each mold segment further comprises a first surface having a profile. In some embodiments, a network of fractal branched cooling passages can be disposed between the first mold segment and second mold segment.

In some embodiments, this disclosure includes a method for forming a plastic part which comprises introducing a molten plastic material into a central cavity within the one or more additively-manufactured molds comprising fractal branched cooling passages that conform to a profile. A fluid is passed through the network of fractal branched cooling passages. The plastic material is cooled to below a softening point temperature of the plastic material to form the plastic part. The plastic part is then removed from the mold.

The additively-manufactured mold comprising fractal branched cooling passages can be used in injection molding to create a part comprising a plastic (“plastic formed part” or “formed plastic part”). In some embodiments, the injection molding process is hot isostatic pressing process (“HIP process”). The HIP process comprises placing the additively-manufactured mold made by the processes described herein into a pressure vessel containing an inert atmosphere which is non-reactive with the composition of the additively-manufactured mold. In some embodiments, the pressure vessel is operated at a sufficient pressure to press and blend the plastic material into the additively-manufactured mold and remove or eliminate any air gaps. The pressure can be up to about 20,000 pounds per square inch (“psi” in imperial units) (1406 kg/cm2), with about 10,000 psi (703 kg/cm2) to about 20,000 psi (1406 kg/cm2). In some embodiments, the pressure is up to about 14,000 psi (984 kg/cm2) to about 16,000 psi (1125 kg/cm2). In one embodiment, the additively-manufactured mold is placed in the pressure vessel, while the pressure within the pressure vessel is held constant and the temperature is increased from about 350° C. to about 800° C., and preferably from about 425° C. to about 600° C., for a time period of about 4 hours to about 24 hours. The constant pressure and increased temperature isostatically press the plastic materials into the additively-manufactured mold to eliminate air gaps, and to prevent possible leakage. The HIP process can enhance the densification of the plastic material to create a part having a homogeneous composition.

In some embodiments, two or more additively-manufactured mold segments each of which comprise a separate set of fractal branched cooling passages are combined to present two or more separate surfaces to the formed plastic part. In some embodiments, the formed plastic part preferably possesses a uniform thickness. In some embodiments, the uniform thickness of the formed plastic part is from about 0.1 mm to about 50 cm. In some embodiments, the uniform thickness of the formed plastic part is from about 0.5 mm to about 10 cm.

The thickness of the additively-manufactured heat exchanger comprising fractal branched cooling passages combined with the thermal conductivity value of the metal or alloy comprising the additively-manufactured mold segment improves the cooling capabilities of the heat exchanger. In some embodiments, the thermal conductivity values of regions or all of the additively-manufactured heat exchanger are from about 5 Watts per meter-Kelvin (SI units) to about 300 W/m-K or any thermal conductivity value between the aforementioned values. Without being bound by theory, additively-manufactured heat exchangers comprising fractal branched cooling passages made by the processes described herein when used as a mold to construct a formed part maintain a substantially homogeneous temperature throughout the entire additively-manufactured mold. In some embodiments, the temperature throughout the additively-manufactured mold comprising fractal branched cooling passages contains a temperature difference (delta T) of less than or equal to 10° C. to 100° C. or any temperature difference between any of the aforementioned values, across the entire plastic part being formed. In some embodiments, the temperature of the additively-manufactured mold used in the processes described herein can be modulated from 15° C. to 190° C. In some embodiments, the temperature of the additively-manufactured mold can be modulated from 20° C. to 160° C. In some embodiments, the temperature of the additively-manufactured mold can be modulated from 20° C. to 140° C.

The resulting plastic part produced using the additively-manufactured mold comprising fractal branched cooling passages can be manufactured faster (in a shortened cycle time), than plastic parts using non-additively-manufactured molds. In some embodiments, the method for shortening the cycle time for molding an article comprises injecting an amount of plastic material sufficient for the preparation of a additively-manufactured part into a central cavity that comprises the features of the plastic part to be formed, in which the additively-manufactured mold central cavity comprises a profile having one or more features of the plastic part to be formed and a network of fractal branched cooling passages substantially conforming to the profile of the features of the plastic part to be formed. A plastic part is then created within additively-manufactured mold comprising fractal branched cooling passages. In some embodiments, a complex fluid can then be injected under pressure through the network of fractal branched cooling passages in the additively-manufactured mold comprising said fractal branched cooling passages components, such that the operating temperature of the additively-manufactured mold is lowered to a temperature beneath the softening point of the plastic material of which the part being formed comprises. In some embodiments, plastic material can be injected under pressure into the additively-manufactured mold central cavity at a temperature of about 160° C. to about 370° C. After injecting the complex fluid into the network of fractal branched cooling passages, the operating temperature of the additively-manufactured mold can be lowered. In some embodiments, the temperature of the additively-manufactured mold at the surface contacting the plastic part being formed can be decreased by about 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1° C. to cool the plastic material in the central cavity in the additively-manufactured mold comprising fractal branched cooling passages. After the plastic part has formed, the additively-manufactured mold comprising fractal branched cooling passages is then separated from the formed plastic part, such that the formed plastic part is opened to the atmosphere and removed from the additively-manufactured mold.

In some embodiments, after removing the formed plastic part and prior to injecting a second quantity of plastic material to form another plastic part by injecting a second complex fluid into the network of fractal branched cooling passages in the additively-manufactured mold, the operating temperature of the additively-manufactured mold can be increased. In some embodiments, the operating temperature of the additively-manufactured mold can be increased to between 160° C. to about 370° C. By injecting the plastic material into a pre-heated mold, the plastic material viscosity decreases, resulting in filling in the contours of the features of the central cavity of the additively-manufactured mold more rapidly and homogeneously. In some embodiments, decreasing the viscosity of the plastic material by injecting the plastic material into a pre-heated additively-manufactured mold enables the formation of thinner sections in the formed plastic part, at lower injection pressures and at faster injection rates. This reduces the amount of plastic material which is molded in stress and also shortens the overall plastic part production cycle. In some embodiments, the additively-manufactured mold comprising fractal branched cooling passages is then rapidly cooled as described above to solidify the formed plastic part which is then removed from the additively-manufactured mold.

The term “plastic material”, as used herein, refers to any plastic material that exhibits plastic flow properties under injection molding temperature and pressure conditions. “Plastic material” can include or exclude all organic and inorganic materials having, with or without additives, thermoplastic characteristics, including certain synthetic organic resins. “Plastic material” can include or exclude polyolefin materials (e.g., substituted or unsubstituted polypropylenes, substituted or unsubstituted polyethylene, substituted or unsubstituted polyacrylates, substituted or unsubstituted polystyrenes, substituted or unsubstituted polybutadienes, substituted or unsubstituted polymethylmethacrylates, and copolymers and mixtures thereof), substituted or unsubstituted polytherepthalates, polyurethane, polyether sulfone, polyacetal, polytetrafluoroethylene, and phenolic resins. In some embodiments, the phenolic resins are thermosetting resins, when reacted at a temperature and for a time sufficient to produce the cross-linking necessary causes them to be considered as substantially thermoset. In some embodiments, the “plastic material” can include or exclude thermoplastic and thermoset materials, or combinations thereof. In some embodiments, the “plastic material” can include or exclude acrylonitrile butadiene styrene (ABS), polycarbonate, polyamide (nylon, e.g. Nylon 6,6; Nylon 6,12; Nylon 4,6; Nylon 6; Nylon 12), or high-impact polystyrene (HPS). In some embodiments, the polyethylenes can be selected from high-density polyethylene (HDPE) or low-density polyethylene (LDPE).

The methods for manufacturing additively-manufactured molds comprising fractal branched cooling passages provides for advantages which can include or exclude manufacturing cost savings, use of homogeneous materials, higher part-to-part consistency, reduced rippling on the surfaces of the plastic parts thus formed, over injection molding methods using non-additively-manufactured molds. In some embodiments, the methods described herein can reduce or eliminate blistering in the formed plastic part, which would occur if the mold or plastic material is too hot, which is caused by a lack of cooling around the central cavity or a faulty heater used in heating the mold comprising the plastic material. In some embodiments, the methods described herein can reduce or eliminate flow marks, which occurs when the plastic material injection speed is too slow (the plastic has cooled down too much during injection). In some embodiments, the methods described herein can reduce or eliminate sink marks, which occurs when the holding time/pressure is too low, or the cooling time is too short. In some embodiments, the methods described herein can reduce or eliminate weld lines, which occurs when the mold or plastic material temperatures are set too low. In some embodiments, the methods described herein can reduce or eliminate warping in the formed plastic part, which occurs when the localized cooling time is too short, the plastic material is too hot, or there is a lack of sufficient cooling around the region of the mold near the warped formed plastic part region.

In some embodiments, the additively-manufactured molds comprising fractal branched cooling passages using the methods described herein have higher heat dissipation values than molds without fractal branched cooling passages, which results in improved localized cooling capabilities. The additively-manufactured mold comprising fractal branched cooling passages exhibits an inherent ability to cool a formed plastic part faster than molds without fractal branched cooling passages.

### Nonstandard Coolants

The inventors have recognized that fluids other than water can be used as the coolant for the molds. While the use of water is readily accessible and easy to work with as a coolant, it has a low heat transfer capability and change of thermal conductivity over a range of temperatures. Other fluids specially designed for efficient cooling and/or heating can be implemented with the fractal-based conformal cooling passages (“fractal branched cooling passages”) described herein to further increase the overall efficiency of the fractal branched conformal cooling system. In some embodiments, the heat transfer fluid is a cryogenic coolant (also referred to herein as a “cryogenic fluid”). The cryogenic coolant can decrease cooling time while ensure part viability. In some embodiments, cyrogenic coolants can include or exclude: liquidified gases (e.g., helium, hydrogen, neon, nitrogen, ethane, krypton, argon, carbon monoxide, methane, oxygen, and mixtures thereof), cooled alcohols (e.g., ethanol, isopropanol, butanol, sec-butanol), cooled polar aprotic low freezing point liquids (e.g., acetone, N,N-dimethylformamide, dimethylsulfoxide), hydrogen sulfide, ethylene glycol, tetraethylene glycol, freons, high salt aqueous solutions, a complex fluids, and mixtures thereof. In some embodiments, cryogenic coolants can include or exclude nanofluids.

As used herein, the term “fluid” refers to gaseous and liquid pressurizing fluids. In some embodiments, the term “fluid” can refer to more than one type of fluid. In some embodiments, two or more fluids can be used throughout the processes described herein. In some embodiments, a second fluid can be the first fluid having a different temperature (i.e., a lower temperature) than when employed as the first fluid. In some embodiments, the second fluid comprises a fluid mixture comprising water and glycol, introduced into the fractal branched cooling passages to cool or warm the mold.

As used herein, the term “complex fluid” refers to binary mixtures that have a coexistence between two phases: solid-liquid (suspensions or solutions of macromolecules such as polymers), solid-gas (granular), liquid-gas (foams) or liquid-liquid (emulsions).

As used herein, the term “nanofluid” refers to a fluid comprising nanoparticles (e.g., particles having an average diameter as measured by laser light scattering of less than 999 microns). Nanofluids can be formed by suspending metallic or non-metallic oxide nanoparticles in fluids. Nanofluids comprise ultrafine nanoparticles (1-100 nm). The nanoparticles can include or exclude Cu, Fe, Au, Ag, Cd, Se, and non-metallic particles or compounds which can include or exclude MoS₂ (molybdenum disulfide), Al₂O₃(Alumina), CuO, SiC, TiO₂, Fe₃O₄ (Iron Oxide), ZrO₂ (Zirconia), WO₃ (Tungsten trioxide), ZnO, SiO₂, and multi-walled carbon nanotubes. Nanofluids can further comprise water, hydrophobic oil, ethylene glycol, or combinations thereof. The liquids can be cooled by compression, dilution, expansion, and thermal contact with a cooling source.

The inventors discovered that the use of the efficient coolants described herein are problematic with standard cooling geometries because they would result in uneven heat transfer. The use of the efficient coolants with conformal cooling geometries, however, allows for precise design for specific coolants and geometries. In some embodiments, the coolant is water. In some embodiments, the coolant is a heat transfer (e.g., coolant) fluid described herein.

### Embedded Resistive Coils

In some embodiments, the additively-manufactured molds described herein further comprise a resistive heating coil. In some embodiments, the heating coil is embedded in the mold. In some embodiments, the heating coil is brazed onto the external surface of the mold. The heating coil can include or exclude metal coils, polymer coils, ceramic coils. In some embodiments, the metal coils can include or exclude Kanthal (FeCrAl), Nichrome (NiCr), and Cupronickel (CuNi). In some embodiments, the ceramic coils can include or exclude Molybdenum disilicide (MoSi₂), barium titanate, and lead titanate. In some embodiments, the heating coil can include or exclude platinum, tungsten molybdenum disilicide, molybdenum (vacuum furnaces) and silicon carbide. The heating coil can preheat the mold prior to rapidly cooling the mold using fluids through the conformal branched passages. This can be done by presenting a heated fluid through the fractal branched passages prior to, and in some embodiments, during injection, before flowing a cooled fluid to wick the heat from the cavity. In some embodiments, the heating coil would maintain the temperature of the plastic material during the heating of the mold, and in some embodiments, after removal of the mold from the external heating environment.

### Additive Manufacturing Process Test Apparatus

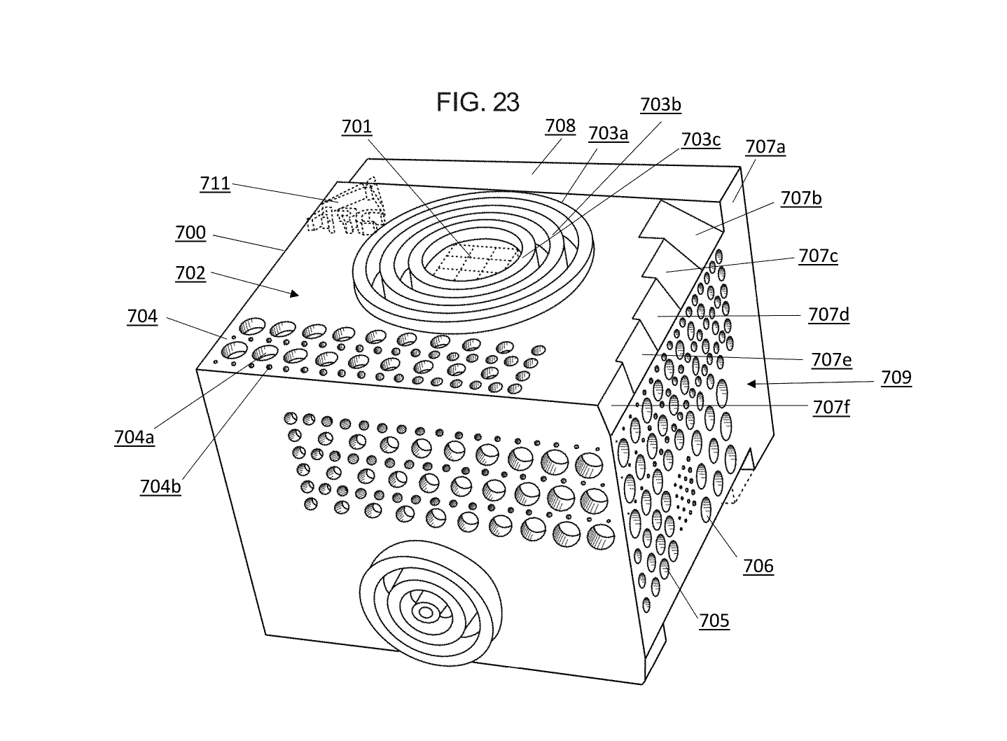

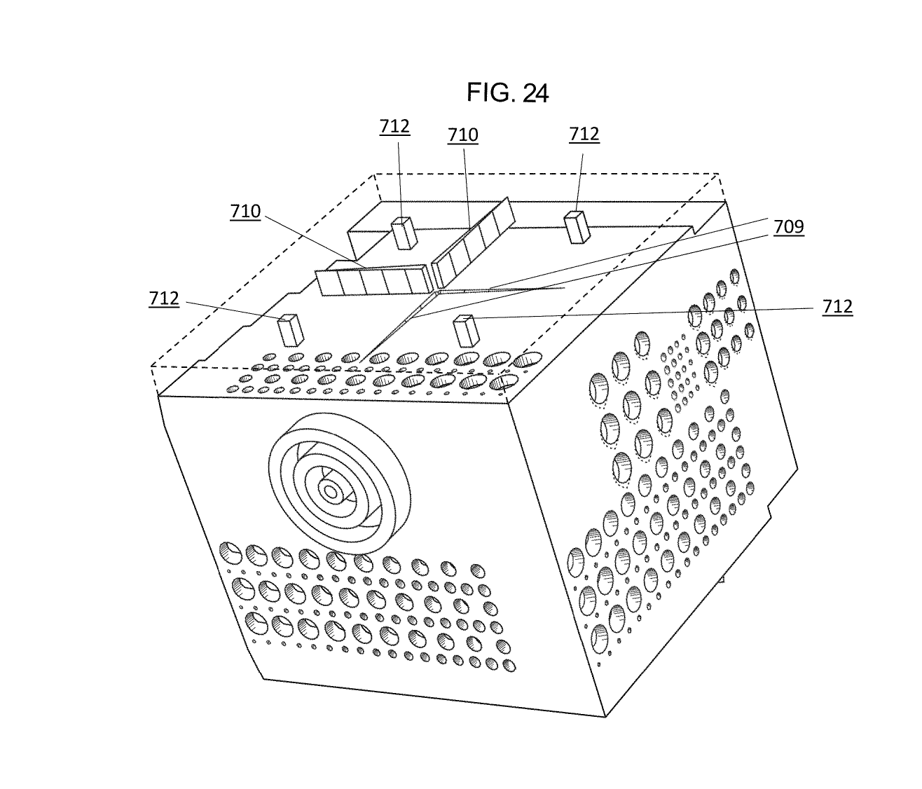

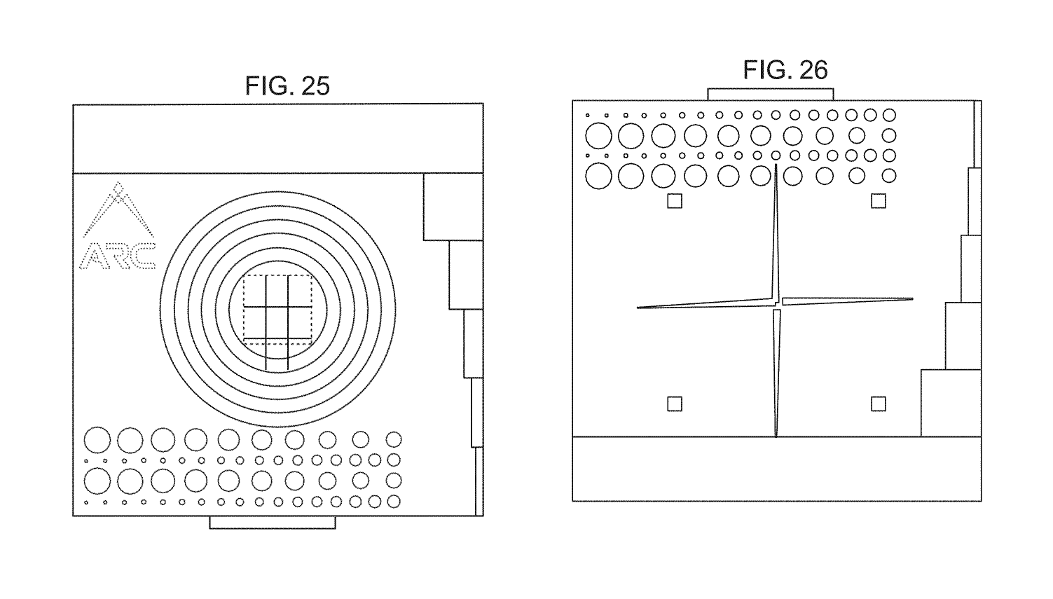

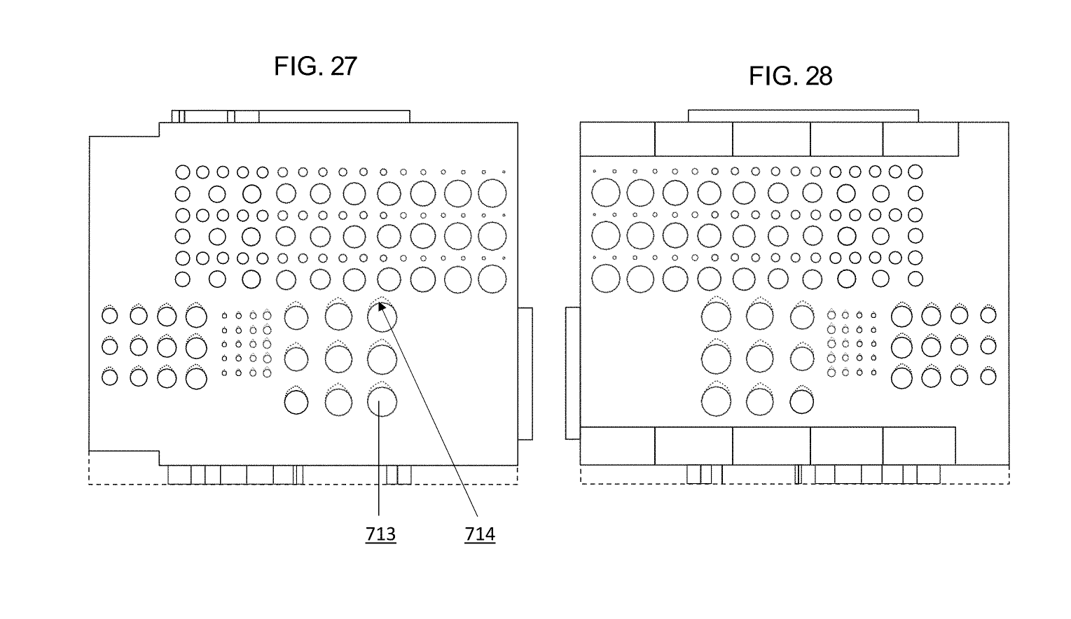

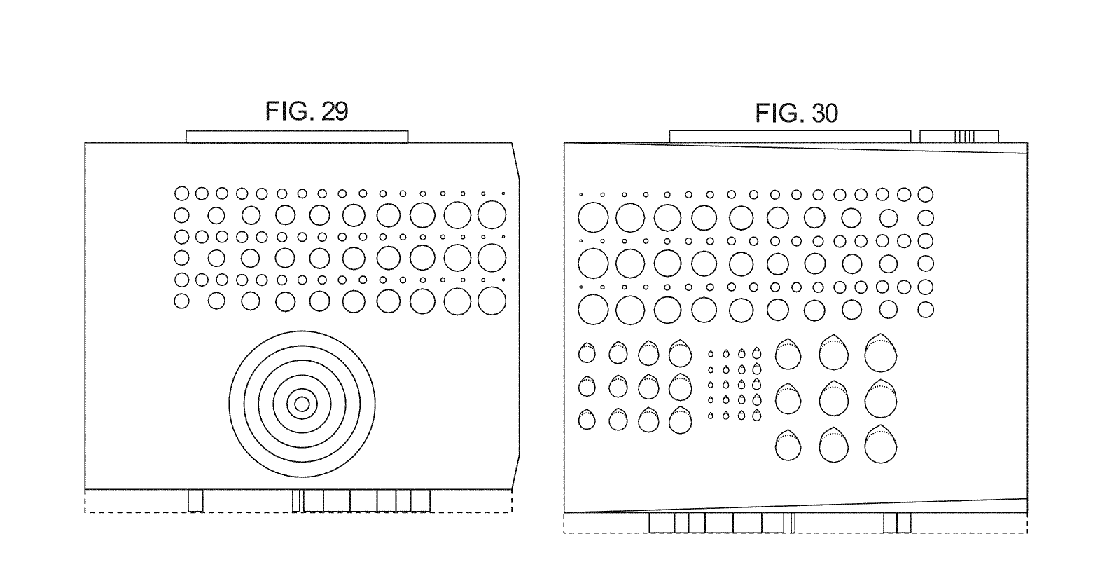

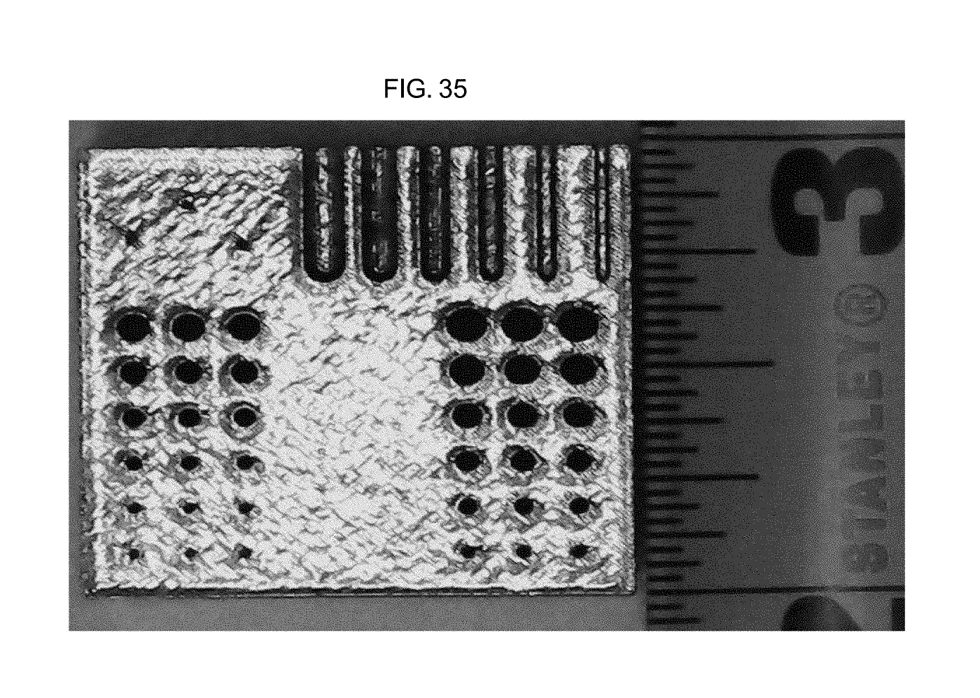

As shown in FIG. 23-37, this disclosure relates to a multi-sided testing apparatus 700 which includes the features of a barcode pattern 701 that is positioned on at least one of the plurality of side surfaces 702; a plurality of rings 703 positioned adjacent to the barcode pattern, wherein each of the plurality of rings are coupled to each other such that each ring of the plurality of rings 703a, 703b, and 703c is concentrically aligned with at least one other ring of the plurality of rings, each of the plurality of rings 703a, 703b, and 703c have the same first predefined diameter; at least one first set of a plurality of openings 704 positioned on the same side surfaces that the barcode pattern and the plurality of rings are positioned on, wherein each of the at least one first set of the plurality of openings 704b have a second predefined diameter that is different than the first predefined diameter, the at least one first set of the plurality of openings have a predefined first shape 704a; at least one second set of a plurality of openings positioned on at least one of the plurality of side surfaces that is different than the at least one surface that the barcode pattern and the plurality of rings are positioned on (705), wherein each of the at least one second set of the plurality of openings 705 have a second predefined diameter that is different than the first predefined diameter, the at least one second set of the plurality of openings 705 have a predefined second shape; and at least one third set of a plurality of openings positioned adjacent to the at least second set of the plurality openings, wherein the at least one third set of the plurality of openings 706 have a predefined third shape that is different than the predefined second shape. In some embodiments, the testing apparatus further comprises at least one series of tapered edge ramps 707 at one or more angles tapering inward to the center of the at least one of the plurality of side surfaces 702 to partially bisect two of the side surfaces 708 and 709. In some embodiments, the at least one series of tapered edge ramps 707 comprises six ramps 707a, 707b, 707c, 707d, 707e, and 707f. In some aspects, the angles of the at least one series of tapered edge ramps are selected from: 1, 15, 30, 45, 60, and 75 degrees. In some embodiments, the testing apparatus further comprises a planar tapered edge ramp configured at the lateral outer edge of and spanning across the length of the testing apparatus 708. The angle of the planar tapered edge ramp can be 1.0 (+/−0.1) degrees.

In some embodiments, the testing apparatus further comprises one or a plurality of stepped troughs 709 penetrating into one or more side surfaces opening up from a single point to an open area. In some embodiments, the testing apparatus comprises one or more stepped ridge 710 configured on one or more of the side surfaces, where the walls of the trapezoid are step-tapered.

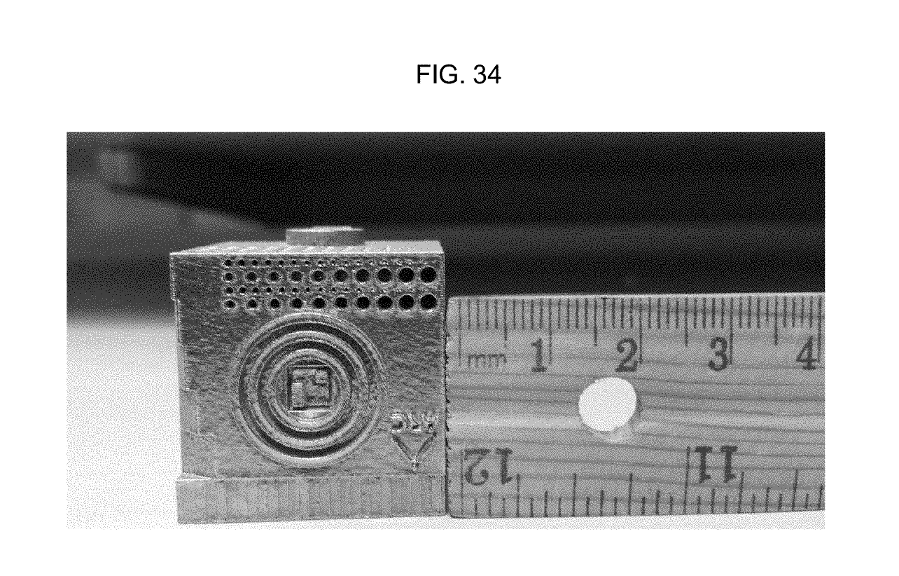

In some embodiments, the additively-manufactured articles including a testing apparatus is a polyhedron. In some embodiments, the additively-manufactured articles including a testing apparatus comprises 4, 5, or 6 sides. In some aspects, the 4-sided testing apparatus is a triangular pyramid. In some embodiments, the 5-sided testing apparatus is a rectangular pyramid. In some embodiments, the 6-sided testing apparatus is a rectangular cuboid. In some embodiments, the rectangular cuboid is a cube (also known as a hexahedron). In some embodiments, the testing apparatus consists essentially of six side surfaces and twelve edges. The twelve edges of the testing apparatus can be of the same length. In some embodiments, the length of the twelve edges can vary by 1%, 2%, 3%, 4%, 5%, 6%, 7%, 8%, 9%, or 10% from edge to edge. In some embodiments, the length of each edge is less than 5, 4, 3, 2, or 1 centimeters. In some embodiments, the length of each edge is less than 3.5 centimeters as shown in FIG. 34.

In some embodiments, orientation text 711 may be positioned on at least one of the testing apparatus side surfaces. In some embodiments, the testing apparatus comprises standoffs 712 on at least one side surface. In some embodiments, the testing apparatus comprises one or a plurality of angled openings 713 which bisect at least two sides of the testing apparatus. In some embodiments, the angles 714 of the angled openings can be from 1 degree to 90 degrees. In some embodiments, the angle of the angled openings is selected from: 1 degree, 30 degrees, 45 degrees, or 60 degrees. The angles of each of the angled openings can be the same or different. In some embodiments, the testing apparatus comprises one or a plurality of troughs positioned on at least one side surface. The troughs can be straight or curved. The troughs can be square-bottomed or curved-bottomed. In some embodiments, the testing apparatus comprises one or a plurality of ridges positioned on at least one side surface. The ridges can be straight or curved. The ridges can be rounded or squared on top. In some embodiments, the testing apparatus comprises one or a plurality of dimples positioned on at least one side surface. The shape of the dimples can be hemispherical. In some embodiments, the testing apparatus comprises one or a plurality of bumps positioned on at least one side surface. In some embodiments, the testing apparatus comprises one or a plurality of beveled edges along at least one edge. In some embodiments, the testing apparatus comprises one or a plurality of angled ramps on at least one side, bisecting two sides of the testing apparatus along at least one edge.

In some embodiments, the testing apparatus surface is smooth. In some embodiments, the testing apparatus surface is rough. In some embodiments, the testing apparatus surface is porous.

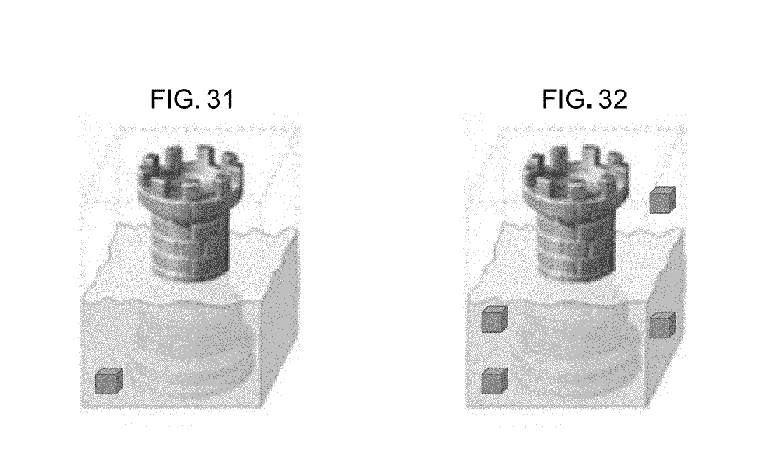

In some embodiments, the testing apparatus consists essentially of six side surfaces. In some embodiments, the testing apparatus consists essentially of twelve edges. In some embodiments, the testing apparatus is cubic shape. In some embodiments, each side surface of the testing apparatus has substantially about the same surface area. In some embodiments, the length of each testing apparatus edge is substantially about the same. In some embodiments, the testing apparatus is a cube where the length of the edges is less than 3.5 centimeters. In some embodiments, the testing apparatus consists of 12 edges where the length of the edge is selected from: 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, or 3.5 cm. The small testing apparatus size allows for the testing apparatus to be manufactured in parallel with the manufacture of another object to be used as quality control mechanism of the additive manufacturing process. In some embodiments, multiple testing apparatii can be created at selected positions in the manufacture bed during the manufacturing of another object as shown in FIG. 31.

### Methods of Manufacturing Expansion Deflection Throttling Nozzles

In some embodiments, the additively-manufactured constructs described herein can be manufactured by casting from molds, additive-layered manufacturing, subtractive manufacturing, or combinations thereof. In some embodiments, the subtractive manufacturing can be machining. In some embodiments, the machining can be CNC (Computer Numerical Control) machining. In some embodiments, the machining can include or exclude the steps of turning, milling, drilling, reaming, and boring. In some embodiments, the method of manufacture can include or exclude abrasive flow machining, polishing, and surface-coating.

### Additive-Layered Manufacturing Systems

The methods of this disclosure can be operated on any additive-layered manufacturing system capable of manipulating metallic, semi-metallic, or alloyed materials. In some embodiments, the additive-layered manufacturing (ALM) systems are selected from one or more of those listed in Table 1.

TABLE 1
Exemplary additive-layered manufacturing systems, processes,
possible build-volumes, and energy sources.

| ALM System | Acronym | Heat Source |
|---|---|---|
| GE Additive ARCAM | EBM | 7 kW electron beam |
| series | | |
| EOS (M280) | DMLS | 200-400 W Yb-fiber laser |
| Concept laser cusing | SLM | 200 W fiber laser |
| (M3) | | |
| MTT (SLM 250) | SLM | 100-400 W Yb-fiber laser |
| Phenix system group | SLM | 500 W fiber laser |
| (PXL) | | |
| Renishaw (AM 250) | SLM | 200 or 400 W laser |
| Realizer (SLM 250) | SLM | 100, 200, or 400 W laser |
| Matsuura (Lumex | SLM | 400 W Yb fiber laser; hybrid |
| Advanced 25) | | additive/subtractive system |
| Powder feed | | |
| Optomec (LENS 850- | LENS | 1 or 2 kW IPG fiber laser |
| R) | | |
| POM DMD (66R) | DMD | 1-5 kW fiber diode or disk laser |
| Accufusion laser | LC | Nd:YAG laser |
| consolidation | | |
| Irepa laser (LF 6000) | LD | Laser cladding |
| Trumpf | LD | |
| Huffman (HC-205) | LD | CO₂ laser clading |
| Wire feed | | |
| Sciaky (NG1) EBFFF | EBDM | >40 kW @ 60 kV welder |
| GE Additive Arcam | EBM | |
| EBM | | |
| MER plasma | PTAS | Plasma transferred arc using |
| transferred arc | FFF | two 350 A DC power supplies |
| selected FFF | | |
| Honeywell ion fusion | IFF | Plasma arc-based welding |
| formation | | |
| ExOne Exerial | HJP | n/a during build |
| ExOne S-Max | HJP | n/a during build |
| HP MetalJet | HJP | n/a during build |
| GE Additive Mlab, | DMLM | Includes 1.5 kW lasers |
| M1, M2, and | | |
| A.T.L.A.S. | | |

In some embodiments, additive manufacturing includes several different unique processes. Types of additive manufacturing processes include: laser engineered net shaping (LENS), directed light fabrication (DLF), electron beam melting (EBM), direct metal deposition (DMD), direct metal laser melting (DMLM), laser deposition (LD), and hot-jet binder printing (HJP). Laser deposition in combination with rotational deposition allows for the production of metal compositional gradients radially from the center of a part by a process known as radial additive manufacturing (RAM) with functionally graded materials. Hot-jet binder printing (also referred to as “inkjet powder printing” is an additive manufacturing process in which a liquid binding agent is selectively deposited to join powder particles. Layers of powder particles are then bonded to form an object. The printhead strategically drops binder into the powder. The job box lowers and another layer of powder is then spread and binder is added. Over time, the part develops through the layering of powder and binder. The binder can comprise a latex which is melted when deposited, then solidifies upon cooling. Hot-jet binder printing can print a variety of materials including metals, sands and ceramics. Some materials, like sand, require no additional processing. In some embodiments, the sand is “green sand” and the constructed article can be used for metal casting. Green sand can comprise silica sand (SiO₂), chromite sand (FeCr₂O₄), zircon sand (ZrSiO₄), olivine, staurolite, graphite, bentonite (clay), water, inert sludge, and/or anthracite. In some embodiments, the hot-jet binder materials are cured and sintered and sometimes infiltrated with another material, depending on the application. In some embodiments, hot isostatic pressing may be used to achieve high densities in solid metals. In hot-jet binder printing, the binder material component functions like as an ink as it moves across the layers of powder, to form the final product.

In some embodiments, the RAM process begins with a computer generated model (CAD) as an input into a program that transforms the part's geometry into a programmable set of pathways that define the movement of the components within an additive manufacturing machine. The two main components of the additive manufacturing machine are a base and the nozzle. The part is constructed onto the base, and the nozzle is the component that utilizes the laser and material feed systems. Both the base and nozzle may be dictated by multiple-axis controls which allow for angular deposition, thereby removed the need for support material. The machine prints by feeding a continuous supply of metal or ceramic powder into the focal zone of a laser which melts the powder. The melted powder forms a melt pool and is deposited along the surface of the part as the laser moves along a predefined path. The melt pool quickly solidifies upon cooling so that the next layer may be added. Successive layers are printed until an entire part is produced. In some embodiments, more than one metal or ceramic powder are added into the material feed system during the printing process through the same, or different nozzles. In some embodiments, the process is performed under an inert gas to prevent chemical oxidation of the powder material.

The ability of the additive manufacturing processes described herein to grow complex geometry near net shape constructs without tooling enables processes such as casting, forming, forging, rolling, extruding, pressing, stretch forming, milling, turning, drilling, sawing, broaching, shaping, planning, and joining (welding, brazing, bolted joints) or diffusion bonding to be replaced or reduced. In some embodiments, constructs are created using the integrated machining and additive processes simultaneously or serially.

In some embodiments, laser deposition comprises precisely manipulating a laser beam to vaporize unwanted, deposited material in a process termed “laser beam machining”. Laser beam machining can include or exclude cutting, welding, drilling, heat-treating, scoring and scribing materials at a very high speed and in a very precise specification. Multiple, simultaneous secondary operations can be performed in the same additive manufacturing environment without contaminating or compromising the additively-manufactured material deposition while in-progress. Laser beam machining can provide heat treatment prior to the deposition area and immediately after, during additive manufacturing, using a plurality of beam pulses and durations. In some embodiments, laser beam machining enables control of the thermodynamic profile of the pre and post deposition metal. In some embodiments, laser beam machining during additive manufacturing enables the control of the construct's microstructure and residual thermal stresses. Laser heat-treatment is a surface alteration process that changes the microstructure of metals by controlled heating and cooling. The laser can heat treat small sections or strips of material without affecting the metallurgical properties of the surrounding area because of its ability to pinpoint focus both the amount and the location of its energy. The advantages of laser heat-treating include precision control of heat input to localized areas, minimum distortion, minimum stress and micro cracking, self-quenching, and is an inherently time-efficient process.

In some embodiments, laser deposition can further include a laser scribing process. Laser scribing may be performed where lines may be produced on the construct during the additive manufacturing process. In some embodiments, the laser scribed line width can be smaller or equal to the laser beam width. The laser scribed line can be set to a specific tolerance depth. In some embodiments, the laser-scribed lined comprises a series of small, closely spaced holes in the substrate that is produced by laser energy pulses.

### Metallurgy

In some embodiments, the additively manufactured process can involve one or more chemical compositions which can include or exclude plastics, pure metals, semi-metals, non-metals, ceramics, or one more alloys. In some embodiments, the pure metals can include or exclude: titanium, gold, silver, nickel, cobalt, molybdenum, copper, aluminum, gallium, bismuth, lead, tin, iron, cadmium, zinc, indium, thallium, platinum, palladium, antimony, tantalum, germanium, silicon, tungsten, zirconium, hafnium, chromium, vanadium, manganese, magnesium, iridium, ruthenium, rhodium, osmium, molybdenum, cerium, indium, vanadium, rhenium, niobium (Nb, formerly Cb), and combinations thereof. In some embodiments, the semi-metals can include or exclude silicon. In some embodiments, the non-metals can include or exclude: sulfur, phosphorous, carbon, nitrogen, and boron. In some embodiments, the alloys can include or exclude stainless steels, duplex steels, tool steels, and maraging steels. In some embodiments, the tool steels can include or exclude H13. In some embodiments, the maraging steels can include or exclude Maraging 300. In some embodiments, the stainless steels can include or exclude types 316, 316L, 420, 347, 15-SPH, and 17-4PH. In some embodiments, the alloy can include or exclude: Galinstan (Ga 68.5, In 21.5, Sn 10 wt. %), Cerrolow 117 (Bi 44.7, Pb 22.6, In 19.1, Cd 5.3, Sn 8.3 wt. %), Cerrolow 136 (Bi 49, Pb 18, In 21, Sn 12 wt. %), Field's metal (Bi 32.5, In 51.0, Sn 16.5 wt. %), Cerrobend (Bi 50, Pb 26.7, Sn 13.3, Cd 10 wt. %), Lipowitz's alloy (Bi 49.5, Pb 27.3, Sn 13.1, Cd 10.1 wt. %), Wood's metal (Bi 50.0, Pb 25.0, Sn 12.5, Cd 12.5 wt. %), Cerrosafe (Bi 42.5, Pb 37.7, Sn 11.3, Cd 8.5 wt. %), ChipQuik (Bi 56, Sn 30, In 14 wt. %), Onions' Fusible alloy (Bi 50, Pb 30, Sn 20 wt %, plus Impurities), Bi52 (Bi 52, Pb 32.0, Sn 16 wt. %), Newton's metal (Bi 50.0, Pb 31.2, Sn 18.8 wt. %), Rose's metal (Bi 50.0, Pb 28.0, Sn 22.0 wt. %), Bi58 (Bi 58, Sn 42 wt. %), Sn63 (ASTM63A, ASTM63B—Sn 63.0, Pb 37.0 wt. %), KappAlloy9 (Sn 91.0, Zn 9.0 wt. %), Tin foil (Sn 92.0, Zn 8.0 wt. %), commercially pure grade 1 titanium alloy, commercially pure grade 2 titanium alloy, Ti6Al4V, Ti 6AL-4V ELI, Cp Ti, gamma-TiAl, Al—Si—Mg, 6061 aluminum alloy, alumina, Cermets, Stellite, AlSi12, AlSi10Mg, Inconel 625, Inconel 713, Inconel 718, Inconel 738, Hastelloy X, Co28Cr6Mo, bronze (CuSn10), MoRe, Ta—W, CoCr, ATI Rene 95 PM™ Nickel, ATI Low Carbon Astroloy PM Nickel, ATI 720 PM™ Nickel, ATI A625 PM™ Nickel, ATI N625 PM™ Nickel, ATI 625M PM™ Nickel, ATI CP PM™, ATI 6-4 PMT™, Erasteel Pearl 625 (Ni/Co), Erasteel Pearl 690 (Ni/Co), Erasteel Pearl 6 (Co-base), Erasteel Pearl 12 (Co-base), Erasteel Pearl 21 (Co-base), Erasteel Pearl 304 (stainless steel), Erasteel Pearl 316 (type L stainless steel), Erasteel Pearl 316 (type N stainless steel), Erasteel Pearl 431 (stainless steel), Erasteel Pearl 440 (stainless steel), Erasteel Pearl F44 (stainless steel), Erasteel Pearl 2205 (duplex steel), Erasteel Pearl 2505 (duplex steel), Erasteel Pearl 2004 (AISI M4), Erasteel Pearl 2009, Erasteel Pearl 2011 (AISI A11), Erasteel Pearl 2015 (AISI T15), Erasteel Pearl 2023, Erasteel Pearl 2030, Erasteel Pearl 2060, Erasteel Pearl D2, Erasteel Pearl D7, Erasteel Pearl H13, SC 30 alloy (C 0.08, Cr 19.0, Si 1.0, Mn 2.0, Ni 10.0, Bal. Fe), SC 304L alloy (C 0.02, Cr 19.0, Si 1.0, Mn 2.0, Ni 10.0, Bal. Fe), SC 316L alloy (C 0.02, Cr 17.0, Cr 17.0, Si 1.0, Mn 2.0, Ni 12.0, Mo 2.5, Bal. Fe), 329 (S32900) alloy (C 0.2, Cr 23.0-28.0, Ni 2.5-5.0, Si 0.75, Mn 1.0, Mo 1.0-2.0, Bal. Fe), Nitronic 60 alloy (C 0.1, Cr 16.0-18.0), Ni 8.0-9.0, Si 3.5-4.5, Mn 7.0-9.0, N 0.08-0.18, Bal. Fe), 316Ti alloy (S31635) (C 0.08, Cr 16.0-18.0), Ni 10.0-14.0, Mo 2.0-3.0, Si 1.0, Mn 2.0, N 2.5, Ti 0.7, Bal. Fe), SAF 2507 alloy (S32750) (C 0.03, Cr 24.0-26.0), Ni 6.5-7.5, Mo 3.5-4.5, Si 0.8, Mn 1.2, N 0.25, Cu 0.5, Bal. Fe), HK-30 alloy (J94203) (C 0.24-0.35, Cr 23.0-27.0), Ni 19.0-22.0, Mo 0.5, Si 0.75-1.75, Mn 1.5, Nb 1.2-1.5 0.5, Bal. Fe), CarTech 31V Alloy (0.04 C, 0.20 Mn, 0.20 Si, 0.015 P, 0.015 S, 22.7 Cr, 57.0 Ni, 2.0 Mo, 2.3 Ti, 1.3 Al, 0.90 Cb, 0.005 B, Bal. Fe wt. %), CarTech 355 Alloy (0.10/0.15 C, 0.50/1.25 Mn, 0.04 P, 0.03 S, 0.50 Si, 15.00/16.00 Cr, 4.00/5.00 Ni, 2.50/3.25 Mo, 0.07/0.13 N, Bal. Fe wt. %), CarTech 350 Alloy (0.07/0.11 C, 0.50/1.25 Mn, 0.04 P, 0.03 S, 0.50 Si, 6.00/17.00 Cr, 4.00/5.00 Ni, 2.50/3.25 Mo, 0.07/0.13 N, Bal. Fe wt. %), CarTech Purls SM-100 titanium powder, CarTech Purls eTi powder, CarTech Purls 5+ titanium powder (Ti-6Al-4V), CarTech 625 Alloy (0.10 C, 0.50 Mn, 0.50 Si, 0.015 P, 0.015 S, 20.0/23.0 Cr, 8.0/10.0 Mo, 5.00 Fe, 0.40 Ti, 1.00 Co, 3.15/4.15 Cb and Ta, 0.40 Al, Bal. Ni), CarTech Custom Age 725 Alloy (C 0.03, P 0.015, Si 0.20, Ni 59.00, Co 4.00, Al 0.35, Mn 0.20, S 0.010, Cr 22.00, Mb 9.50, Ti 1.60, Bal. Fe), CarTech 41 Alloy (0.06/0.12 C, 0.50 Mn, 0.50 Si, 18.00/20.00 Cr, 9.00/10.50 Mo, 10.00/12.00 Co, 3.00/3.30 Ti, 1.40/1.60 Al, 0.003/0.010 B, 5.00 Fe, Bal. Ni), CarTech 600 Alloy (0.10 C, 1.00 Mn, 0.50 Si, 0.015 S, 14.00/17.00 Cr, 72.00 min. Ni, 0.50 Cu, 6.00/10.00 Fe), CarTech 625 Alloy (0.10 C, 0.50 Mn, 0.50 Si, 0.015 P, 0.015 S, 20.0/23.0 Cr, 8.0/10.0 Mo, 5.00 Fe, 0.40 Ti, 1.00 Co, 3.15/4.15 Cb and Ta, 0.40 Al, Bal. Ni), CarTech 680 Alloy (0.05/0.15 C, 1.00 Mn, 1.00 Si, 0.040 P, 0.030 S, 20.50/23.00 Cr, 0.50/2.50 Co, 8.00/10.00 Mo, 0.20/1.00 W, 17.00/20.00 Fe, Bal. Ni), CarTech 706 Alloy (0.06 C, 2.50/3.30 Nb+Ta, 0.35 Mn, 1.50/2.00 Ti, 0.35 Si, 0.40 Al, 0.020 P, 0.006 B, 0.015 S, 0.30 Cu, 14.50/17.50 Cr, Bal. Fe, 39.00/44.00 Ni), CarTech 718 Alloy (0.10 C, 0.35 Mn, 0.35 Si, 0.015 P, 0.015 S, 17.00/21.00 Cr, 50.00/55.00 Ni+Co, 2.80/3.30 Mo, 4.75/5.50 Cb+Ta, 0.65/1.15 Ti, 0.35/0.85 Al, 0.001/0.006 B, 0.15 Cu, Bal. Fe), CarTech 80A Alloy (0.06 C, 0.35 Mn, 0.35 Si, 20.00 Cr, 0.007 S, 0.75 Fe, 2.35 Ti, 1.25 Al, 0.05 Cu, 1.00 Co, Bal. Ni), CarTech 882 Alloy (0.40 C, 1.00 Si, 5.00 Cr, 1.50 Mo, 0.40 V, Bal. Fe), CarTech 901 Alloy (0.10 C, 1.00 Mn, 0.60 Si, 11.00/14.00 Cr, 40.00/45.00 Ni, 5.00/7.00 Mo, 2.35/3.10 Ti, 0.50 Cu, 0.35 Al, 0.010/0.020 B, Bal. Fe), CarTech A-286 Alloy (0.08 C, 2.00 Mn, 1.00 Si, 13.50/16.00 Cr, 24.00/27.00 Ni, 1.00/1.50 Mo, 1.90/2.30 Ti, 0.10/0.50 V, 0.35 Al, 0.003/0.010 B, Bal. Fe), CarTech CTX-1 Alloy (0.05 C, 0.50 Mn, 0.50 Si, 0.015 P, 0.015 S, 0.50 Cr, 0.20 Mo, 0.50 Cu, 38.00/40.00 Ni, 2.50/3.50 Cb and Ta, 1.25/1.75 Ti, 0.70/1.20 Al, 0.0075 B, 14.00/16.00 Co, Bal. Fe), CarTech CTX-3 Alloy (0.05 C, 0.50 Mn, 0.50 Si, 0.015 P, 0.015 S, 0.50 Cr, 37.00/39.00 Ni, 0.50 Cu, 13.00/15.00 Co, 4.50/5.50 Cb and Ta, 1.25/1.75 Ti, 0.25 Al, 0.012 B, Bal. Fe), CarTech CTX-909 Alloy (0.06 C, 0.50 Mn, 0.40 nom. Si, 0.015 P, 0.015 S, 0.50 Cr, 38.00 nom. Ni, 14.00 nom. Co, 1.60 nom. Ti, 4.90 nom. Cb+Ta, 0.15 Al, 0.50 Cu, 0.012 B, Bal. Fe).

### Additively Manufactured Deflector Nozzles for Rocket Engines

At least some known rocket engines have at least three basic components: the injection manifold, at least one combustion chamber coupled to the manifold, and at least one nozzle. The injection manifold intakes the propellants and evenly distributes them across the injector face in the correct proportions to the combustion chamber, wherein the propellants are mixed and ignited. A converging-diverging nozzle is then used to accelerate the resulting hot gases to supersonic velocities and produce thrust.

This standard arrangement results in a fixed geometry that is optimized at specific conditions. However, when the mission requires engine use in cases with varying conditions, such as vehicle ascent or engine throttling, the overall performance of the engine can be negatively impacted. In addition, the periodic nature of combustion can cause destructive pressure waves to propagate through the fluid pathways upstream of the combustion chamber. These waves can have a catastrophic effect upon the engine and its components.

Conventional solutions to the aforementioned injection molding defects have drawbacks. The aerospike, expansion-deflection, and double bell nozzles each help increase the efficiency of their engines when the ambient conditions are changing, but they provide minimal or no benefit to system efficiency when throttling the engine. Furthermore, injection manifolds with a high pressure drop are conventionally used to help mitigate combustion instabilities. Running the injector at high pressures can help stop traveling pressure waves, but this tactic can't stop all waves and is still highly susceptible to combustion instabilities produced by throttling (chug). Active modification of the nozzle throat area has the benefit of providing optimal operation during throttling of rocket engines. Using a separate system to monitor and respond to engine performance is an effective method of applying the nozzle throat area modification technology. However, there is a penalty in terms of complexity and weight, which in turn correlates to an increase in monetary cost and decrease in available payload. Sensors and microcontrollers capable of detecting the small changes while also surviving the extreme conditions near a functioning rocket engine are expensive and difficult to design.

The inventors have recognized that a more cost effective technique to modifying the throat area is through passive means. Advantages of using passive means include there are no active monitors because the geometry itself responds to the environmental conditions resulting in optimal performance. The nozzle would respond to a change in upstream pressure due to engine throttling by passively adjusting the throat area to maintain performance.

In some embodiments, this disclosure includes the use of a center pintle to passively modulate the throat area. The center pintle is a moving component extending from the injector, along the chamber vertical axis, connected to the deflector portion of the nozzle (through the interior nozzle core), in an expansion deflection nozzle. By incorporating the pintle geometry to the injector, the propellant pressures within the injection manifold would be able to control the position of the pintle and therefore the position of the deflector core, and by connection the throat area. Axial contraction of this core reduces throat area, while the core extends axially outward, the throat area is increased. In some embodiments, the movement of this pintle/deflector core may be driven by pneumatic controls, electronic or piezoelectric actuators. In some embodiments, the pintle may be pneumatically operated using the propellant feed pressure as the driving mechanism to determine the position of the pintle relative to the interior nozzle core. In such an embodiment, the interior nozzle core geometry is optimized through computational fluid dynamics to allow for the desired degree of axial movement over a given pressure range and provide the desired throat area and expansion geometry at each operating pressure.

### Throttling Optimization Nozzle

Nozzle contours are typically static shapes designed for optimal operation at specific ambient and throttling conditions. The specific nozzle contour shapes are designed to ensure satisfactory performance across the entire range of operating conditions. Even when optimized nozzle geometries are used, like the double bell, aerospike, or expansion deflection nozzles, they only optimize performance for changes in ambient conditions. These solutions do not account for engine throttling.

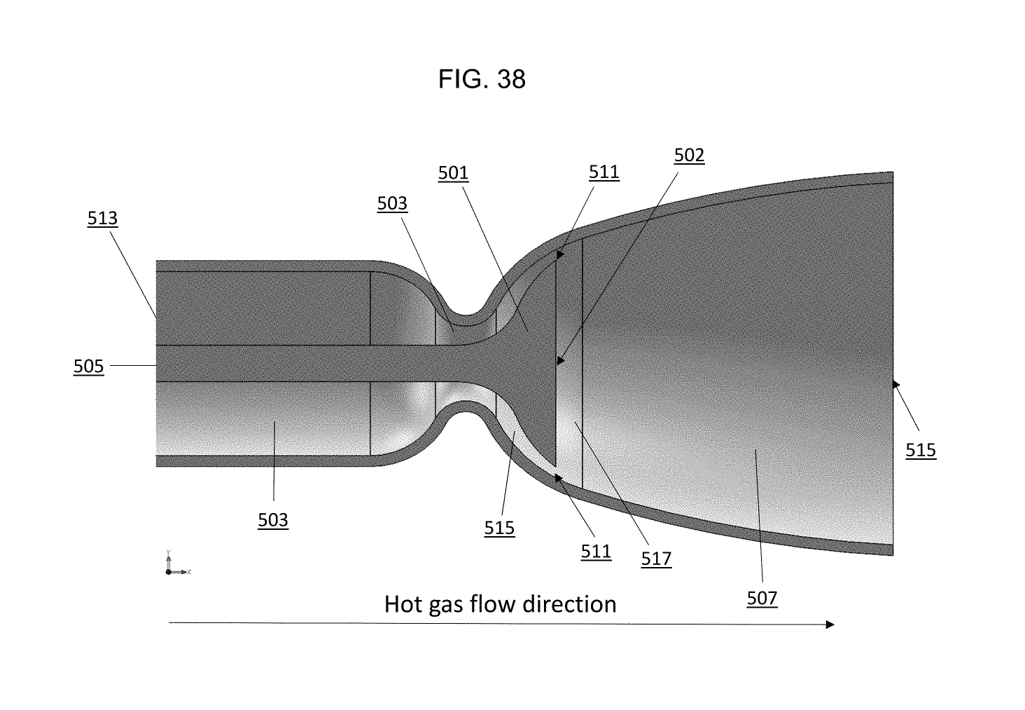

Operating conditions within rocket engine nozzles are largely governed by, as depicted in FIG. 38, the ratio of the inlet (left side), throat (middle), and outlet (right side) cross sectional areas. These ratios are designed to be constant leading to the aforementioned single optimal set of conditions. The ability to modify these ratios during flight allows for the engine to maintain optimal performance through the entire range of operation.

Methods of modifying these parameters focus on changing the exit area. This is effective in maintaining performance while ambient conditions are changing, but does little for optimization when throttling the engine across its range of thrusts.

It was discovered that by modifying the throat cross sectional area, the engine is capable of maintaining efficiency through its entire thrust range. In some embodiments, the cross sectional area of the throat area can be reduced when the engine throttles down to maintain engine performance when operating at lower pressures. In some embodiments, the throat area can be expanded to allow for higher operating pressures and greater engine performance at higher thrust ranges.

In some embodiments, this disclosure includes a deflector nozzle comprising a hot gas inlet 513, in fluidic communication with an interior nozzle core 509, in fluidic communication with an injector 503, in fluidic communication with a pintle 501, in fluidic communication with a throat area 511, in fluidic communication with a pintle terminus 502, in fluidic communication with a diverging portion of the nozzle 517, in fluidic communication with a hot gas outlet 518, and a throat 515. The deflector nozzle further comprises a chamber vertical axis 505.

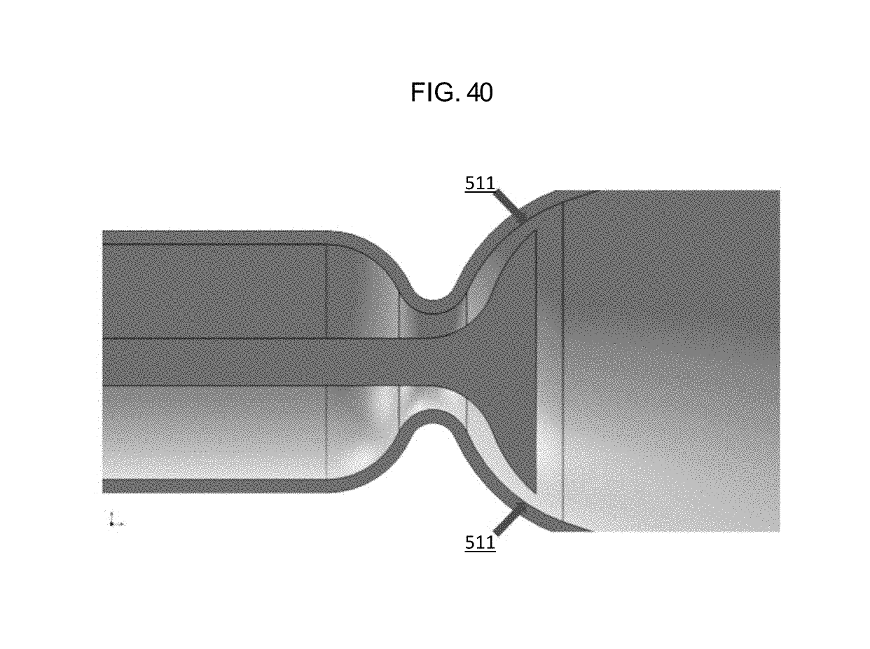

One method of controlling the nozzle throat area utilizes the center pintle in an expansion deflection nozzle. The pintle is used to direct the hot gas flow in diverging portion of the nozzle, as seen below in FIG. 38. Moving the pintle along the engine's centerline (chamber vertical axis) can expand or contract the throat area to ensure the geometry of the nozzle allows for choked flow at the throat. FIG. 39 and FIG. 40 highlight the effect on throat area caused by slight movements of the pintle. As shown in FIG. 39, positioning the pintle terminus 502 towards the throat 515 results in a lower throat surface area 511. As shown in FIG. 40, positioning the pintle terminus 502 away from the throat 515 and into the diverging portion of the nozzle 517 results in a higher throat surface area 511. Controllable change of the throat surface area allows for greater engine efficiency through various operating conditions, including engine throttling.

In some embodiments, the pintle position is configured in such a manner than increasing the pressure in the injector forces the pintle into the deflector nozzle region which increases the total throat area.

### Sonic Injector

The current method of mitigating combustion instabilities within rocket engines relies on an exceptionally high pressure drop through the injection manifold to ward off the back propagation of pressure waves. This method is effective at managing steady state operation combustion instabilities, but fails to mitigate instabilities brought on during startup, throttling, and shut down. During these occasions the pressure drop through the injection manifold decreases enough that the combustion pressure waves are able to pass back through the feed system.

A sonic injector, designed for a choked condition at a wide range of inlet pressures would be capable of mitigating every possible combustion base instability. The Mach 1 condition at the propellant injector outlet does not allow passing information upstream. This is particularly effective during throttling as long as the design maintains the injector outlet's choked condition across the entire throttle range. No matter how low the combustion pressure goes, the sonic condition will continue to mitigate the propagation of combustion instability.

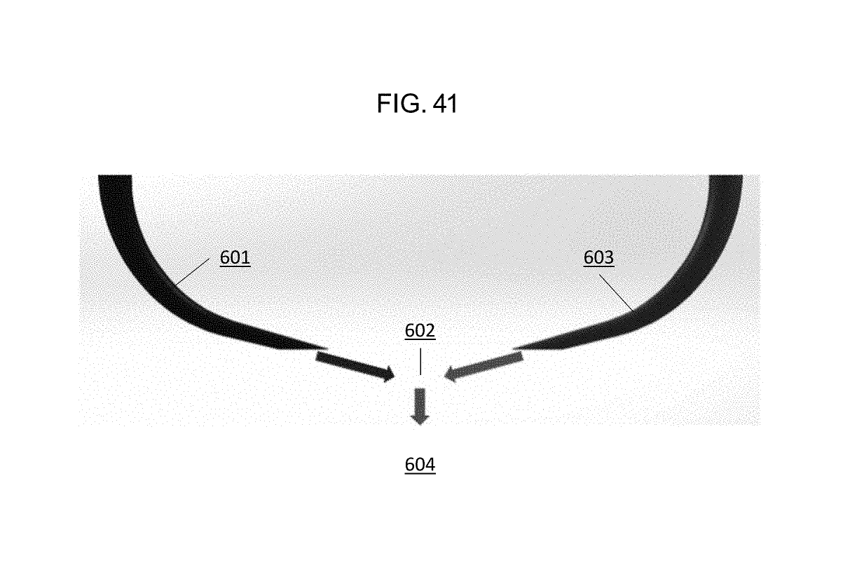

The high velocity of the sonic injector when used with a standard injection element would require a significantly increased chamber length to ensure mixing and combustion before the throat. To avoid the extra chamber length, it was discovered that injection elements with high incident angles are to be used. FIG. 41 depicts one embodiment of such an injection element. As shown in FIG. 41, a first impinging jet 601 directs hot gas flow to a mixing point 602. Simultaneously, a second impinging jet 603 directs hot gas flow to said mixing point 602. Each impinging jet uses the opposing momentum of its pair to slow down for mixing and combustion. The result is a sonic injector without the need for exceptionally long chambers. The hot gas is then directed to the thrust direction 604.

In general, the disclosures herein may also be applied to other applications having various industrial applicability. For example, fractal branched cooling passage concepts may be applied to heat exchangers, aerators, HVAC, pumps, agricultural injectors, chemical reactor temperature control, nuclear reactor heat transfer, and pharmaceutical injectors. As another example, the convergent junctures may similarly be applied to heat exchangers, aerators, HVAC, pumps, agricultural injectors, gas turbines, chemical reactor temperature control, nuclear reactor heat transfer, and pharmaceutical injectors. As yet another example, the fractal branched points and designs may be applied to heat exchangers, aerators, HVAC, pumps, agricultural injectors, gas turbines, chemical reactor temperature control, nuclear reactor heat transfer, and pharmaceutical injectors.

### EXAMPLES

### Example 1. Use of Testing Apparatus to Measure Deviation from CAD-Designed Model Features in as-Manufactured Features

It was discovered that structural features vary from the CAD-designed model to the as-manufactured object.

A 3-D CAD model of a testing apparatus was generated using AutoCAD using the Figures described herein, and converted into the appropriate file format for the additive-manufacturing test printer. The test printer was a direct metal laser sintering (DMLS) powder bed 3-D printer. The build material was titanium powder (CarTech® Purls Ti-6Al-4V Titanium Powder, Carpenter Technology Corp., USA). The additive manufacturing build instrument was the EOS M 290 (EOS, Germany). The laser write speed was varied and limited to a maximum of 7 meters per second. The laser was a Yb-fiber laser operating at 400 W. The laser focus diameter was 100 microns. The step height was varied between 20 to 40 microns. The additive manufacturing process was done under inert nitrogen atmosphere so as to prevent oxidation of the sintering material.

The imaging was performed with a borescope inspection microscope (Oasis Scientific, USA). The imaging setup was performed using optical tomography imaging equipment so as to take a profile of at least one side of the testing apparatus. Separately, a micrometer was imaged using the imaging system for calibration.

The as-manufactured testing apparatus was then imaged on all six side surfaces using a digital cell-phone camera (Apple iPhone, v. 7), and the images analyzed by imageJ (NIH) against a size calibrator to measure the opening diameters.

A series of openings in the as-manufactured testing apparatus was measured and the radii compared to the CAD designed radii. The results are presented in Table 1, below. Surprisingly, the results show that for small radii (0.15 mm and below), the as-manufactured part failed to produce any opening (hole) feature.

TABLE 1
Opening radii for CAD designed vs. measured in one embodiment of an
additively manufactured testing apparatus of the present invention.

| | Opening Number | | | | | | | |
|---|---|---|---|---|---|---|---|---|
| | 1 | 2 | 3 | 4 | 5 | 6 | 7 | 8 |
| CAD designed | 0.95 | 0.9 | 0.85 | 0.8 | 0.75 | 0.7 | 0.65 | 0.6 |
| opening Radii | | | | | | | | |
| (mm) | | | | | | | | |
| Measured | 0.845 | 0.776 | 0.759 | 0.707 | 0.621 | 0.534 | 0.5 | 0.448 |
| Series 1-1 | | | | | | | | |
| radii (mm) | | | | | | | | |
| Measured | 0.776 | 0.741 | 0.69 | 0.672 | 0.621 | 0.552 | 0.517 | 0.483 |
| Series 1-2 | | | | | | | | |
| radii (mm) | | | | | | | | |
| Measured | 0.84 | 0.759 | 0.707 | 0.655 | 0.603 | 0.552 | 0.517 | 0.483 |
| Series 1-3 | | | | | | | | |
| radii (mm) | | | | | | | | |
| Measured | 0.776 | 741 | 0.69 | 0.638 | 0.603 | 0.534 | 0.483 | 0.431 |
| Series 2-1 | | | | | | | | |
| radii (mm) | | | | | | | | |
| Measured | 0.776 | 0.724 | 0.69 | 0.603 | 0.56 | 0.517 | 0.483 | 0.414 |
| Series 2-2 | | | | | | | | |
| radii (mm) | | | | | | | | |
| Measured | 0.759 | 0.741 | 0.672 | 0.603 | 0.569 | 0.534 | 0.5 | 0.448 |
| Series 2-3 | | | | | | | | |
| radii (mm) | | | | | | | | |
| Measured | 0.81 | 0.741 | 0.69 | 0.638 | 0.603 | 0.534 | 0.517 | 0.466 |
| Series 3-1 | | | | | | | | |
| radii (mm) | | | | | | | | |
| Measured | 0.81 | 0.776 | 0.724 | 0.638 | 0.621 | 0.569 | 0.534 | 0.466 |
| Series 3-2 | | | | | | | | |
| radii (mm) | | | | | | | | |
| Measured | 0.793 | 0.759 | 0.707 | 0.655 | 0.621 | 0.569 | 0.534 | 0.448 |
| Series 3-3 | | | | | | | | |
| radii (mm) | | | | | | | | |
| Measured | 0.724 | 0.69 | 0.638 | 0.569 | 0.534 | 0.483 | 0.431 | 0.397 |
| Series 4-1 | | | | | | | | |
| radii (mm) | | | | | | | | |
| Measured | 0.741 | 0.69 | 0.638 | 0.569 | 0.517 | 0.483 | 0.431 | 0.397 |
| Series 4-2 | | | | | | | | |
| radii (mm) | | | | | | | | |
| Measured | 0.81 | 0.741 | 0.672 | 0.638 | 0.586 | 0.552 | 0.5 | 0.448 |
| Series 4-3 | | | | | | | | |
| radii (mm) | | | | | | | | |
| | Opening Number | | | | | | | |
| | 9 | 10 | 11 | 12 | 13 | 14 | 15 | 16 |
| CAD designed | 0.55 | 0.5 | 0.45 | 0.425 | 0.4 | 0.375 | 0.35 | 0.325 |
| opening Radii | | | | | | | | |
| (mm) | | | | | | | | |
| Measured | 0.397 | 0.345 | 0.293 | 0.259 | 0.241 | 0.241 | 0.155 | 0.155 |
| Series 1-1 | | | | | | | | |
| radii (mm) | | | | | | | | |
| Measured | 0.431 | 0.362 | 0.345 | 0.276 | 0.259 | 0.241 | 0.207 | 0.172 |
| Series 1-2 | | | | | | | | |
| radii (mm) | | | | | | | | |
| Measured | 0.414 | 0.362 | 0.31 | 0.293 | 0.259 | 0.224 | 0.19 | 0.121 |
| Series 1-3 | | | | | | | | |
| radii (mm) | | | | | | | | |
| Measured | 0.397 | 0.31 | 0.293 | 0.276 | 0.241 | 0.224 | 0.19 | 0.172 |
| Series 2-1 | | | | | | | | |
| radii (mm) | | | | | | | | |
| Measured | 0.369 | 0.345 | 0.31 | 0.276 | 0.224 | 0.224 | 0.172 | 0.172 |
| Series 2-2 | | | | | | | | |
| radii (mm) | | | | | | | | |
| Measured | 0.397 | 0.362 | 0.31 | 0.241 | 0.224 | 0.224 | 0.172 | 0.172 |
| Series 2-3 | | | | | | | | |
| radii (mm) | | | | | | | | |
| Measured | 0.414 | 0.379 | 0.31 | 0.31 | 0.259 | 0.224 | 0.207 | 0.19 |
| Series 3-1 | | | | | | | | |
| radii (mm) | | | | | | | | |
| Measured | 0.431 | 0.379 | 0.328 | 0.259 | 0.259 | 0.241 | 0.241 | 0.19 |
| Series 3-2 | | | | | | | | |
| radii (mm) | | | | | | | | |
| Measured | 0.431 | 0.379 | 0.328 | 0.293 | 0.276 | 0.224 | 0.207 | 0.172 |
| Series 3-3 | | | | | | | | |
| radii (mm) | | | | | | | | |
| Measured | 0.328 | 0.31 | 0.207 | 0.207 | 0.172 | 0.172 | 0.138 | 0.103 |
| Series 4-1 | | | | | | | | |
| radii (mm) | | | | | | | | |
| Measured | 0.379 | 0.345 | 0.276 | 0.241 | 0.172 | 0.172 | 0.138 | 0.121 |
| Series 4-2 | | | | | | | | |
| radii (mm) | | | | | | | | |
| Measured | 0.397 | 0.379 | 0.31 | 0.241 | 0.241 | 0.224 | 0.19 | 0.155 |
| Series 4-3 | | | | | | | | |
| radii (mm) | | | | | | | | |
| | Opening Number | | | | | | | |
| | 17 | 18 | 19 | 20 | 21 | 22 | 23 | 24 |
| CAD designed | 0.3 | 0.275 | 0.25 | 0.225 | 0.2 | 0.175 | 0.15 | 0.125 |
| opening Radii | | | | | | | | |
| (mm) | | | | | | | | |
| Measured | 0.121 | 0.103 | 0.069 | 0.069 | 0.052 | 0.034 | 0 | 0 |
| Series 1-1 | | | | | | | | |
| radii (mm) | | | | | | | | |
| Measured | 0.155 | 0.138 | 0.103 | 0.086 | 0.069 | 0.052 | 0 | 0 |
| Series 1-2 | | | | | | | | |
| radii (mm) | | | | | | | | |
| Measured | 0.121 | 0.086 | 0.069 | 0.052 | 0.052 | 0.034 | 0 | 0 |
| Series 1-3 | | | | | | | | |
| radii (mm) | | | | | | | | |
| Measured | 0.155 | 0.103 | 0.069 | 0.069 | 0.052 | 0.034 | 0 | 0 |
| Series 2-1 | | | | | | | | |
| radii (mm) | | | | | | | | |
| Measured | 0.155 | 0.103 | 0.086 | 0.069 | 0.069 | 0.052 | 0 | 0 |
| Series 2-2 | | | | | | | | |
| radii (mm) | | | | | | | | |
| Measured | 0.138 | 0.103 | 0.086 | 0.069 | 0.052 | 0.052 | 0 | 0 |
| Series 2-3 | | | | | | | | |
| radii (mm) | | | | | | | | |
| Measured | 0.172 | 0.121 | 0.103 | 0.052 | 0.052 | 0.052 | 0 | 0 |
| Series 3-1 | | | | | | | | |
| radii (mm) | | | | | | | | |
| Measured | 0.172 | 0.155 | 0.069 | 0.069 | 0.058 | 0.058 | 0 | 0 |
| Series 3-2 | | | | | | | | |
| radii (mm) | | | | | | | | |
| Measured | 0.138 | 0.103 | 0.086 | 0.069 | 0.069 | 0.052 | 0 | 0 |
| Series 3-3 | | | | | | | | |
| radii (mm) | | | | | | | | |
| Measured | 0.086 | 0.052 | 0.052 | 0.052 | 0.034 | 0.035 | 0 | 0 |
| Series 4-1 | | | | | | | | |
| radii (mm) | | | | | | | | |
| Measured | 0.103 | 0.086 | 0.052 | 0.052 | 0.034 | 0.026 | 0 | 0 |
| Series 4-2 | | | | | | | | |
| radii (mm) | | | | | | | | |
| Measured | 0.103 | 0.069 | 0.052 | 0.052 | 0.052 | 0.034 | 0 | 0 |
| Series 4-3 | | | | | | | | |
| radii (mm) | | | | | | | | |

| | Opening Number | | |
|---|---|---|---|
| | 25 | 26 | 27 |
| CAD designed | 0.1 | 0.075 | 0.05 |
| opening Radii | | | |
| (mm) | | | |
| Measured | 0 | 0 | 0 |
| Series 1-1 | | | |
| radii (mm) | | | |
| Measured | 0 | 0 | 0 |
| Series 1-2 | | | |
| radii (mm) | | | |
| Measured | 0 | 0 | 0 |
| Series 1-3 | | | |
| radii (mm) | | | |
| Measured | 0 | 0 | 0 |
| Series 2-1 | | | |
| radii (mm) | | | |
| Measured | 0 | 0 | 0 |
| Series 2-2 | | | |
| radii (mm) | | | |
| Measured | 0 | 0 | 0 |
| Series 2-3 | | | |
| radii (mm) | | | |
| Measured | 0 | 0 | 0 |
| Series 3-1 | | | |
| radii (mm) | | | |
| Measured | 0 | 0 | 0 |
| Series 3-2 | | | |
| radii (mm) | | | |
| Measured | 0 | 0 | 0 |
| Series 3-3 | | | |
| radii (mm) | | | |
| Measured | 0 | 0 | 0 |
| Series 4-1 | | | |
| radii (mm) | | | |
| Measured | 0 | 0 | 0 |
| Series 4-2 | | | |
| radii (mm) | | | |
| Measured | 0 | 0 | 0 |
| Series 4-3 | | | |
| radii (mm) | | | |

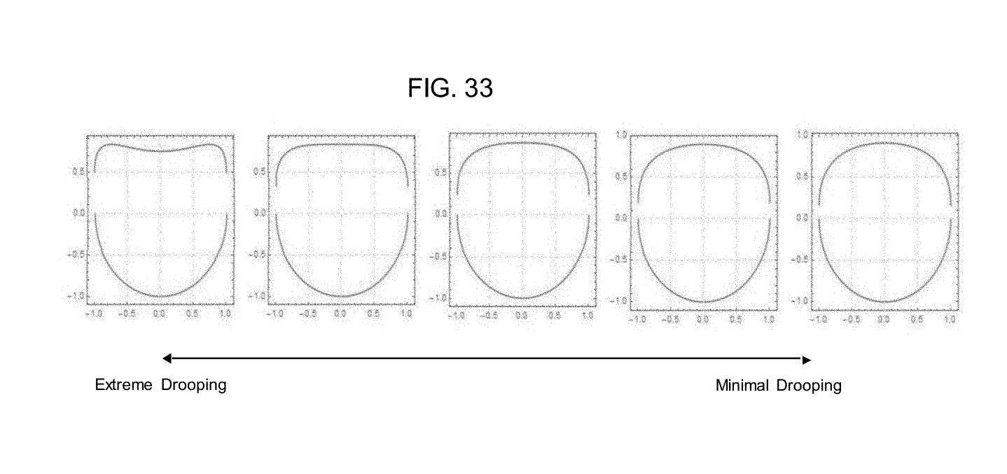

A graph of the openings radii is presented in FIG. 33 shows the measured xy-openings radii for three separate series (iterations) of openings compared to the designed CAD dimensions. The results indicate that the testing apparatus can be used to measure the deviation from CAD-designed dimensions in the as-manufactured testing apparatus.

### Example 2. Measurement of Drooping of Teardrop-Shaped Openings in One Embodiment of the Present Invention

It was discovered that the teardrop-shaped openings positioned on at least one side surface of one testing apparatus embodiment of the present invention can be used to measure the drooping effect in the as-manufactured testing apparatus openings as a function of radii.

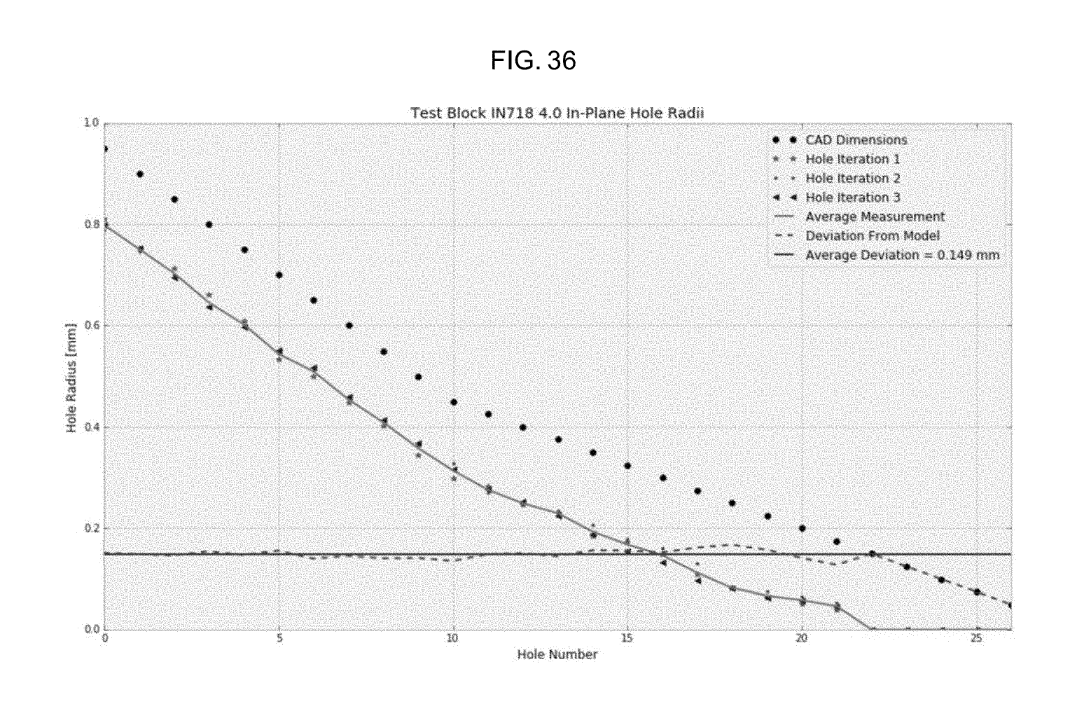

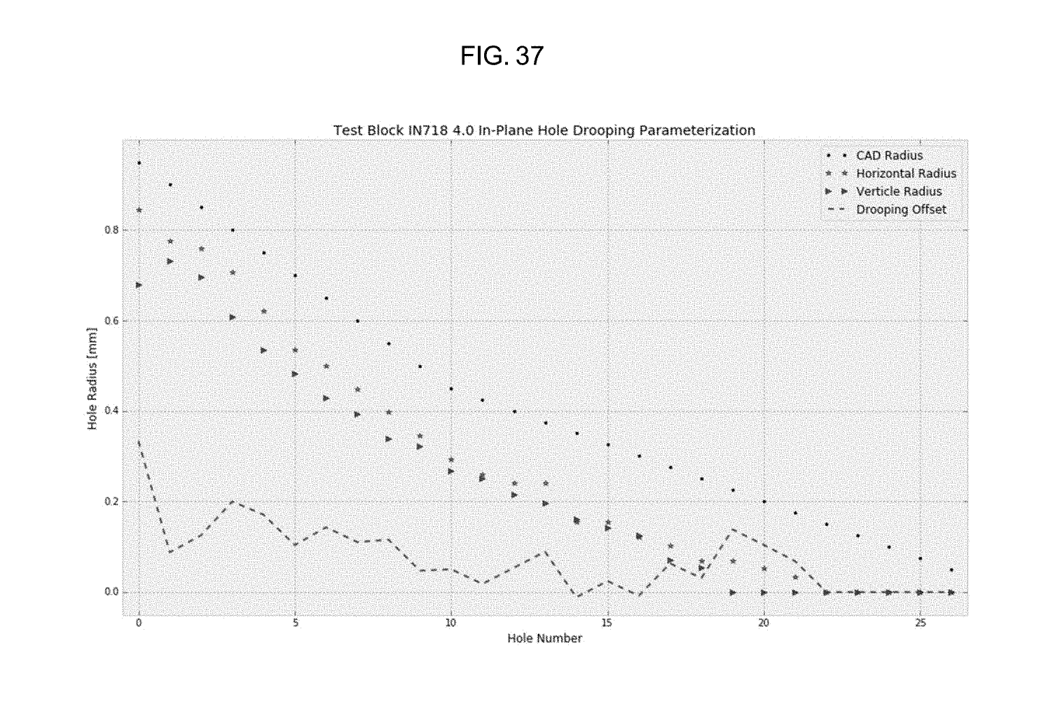

The testing apparatus was designed, manufactured, and imaged according to the method described in Example 1. A graph of the as-measured xz-teardrop vertical and horizontal opening radii compared to the CAD-designed opening radii is presented in FIG. 36 and FIG. 37. Surprisingly, the as-manufactured testing apparatus failed to produce any openings with a radius of 0.15 mm or smaller. The results indicate that the testing apparatus can be used to measure the deviation from CAD-designed drooping in the as-manufactured testing apparatus.

### Example 3. Process for Additively-Manufacturing a Construct

A 3-D CAD model of the constructs described herein are generated using AutoCAD, and are converted into the appropriate file format for the additive-manufacturing system. Constructs can be of almost any shape or geometry and are produced using digital model data from a three-dimensional model or another electronic data source such as an Additive Manufacturing File (AMF) file or an (STereoLithography) STL file. One example of digital model data is G-code. G-code (also RS-274), which has many variants, is the common name for the most widely used numerical control (NC) programming language.

Before printing a 3-D CAD model from an STL file, it must first be examined for errors. Most CAD applications produce errors in output STL files: holes, inverted or inconsistent face normals, self-intersections, noise shells or manifold errors. A step in the STL generation known as “repair” fixes such problems in the original model.

Once error checking is completed, the STL file needs to be processed by a piece of software called a “slicer,” which converts the model into a series of thin layers and produces a G-code file containing instructions tailored to a specific type of three-dimensional printer. This G-code file can then be printed with three-dimensional printing client software (which loads the G-code, and uses it to instruct the additive-manufacturing printer during the additive manufacturing process.

The system is a direct metal laser sintering (DMLS) powder bed 3-D printer. The build material is titanium powder (CarTech® Purls Ti-6Al-4V Titanium Powder, Carpenter Technology Corp., USA). The additive manufacturing build instrument is the EOS M 280 (EOS, Germany). The laser write speed is varied and limited to a maximum of 7 meters per second. The laser is a Yb-fiber laser operating at 400 W. The laser focus diameter is 100 microns. The step height is varied between 20 to 40 microns. The additive manufacturing process is done under inert nitrogen atmosphere so as to prevent oxidation of the sintering material.

### Example 4: Conformal Cooling Simulation

A heat map simulation of a heat exchanger where the heat exchanger is a mold comprising conformal cooling passages about a central cavity defining a spherical shape (FIG. 15 and FIG. 21), or a polyhedron shape (FIG. 17 and FIG. 19) was calculated and compared to that of a mold comprising non-conformal cooling passages about a central cavity having a polyhedron shape (FIG. 18) or non-conformal cooling passages about a central cavity having a spherical shape (FIG. 22). The heat maps demonstrate that the simulated temperature difference across the central cavity is more homogeneous for the mold comprising conformal cooling passages. Furthermore, the temperature drop is greater for the fractal branched conformal cooling passages because the mold comprising the non-conformal cooling passage is a single passage where the heat transfer to the fluid is less because the single passage mold comprises a fluid which is increasing in temperature as the fluid traverses through the single passage. The fractal branched conformal cooling passages, however, enable more efficient heat transfer because of the higher surface-volume area of the multiple passages, each of which is transporting a separate portion of the fluid. Multiple passages with parallel fluid flow are possible in the fractal branched conformal cooling passages in the additively-manufactured molds made by the methods described herein because they comprise fractal branching points and convergent junctures. In some embodiments, the fractal branching points are disposed to be between the feeder passage inlet and the central cavity. In some embodiments, the convergent junctures are disposed to be between the central cavity and the passage outlet.

The heatmaps generated and described herein were obtained using conjugate heat transfer analysis using the Ansys™ modeling software with the applicable modalities employed as appropriate. Conjugate heat transfer analysis is a type of coupled multiphysics simulation which incorporates both Computational Fluid Dynamics (CFD) and Finite Element Analysis (FEA). In the context of the cooled mold or mold insert, CFD analysis is performed on the fluid flowing through the passages to determine the amount of heat they remove from the surrounding material while FEA analysis determines the movement of the heat from the mold cavity (where it is typically determined by heat flux outputs from a mold flow analysis or estimated from working material heat capacity) to the cooling passages where it is transferred to the fluid. In this way, both sets of physics are coupled and provide a reasonably accurate picture of the expected cavity thermal distribution. For this simulation, both the mold cavity and coolant mass flow rate were held constant. The temperature was given in arbitrary relative Temperature units (degrees Celsius).

In some embodiments, this disclosure relates to a testing apparatus described by the following:

A1. A testing apparatus comprising:

a plurality of side surfaces;

a barcode pattern that is positioned on at least one of the plurality of side surfaces;

a plurality of rings positioned adjacent to the barcode pattern, wherein each of the plurality of rings are coupled to each other such that each ring of the plurality of rings is concentrically aligned with at least one other ring of the plurality of rings, each of the plurality of rings have the same first predefined diameter;

at least one first set of a plurality of openings positioned on the same side surfaces that the barcode pattern and the plurality of rings are positioned on, wherein each of the at least one first set of the plurality of openings have a second predefined diameter that is different than the first predefined diameter, the at least one first set of the plurality of openings have a predefined first shape

at least one second set of a plurality of openings positioned on at least one of the plurality of side surfaces that is different than the at least one surface that the barcode pattern and the plurality of rings are positioned on, wherein each of the at least one second set of the plurality of openings have a second predefined diameter that is different than the first predefined diameter, the at least one second set of the plurality of openings have a predefined second shape; and

at least one third set of a plurality of openings positioned adjacent to the at least second set of the plurality openings, wherein the at least one third set of the plurality of openings have a predefined third shape that is different than the predefined second shape.

A2. The testing apparatus of A1, further comprising at least one series of tapered edge ramps at one or more angles tapering inward to the center of the testing apparatus to partially bisect two of the side surfaces.

A3. The testing apparatus of A2, wherein the at least one series of tapered edge ramps comprises six ramps.

A4. The testing apparatus of A3, wherein the angles of the at least one series of tapered edge ramps are selected from: 1, 15, 30, 45, 60, and 75 degrees.

A5. The testing apparatus of A1, further comprising a planar tapered edge ramp configured at the lateral outer edge of and spanning across the length of the testing apparatus.

A6. The testing apparatus of A5, wherein the angle of the planar tapered edge ramp is 1 degree.

A7. The testing apparatus of any of A1-6, wherein the testing apparatus consists essentially of six side surfaces and twelve edges.

A8. The testing apparatus of A7, wherein the twelve edges of the testing apparatus are of the same length.

A9. The testing apparatus of A8, wherein the length of each of the edges are less than 3.5 centimeters.

A10. An imaging system comprising a testing apparatus of A7 and a camera configured to be orthogonal to any of the six side surfaces.

A11. The imaging system of A10, wherein any of the six side surfaces of the testing apparatus presented to the camera can be switched with any other of the six side surfaces of the testing apparatus.

A12. A method for detecting the presence of any defects of an additive-manufacturing process, the method comprising the steps of:
a. creating a first input design file for a testing apparatus of A7 wherein said design file comprises size requirements of the testing apparatus features;
b. performing an additive manufacturing process to the testing apparatus of A7 using the first input design file;
c. scanning a first side surface of the additively manufactured testing apparatus;
d. measuring the dimensions of one or a plurality of the features positioned on the first side surface of the additively manufactured testing apparatus; and
e. comparing the dimensions of one or a plurality of the features of the additively manufactured testing apparatus with the first input design file size features of the testing apparatus,
whereby a difference greater than a set threshold in the dimensions of the additively manufactured testing apparatus and of the first input design file indicates a defect in the additive manufacturing process.

A13. The method of A12, further comprising the steps of:
f. scanning a second side surface of the additively manufactured testing apparatus; and
g. measuring the dimensions of one or a plurality of the features positioned on the second side surface of the additively manufactured testing apparatus.

A14. The method of A12, wherein the step (b) an additive manufacturing process to the testing apparatus of A7 using the first input design file, is performed at the same time as additively manufacturing a separate object during the additive manufacturing process.

A15. The method of A14, wherein a defect identified in the additive manufacturing process indicates a defect in the additively manufactured separate object.

A16. The method of A13, further comprising:
h. creating a second input design file for a testing apparatus of A7 which comprises different size requirements of the testing apparatus features positioned on a side surface than in the first input design file;
i. performing an additive manufacturing process to the testing apparatus of A7 using the second input design file;
j. scanning a first side surface of the testing apparatus of A7 designed by the second input design file;
k. measuring the dimensions of one or a plurality of the features positioned on the first side surface of the additively manufactured testing apparatus made in step (j); and
l. comparing the dimensions of one or a plurality of the features positioned on a side surface of the additively manufactured testing apparatus with the second input design file size features of the testing apparatus,
   whereby a difference between the dimensions of the additively manufactured testing apparatus designed by the second input file and of the first input design file are reduced.

A17. The testing apparatus of A1, wherein at least two separate features are configured on each side surface of the testing apparatus.

A18. The testing apparatus of A1, wherein the length of each testing apparatus edge is substantially about the same.

A19. The testing apparatus of A1, wherein the surface area of each side surface is substantially about the same.

A20. The testing apparatus of A1, wherein the shape of the first set of a plurality of openings are round.

A21. The testing apparatus of A1, wherein the shape of the second openings are teardrop-shaped.

A22. The testing apparatus of A1, wherein the shape of the third openings are round.

The preceding merely illustrates the principles of various embodiments of the disclosure. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

All numbers expressing quantities or parameters used in the specification are to be understood as additionally being modified in all instances by the term “about”. Notwithstanding that the numerical ranges and parameters set forth, the broad scope of the subject matter presented herein are approximations, the numerical values set forth are indicated as precisely as possible. For example, any numerical value may inherently contain certain errors, evidenced by the standard deviation associated with their respective measurement techniques, or round-off errors and inaccuracies.

The embodiments described herein have many attributes including, but not limited to, those set forth or described or referenced in this Detailed Disclosure. It is not intended to be all-inclusive and the inventions described and claimed herein are not limited to or by the features or embodiments identified in this Detailed Disclosure, which is included for purposes of illustration only and not restriction. A person having ordinary skill in the art will readily recognize that many of the components and parameters may be varied or modified to a certain extent or substituted for known equivalents without departing from the scope of the invention. It should be appreciated that such modifications and equivalents are herein incorporated as if individually set forth. The invention also includes all of the steps, features, compositions and compounds referred to or indicated in this specification, individually or collectively, and any and all combinations of any two or more of said steps or features.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents. Reference to any applications, patents and publications in this specification is not, and should not be taken as, an acknowledgment or any form of suggestion that they constitute valid prior art or form part of the common general knowledge in any country in the world.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A heat exchanger comprising:
(a) a plurality of fractal branched cooling passages;
wherein the sum of the cross sectional area of the plurality of fractal branched cooling passages is substantially the same throughout the length of said passages, and
wherein the heat exchanger is additively-manufactured.

2. The heat exchanger of claim 1, further comprising:
(b) a central cavity comprising a surface;
wherein the plurality of fractal branched cooling passages conforms to the contours of the central cavity surface which are disposed close to, but not in fluidic communication with, said central cavity.

3. The heat exchanger of claim 2, wherein the heat exchanger is used as a mold for forming a part.

4. The mold of claim 3, wherein the mold is an injection mold.

5. The heat exchanger of claim 1, further comprising one or a plurality of fractal branching points.

6. The heat exchanger of claim 1, further comprising one or a plurality of convergent junctures.

7. The heat exchanger of claim 1, further comprising one or a plurality of first fluid feeder passages.

8. The heat exchanger of claim 4, further comprising one or a plurality of second fluid feeder passages.

9. The heat exchanger of claim 5, wherein the first fluid feeder passage comprises a first fluid, the second fluid feeder passage comprises a second fluid, and the first fluid and the second fluid are the same type of fluid.

10. The heat exchanger of claim 5, wherein the first fluid feeder passage comprises a first fluid, the second fluid feeder passage comprises a second fluid, and the first fluid and the second fluid are at different temperatures.

11. The heat exchanger of claim 5, wherein the first fluid feeder passage comprises a first fluid, the second fluid feeder passage comprises a second fluid, and the first fluid and the second fluid are at the same temperature when presented into their respective feeder passages.

12. The heat exchanger of claim 1, wherein the plurality of fractal branched cooling passages further comprises a fluid.

13. The heat exchanger of claim 12, wherein the fluid is at a lower temperature than the mold temperature.

14. The heat exchanger of claim 12, wherein the fluid is selected from ethylene glycol, water, oil, a nanofluid, a cryogenic fluid, or mixtures thereof.

15. The mold of claim 3, further comprising:
(c) an additively-manufactured mold insert comprising a plurality of fractal branched cooling passages.

16. A method of forming a plastic part substantially free of warping defects, the method comprising the steps of:
(a) presenting a plastic material into the central cavity of the mold of claim 3;
(b) increasing the temperature of the plastic material to above the softening point of the plastic material to form a melted plastic material;
(c) decreasing the temperature of the plastic material to below the softening point of the plastic material to form a solidified plastic material;
(d) removing the additively-manufactured mold from the solidified plastic material to form a formed plastic part.

17. The method of claim 16, wherein step (b) increasing the temperature of the plastic material is performed by presenting a fluid into the plurality of fractal branched cooling passages, then heating said fluid.

18. The method of claim 16, wherein step (b) increasing the temperature of the plastic material is performed by presenting a pre-heated fluid into the plurality of fractal branched cooling passages.

19. The method of claim 16, wherein step (b) increasing the temperature of the plastic material is performed by placing the additively-manufactured mold comprising the plastic material into an external heating apparatus.

20. The method of claim 19, wherein the external heating apparatus is a heating oven.

21. The method of claim 16, wherein step (c) decreasing the temperature of the plastic material is performed by presenting a pre-cooled fluid into the plurality of fractal branched cooling passages.

22. The method of claim 16, wherein the injection mold comprises two or more additively-manufactured mold segments, each of which comprises a surface.

23. The method of claim 22, wherein each of the surfaces of the two or more additively-manufactured mold segments define substantially the entire surface of a formed plastic part.

24. The heat exchanger of claim 1, further comprising:
(d) an inlet in fluidic communication with the plurality of fractal branched cooling passages; and
(e) an outlet in fluidic communication with the plurality of fractal branched cooling passages.
